(19) United States
(12) Patent Application Publication
(10) Pub. No.: US 2016/0092641 A1
(43) Pub. Date: Mar. 31, 2016

(54) FACILITATING CLINICALLY INFORMED FINANCIAL DECISIONS THAT IMPROVE HEALTHCARE PERFORMANCE

(71) Applicants: Socrates Analytics, Inc., Shaker Heights, OH (US); University Hospitals of Cleveland, Cleveland, OH (US)

(72) Inventors: Conor Delaney, Shaker Heights, OH (US); James Evans, Cleveland Heights, OH (US)

(21) Appl. No.: 14/954,449

(22) Filed: Nov. 30, 2015

Related U.S. Application Data
(63) Continuation-in-part of application No. 14/326,092, filed on Jul. 8, 2014.
Application No. 14/326,092 is a continuation-in-part of application No. 13/985,279, filed on Aug. 13, 2013.
(60) Provisional application No. 61/443,853, filed on Feb. 17, 2011.

(51) Int. Cl. G06F 19/00

(52) U.S. Cl. CPC G06F 19/327; G06F 19/322

(57) ABSTRACT

Systems, methods and computer readable media that facilitate providing clinically informed financial decisions that improve healthcare performance are provided. In an aspect, a system includes a performance evaluation component configured to identify groups of patients having received healthcare service by a healthcare organization and associated with a common healthcare service parameter and uncommon healthcare service parameters. The system further includes a scoring component configured to determine performance scores for respective groups of patients, wherein the performance scores reflect clinical and financial performance of the healthcare organization in association with provision of the healthcare service to the respective groups of patients. A comparison component further compare the respective groups of patients based on the performances scores respectively associated therewith to facilitate identifying one or more of the uncommon healthcare service parameters that are responsible for variance between at least a subset of performance scores.

### PRIORITY CLAIM

This application is a continuation-in-part of U.S. patent application Ser. No. 14/326,092 filed on Jul. 8, 2014, entitled “METHOD AND SYSTEM FOR EXTRACTION AND ANALYSIS OF INPATIENT AND OUTPATIENT ENCOUNTERS FROM ONE OR MORE HEALTHCARE RELATED INFORMATION SYSTEMS,” which is a continuation-in-part of U.S. patent application Ser. No. 13/985,279, filed on Aug. 13, 2013, entitled “METHOD AND SYSTEM FOR EXTRACTION AND ANALYSIS OF INPATIENT AND OUTPATIENT ENCOUNTERS FROM ONE OR MORE HEALTHCARE RELATED INFORMATION SYSTEMS,” which is the National Stage of International Application No. PCT/US2012/025421 filed Feb. 16, 2012, entitled “METHOD AND SYSTEM FOR EXTRACTION AND ANALYSIS OF INPATIENT AND OUTPATIENT ENCOUNTERS FROM ONE OR MORE HEALTHCARE RELATED INFORMATION SYSTEMS,” which claims priority to U.S. Provisional Patent Application Ser. No. 61/443,853 filed Feb. 17, 2011, and entitled, “METHOD AND SYSTEM FOR EXTRACTION AND ANALYSIS OF INPATIENT AND OUTPATIENT ENCOUNTERS FROM ONE OR MORE HEALTHCARE RELATED INFORMATION SYSTEMS.” The entireties of these applications are incorporated herein by reference.

### TECHNICAL FIELD

The present disclosure is directed to systems, methods and computer readable media that facilitate providing clinically informed financial decisions that improve healthcare performance.

### BACKGROUND

Healthcare organizations, such as hospitals and clinics, have at their disposal vast amounts of data through the utilization of a number of healthcare information systems, e.g., for billing, administration, resource scheduling and documentation, patient records, etc. Given that such healthcare organizations face strong pressures to reduce costs while increasing the quality of services delivered, analysis of such available data can lead to greater efficiency, better decision-making, improved patient care, and lower costs. However, the challenge is being able to extract relevant knowledge from such data which can help in the decision-making process.

### BRIEF DESCRIPTION OF THE DRAWINGS

Numerous aspects, embodiments, objects and advantages of the disclosed subject matter will be apparent upon consideration of the following detailed description, taken in conjunction with the accompanying drawings, in which like reference characters refer to like parts throughout, and in which:

FIG. 1 illustrates an example system that facilitates providing clinically informed financial decisions that improve healthcare performance in accordance with various aspects and embodiments described herein;

FIG. 2 illustrates another example system that facilitates providing clinically informed financial decisions that improve healthcare performance in accordance with various aspects and embodiments described herein;

FIG. 3 provides an flow diagram of an example method for assessing an amount of clinical and financial improvement opportunities available for different patient groups in accordance with various aspects and embodiments described herein;

FIG. 4 presents an example graphical user interface that facilitates generating and providing visualizations representing amounts of clinical and financial improvement opportunities available for different patient groups in accordance with various aspects and embodiments described herein;

FIG. 5 presents an example graphical user interface that facilitates generating and providing visualizations that quantify the financial and clinical impacts of complications associated with different patient groups in accordance with various aspects and embodiments described herein;

FIGS. 6-13 present a series of example graphical user interfaces that facilitate generating and providing visualizations quantifying financial and clinical variances in supply cost for different patient groups in accordance with various aspects and embodiments described herein;

FIG. 14 illustrates another example system that facilitates providing clinically informed financial decisions that improve healthcare performance in accordance with various aspects and embodiments described herein;

FIGS. 15-22 present a series of example graphical user interfaces that facilitate generating and providing visualizations identifying financial and clinical variances associated with different care paths for similar patient groups in accordance with various aspects and embodiments described herein;

FIG. 23 presents an example graphical user interface that facilitates identifying financial and clinical variances associated with different care paths for similar patient groups in accordance with various aspects and embodiments described herein;

FIG. 24 presents a flow diagram of an example method for determining root causes of variance between care paths of similar patient encounters in accordance with various aspects and embodiments described herein;

FIG. 25 presents a flow diagram of an example method for determining a model care path associated with treatment of a patient with a particular condition or prescribed a particular primary procedure in accordance with various aspects and embodiments described herein;

FIG. 26 presents a flow diagram of an example method for evaluating variance between care paths of similar patient encounters and updating a model care path using machine learning techniques, in accordance with various aspects and embodiments described herein;

FIG. 27 presents a flow diagram of an example method for determining mechanisms to reduce the amount and cost associated avoidable complications that arise in patient encounters in accordance with various aspects and embodiments described herein;

FIG. 28 illustrates another example system that facilitates providing clinically informed financial decisions that improve healthcare performance in accordance with various aspects and embodiments described herein;

FIG. 29 provides a flow diagram of an example method for predicting expected clinical and financial outcomes associated with a patient prior to admittance in accordance with various aspects and embodiments described herein;

FIGS. 30-32 present a series of example graphical user interfaces that facilitate generating and providing visualizations identifying expected clinical and financial outcomes associated with a patient prior to admittance in accordance with various aspects and embodiments described herein;

FIG. 33 illustrates another example system that facilitates providing clinically informed financial decisions that improve healthcare performance in accordance with various aspects and embodiments described herein;

FIG. 34 is a schematic block diagram illustrating a suitable operating environment in accordance with various aspects and embodiments.

FIG. 35 is a schematic block diagram of a sample-computing environment in accordance with various aspects and embodiments.

### DETAILED DESCRIPTION

The innovation is described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and components are shown in block diagram form in order to facilitate describing the innovation.

By way of introduction, the subject matter described in this disclosure relates to systems, methods and computer readable media that facilitate providing clinically informed financial decisions that improve healthcare performance, rationalize hospital portfolios and prepare providers for risk. As used herein, the term healthcare organization or environment refers to a structured social system developed for the delivery of health care services by specialized workforces to defined communities, populations or markets. For example, a health care organization or environment can include an integrated delivery system, a hospital or group of hospitals, or multispecialty physician groups.

In accordance with various embodiments, a networked (e.g., cloud based) healthcare management server is employed to provide a variety of services associated with measuring, analyzing, and visualizing the clinical and financial performance of a healthcare organization or environment based on information gathered from a plurality of data sources having information associated with the clinical and financial operations of the healthcare organization. For example, the data sources can include health histories of all patients of the healthcare organization, information regarding the care that was provided to the respective patients (e.g., procedures performed, drugs administered, a timeline of the course of the care, complications associated with the care, etc.), costs of provision of the care, reimbursement associated with the care, etc. In another example, the data can include information regarding supplies employed in association with provision of the care and costs associated with those supplies. In yet another example, the data can include information regarding medical personnel involved in provision of the care (e.g., physicians, nurses, technicians, etc.).

The healthcare management server is configured to provide various applications that facilitate exploring the clinical delivery within a healthcare organization so that the administration/management can make clinically informed financial decisions that improve healthcare performance, rationalize hospital portfolios and prepare providers for risk. These applications highlight and track achievable clinical process improvements and reveal the financial risks of all the services offered. For example, these applications are configured to link and merge data from a variety of disparate databases and provide analytics on length of stay, hospital cost, specific medication, implant utilization etc. Based on this analysis, the applications can further determine and suggest, (or facilitate informed determinations by management), changes to various clinical process using enhanced recovery pathways or other efficiency measures. Outcomes of these procedural changes can further be predicted and measured in terms of cost, length of stay, and quality of care in a risk adjusted measure.

In one or more embodiments, a system is provided that includes a performance evaluation component configured to identify groups of patients having received healthcare service by a healthcare organization and that are associated with a common healthcare service parameter and uncommon healthcare service parameters. For example, the common healthcare service parameter can include a common diagnosis received by the respective patients or a common medical procedure performed on the respective patients. The uncommon healthcare service parameters can include for example, a risk score, a medical caregiver, a facility or place of service, a supply type, a supply manufacturer, an avoidable complication, activities included in a course of care, or an order of care activities included in the course of care.

The system further includes a scoring component configured to determine performance scores for respective groups of patients, wherein the performance scores reflect clinical and financial performance of the healthcare organization in association with provision of the healthcare service to the respective groups of patients. In an aspect, the scoring component is configured to determine the respective performance scores based on: cost of care delivery to the respective patients of the groups of patients, length of stay (LOS) of the respective patients of the groups of patients, readmission rate of the respective patients of the groups of patients, complication rate of the respective patients of the groups of, financial variance of the respective patients of the groups of patients, and case complexity of the respective patients of the groups of patients.

The system further includes a comparison component configured to compare the respective groups of patients based on the performances scores respectively associated therewith to facilitate identifying one or more of the uncommon healthcare service parameters that are responsible for variance between at least a subset of performance scores. In an aspect, the comparison component is configured to select a subset of the respective groups of patients for comparison based on association with performance scores that differ beyond a threshold deviation value, and wherein the comparison component is configured to identify one or more of the uncommon healthcare service parameters that are responsible for variance between the performance scores of the respective groups included in the subset.

The system can further include an opportunity assessment component configured to determine an amount of unnecessary cost and/or days associated with provision of healthcare service to respective groups of patients included in the subset based on the one or more uncommon healthcare service parameters. The system can also include a recommendation component configured to determine a mechanism to improve the clinical or financial performance of the healthcare organization in association with provision of future healthcare service to new patients associated with the common healthcare service parameter based on the one or more of the uncommon healthcare service parameters.

In various additional embodiments, a method is provided that includes using a processor to execute the following computer executable instructions stored in a memory to perform the following acts: identifying groups of patients having received healthcare service by a healthcare organization and associated with a common healthcare service parameter and uncommon healthcare service parameters; determining performance scores for respective groups of patients, wherein the performance scores reflect clinical and financial performance of the healthcare organization in association with provision of the healthcare service to the respective groups of patients; and comparing the respective groups of patients based on the performances scores respectively associated therewith to facilitate identifying one or more of the uncommon healthcare service parameters that are responsible for variance between at least a subset of performance scores.

Other implementations provide a tangible computer-readable storage medium comprising computer-readable instructions that, in response to execution, cause a computing system to perform various operations. These operations can include identifying groups of patients with a common diagnosis having received healthcare service from a healthcare organization; determining performance scores for respective groups of patients, wherein the performance scores reflect clinical and financial performance of a healthcare organization in association with provision of the healthcare service to the respective groups of patients; and comparing the respective groups of patients based on the performances scores respectively associated therewith to facilitate identifying one or more healthcare service parameters that are responsible for variance between at least a subset of performance scores.

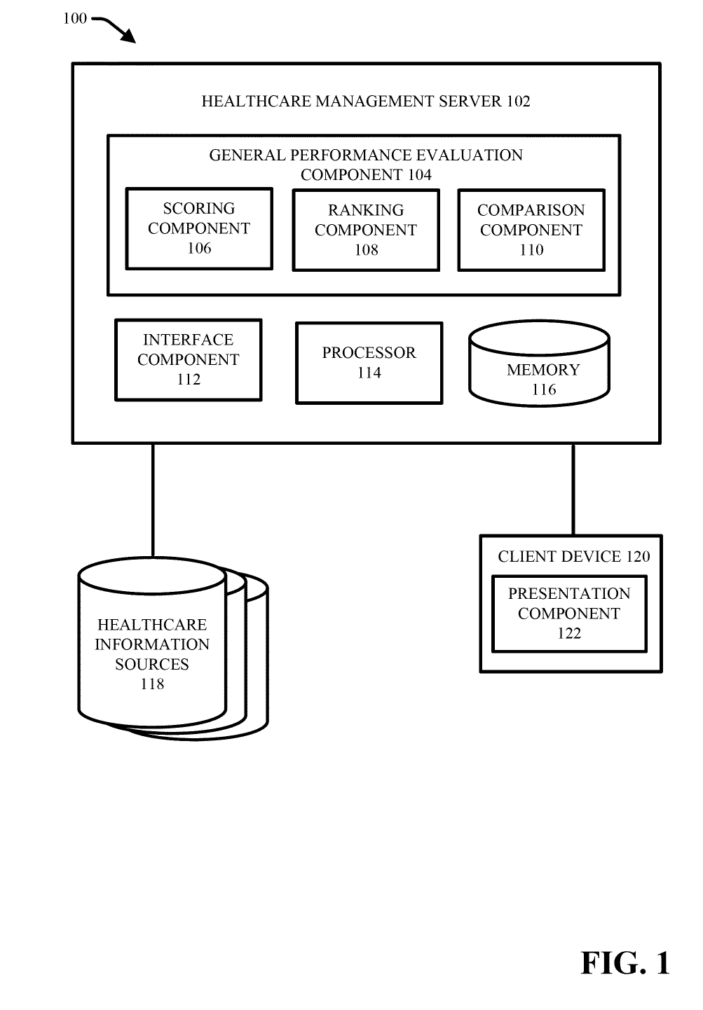

Referring now to the drawings, with reference initially to FIG. 1, presented is diagram of an example system 100 that facilitates providing clinically informed financial decisions that improve healthcare performance in accordance with various aspects and embodiments described herein. Aspects of systems, apparatuses or processes explained in this disclosure can constitute machine-executable components embodied within machine(s), e.g., embodied in one or more computer readable mediums (or media) associated with one or more machines. Such components, when executed by the one or more machines, e.g., computer(s), computing device(s), virtual machine(s), etc. can cause the machine(s) to perform the operations described.

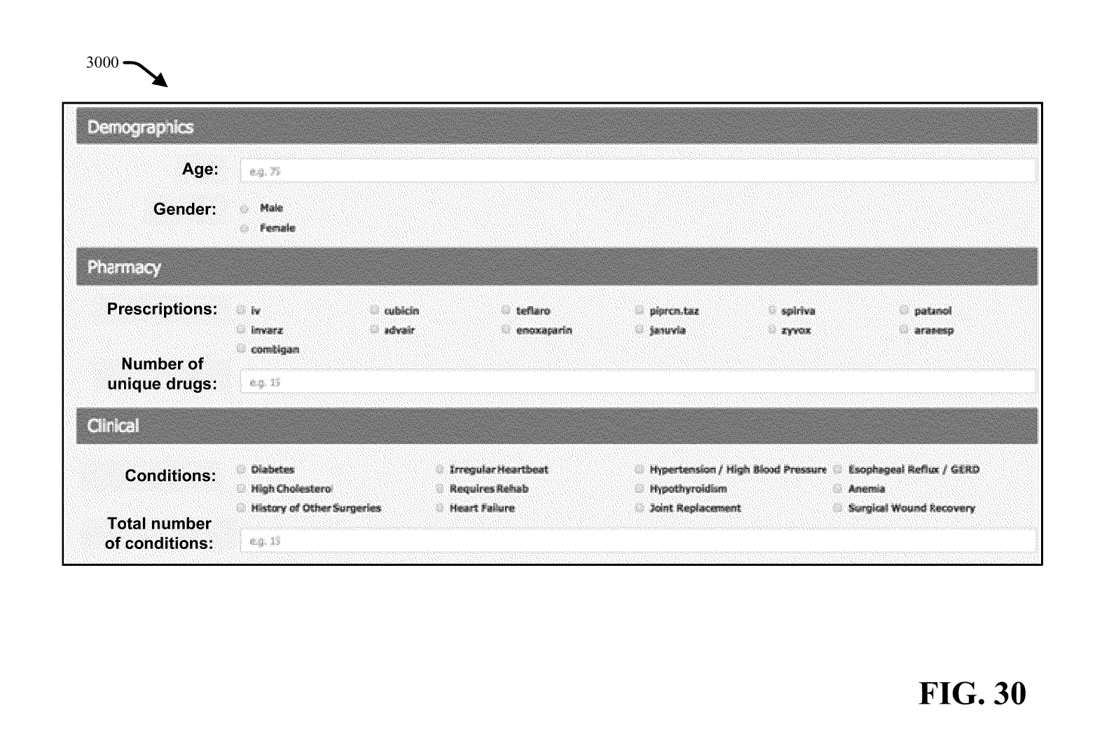

System 100 includes health care management server 102, a plurality of healthcare information sources 118 and one or more client devices 120. Generally, healthcare management server 102, healthcare information sources 118, and client device 120 can include memory (e.g., memory 116) that stores computer executable components and a processor (e.g., processor 114) that executes the computer executable components stored in the memory, examples of which can be found with reference to FIG. 30.

Healthcare management server 102 provides a variety of services associated with measuring, analyzing, and visualizing the clinical and financial performance of a healthcare organization or environment based on aggregated information received from a plurality of disparate healthcare information sources 118. These healthcare information sources 118 can include any potential information source that provides data associated with the clinical and/or financial performance of a healthcare organization. For example, these health care information sources 118 can include but are not limited to, clinical and financial information associated with: patients of the healthcare organization, medical personnel of the healthcare organization, non-medical personnel of the healthcare organization, services provided by the healthcare organization, facilities provided by the healthcare organization, resources of the healthcare organization, supplies employed by the healthcare organization, pharmaceuticals employed by the healthcare organization, and reimbursement agreements for the healthcare organization.

For example, healthcare management server 102 can receive information from different departments of a hospital pertaining to courses of care of patients associated therewith, information from electronic medical records for past and present patients of the hospital, billing information from a hospital billing system regarding costs associated with various aspects of patient care and hospital operation, and/or information pertaining to staff scheduling, performance and compensation. In another example healthcare management server 102 can receive and/or access information from a healthcare organization's practice management systems (PMS), health information systems (HIS), electronic medical record databases (EMRs), lab systems, medical reference databases, and existing decision support systems. In yet another example, healthcare management server 102 can receive information from patient monitoring systems and medical devices configured to sense and provide patient medical information.

Although not a complete listing, the following example healthcare information sources 118 can provide useful and relevant information to healthcare management server 102: enterprise systems, revenue cycle/management systems, cost management and information systems, resource scheduling and documentation systems, and the like which are used for e.g., physician billing, organization billing, resource scheduling and documentation, and administration functions.

An example enterprise system can include a system configured to manage aspects of the professional revenue cycle, including scheduling, billing, and claims, such as GE's Healthcare Systems Centricity Enterprise (formerly IDX Carecast) system. For example, an enterprise system (e.g., GE's Healthcare Systems Centricity Enterprise system) can provide healthcare management server 102 with information regarding patients seen by medical providers of the healthcare organization, including patient identifying information, patient demographic information, and patient contact information. For instances where a physician service has been rendered, the enterprise system can further provide information including but not limited to: information identifying the patient, the billing physician, the date of service, the current procedural terminology (CPT) code for the service, the associated diagnoses, the place of service, the referring physician, the professional charge, the primary insurer of record, and/or the payment received and contractual adjustment. CPT codes include a set of medical codes set maintained by the American Medical Association. CPT codes are used to describe and communicate uniform information about medical, surgical, and diagnostic procedures performed on patients among physicians, coders, patients, accreditation organizations, and payers for administrative, financial, and analytical purposes.

An example revenue cycle/management system can include a system configured to capture and provide information to healthcare management server 102 regarding the entire billing process of a healthcare organization. Siemen's Soarian® Financial system is an exemplary revenue cycle/management system which features a contract engine, an enterprise-wide master person index (EMPI), a claims engine, and a denial management engine. In an aspect, a revenue cycle/management system can provide healthcare management server 102 with billing information associated with diagnoses, procedures, and patient accounts. The billing information associated with diagnoses can include records for discharge diagnosis coded within financial system for patients seen by healthcare providers included in the healthcare organization. The information can include data objects identifying a patient name/MRN, ICD-9 diagnosis code, and date of diagnosis. The billing information associated with procedures can include records for procedures performed during a course of care of a patient, including information identifying the patient, the dates of the procedures, and the identity of the medical caregiver (e.g., physician, nurse, nurse practitioner, etc.) that performed the procedures.

Billing information associated with patient records can include an account number for a patient that represents a course of care for the patients. For example, an account number can represent a single inpatient stay, or a cluster of related outpatient visits. In one embodiment, financial information extracted from cost management/information (discussed hereafter) is used to identify a course of care of a patient and a length of stay of the patient at a hospital (or other medical institution) where the patient was admitted in association with the course of care. In an aspect, billing information for a patient record can include information identifying the patient, information on admission and discharge dates, admitting provider, discharging provider, primary care physician, referring physician, and the like.

An example cost management/information system can include a system configured to provide healthcare management server 102 with strategic planning, product line budgeting, cost accounting, and operational and capital budgeting of the healthcare organization. One example, cost management information system is the Eclipsys' Sunrise EPSi™ system. In an aspect, a cost management/information system can provide healthcare management server 102 with data related to technical charges, costs, reimbursement, and projected revenue information for patients cared for by the healthcare organization (e.g., over the course of care of the patients, including in-patient care, out-patient care, or combinations thereof). In an aspect, cost data can be broken into different categories associated with a course of patient care, such as of pharmacy, laboratory, imaging, nursing, etc. For example, healthcare management server 102 can receive data from a cost management information system that identifies a patient, the aggregate technical costs associated with care of the patient, projected revenue associated with care of the patient, reimbursement associated with care of the patient, and information identifying the attending physician associated with care of the patient.

An example, resource scheduling and documentation system that can serve as a healthcare information source 118 can include a system configured to record critical data on all procedures including patient identifying information, time in operating room, time of incision, time of closure, time out of operation room, emergency status, pre-operative/post-operative diagnoses, Anesthesiological Society of America (ASA) Score (reflects patient's short-term risk for mortality), and other data relating to medical procedures. Exemplary recourse scheduling and documentation systems include PICIS' OR Manager System.

Healthcare information sources 118 can also include medical monitoring devices and systems, and implantable and wearable medical devices. For example, a healthcare information source 118 can include a heart monitor or pedometer configured to send sensed information to healthcare management server regarding a patient cared for by the healthcare management server 102. Healthcare information sources can also include users personal devices (e.g., client devices) that can receive, generate and provide information related to operation and performance of a healthcare organization. For example, using a smartphone medical monitoring application, a patient can provide personal medical information to the healthcare management server 102. In another example, using a portable device, a healthcare personal can input data for provision to healthcare management server regarding a course of patient care.

In an aspect, healthcare management server 102 can receive information from various healthcare information sources 118 in real-time as it is received or generated at the respective sources. For example, as information is entered into an EMR system for a patient it can be sent to the healthcare management server 102. In another example, as vital signs are read from a patient monitoring medical device they can be sent to the healthcare management server 102. According to this aspect, the healthcare information source 118 can be configured to push the information to healthcare management server 102 upon entry, receipt or generation at the source. In another aspect, the healthcare management server 102 can continuously or periodically (e.g., hourly, daily, weekly, etc.) poll healthcare information sources 118 to identify and extract new information entered, received or generated at the respective healthcare information sources 118.

In various implementations, healthcare management server 102 can generate an index or data model that establishes relationships between aspects of the received information. The index or data model can further be stored in memory 116 accessible to healthcare management server 102. In particular, the index can establish relationships between patients, patient medical conditions, patient outcomes, patient quality, aspects of courses of patient care (e.g., diagnoses, inpatient and outpatient length of stay, operations/procedures performed), medical procedures, medical personnel, resources employed, pharmaceuticals employed, medical devices employed, costs, reimbursement, return on investments (ROI), etc. For example, healthcare management server 102 can identify information associated with a patient identity (even where the information was received from a plurality of different sources) and generate an index that ties various aspects of the information to the patient identity.

The indexes or models developed based on the received data facilitate efficient comparison and analysis of aspects of an integrated healthcare organization in ways that were previously not performed because the data necessary for such analysis was distributed amongst a plurality of different healthcare information sources and was not aggregated, indexed and related. Most current healthcare analytical applications are restricted by requiring data to be examined against a limited number of predefined dimensions. Healthcare management server 102 removes these restrictions by mapping characteristics that were historically either considered mutually exclusive (e.g., diagnosis related group (DRG) code (an institutional billing code), and current procedural terminology (CPT) code (the professional procedure code)) to a common or related baseline feature (e.g., a patient identity, a patient encounter, etc.) and then allowing comparison across multiple dimensions. Much of this information is located in different systems or information sources 118, with some being primarily financial or primarily clinical fields.

However, healthcare management server 102 can aggregate and index information received across a plurality of distributed information sources 118 regarding medical care provided by the healthcare organization and operation of the healthcare organization. For example, healthcare management server 102 can generate an index that relates the following elements: diagnosis, billing codes, procedure codes, physician (e.g., including primary operating, attending, anesthesiologist, radiologist, etc.), facility, cost (e.g., laboratory costs, radiology costs, pharmacy costs, supply costs, etc.). The index can then be employed by the healthcare management server 102 to perform analysis against the data in an automated and efficient manner to realize how various aspects of the integrated healthcare organization effect one another. For example, with the established index, healthcare information server 102 can enable mapping across various combinations of the elements related via the index and generate multidimensional comparison indices where prior systems are generally restricted to two-dimensional data comparisons.

Healthcare management server 102 is configured to employ the aggregated and/or indexed information to evaluate the clinical and financial performance of the healthcare organization from various perspectives and at various levels of granularity. In one or more embodiments, healthcare management server 102 provides various tools that measure the clinical and financial performance of the healthcare organization at several levels of granularity with respect to different patient groups. The different patient groups can be based on various filtering criteria, such as patients having same or similar care paths, patients having same or similar diagnoses, patients having a same or similar surgical procedure performed, etc. For example, with respect to different patient groups, healthcare management server 102 can measure cost of care delivery, length of stay, readmission rate, mortality rate, complication rate, and profit. The measured data can further be filtered based on various factors including but not limited to: time frame, physicians involved, medical personal involved, supplies involved, supply manufacturer, type of surgery, type of procedure, type of diagnosis, and patient demographics.

The healthcare management server 102 also provides a data interfacing tool (e.g., via interface component 112) that generates and presents reports and visualizations (e.g., graphical visualizations) depicting the measured data. The interfacing tool can also allow a user to provide input selecting types of measurements to evaluate and analytics to run, filtering criteria, and characteristics of the graphical visualizations (e.g., bar graph, pie graph, etc.) to be generated. As a result, healthcare management server 102 processes the received data in a format that is usable and understandable by management, to determine process changes that lead to better quality, efficiency and lower cost.

In addition, healthcare management server 102 is configured to identify and measure variances between different patient groups regarding cost of care delivery, length of stay, readmission rate, mortality rate, complication rate, and profit. Based on the identified variances, healthcare management server 102 can perform (and/or facilitate user performance of) root cause analysis to determine causes of these variances. The healthcare management server 102 (and/or a user) can further intelligently determine, develop, implement and monitor mechanisms for improving various aspects of operation of the healthcare organization with respect to efficiency, cost, quality of care, and employment satisfaction. At a high level, healthcare management server 102 can function as a great tool to optimize revenue generation, mitigate waste, enhance the patient experience and outcome, and provide for most efficient allocation of resources.

In an aspect, the components of healthcare management server 102 are provided at one or more dedicated computing devices. Users can interface with healthcare management server 102 via the one or more dedicated computing devices and/or via remote client computing devices 120. As used in this disclosure, the terms “content consumer,” “user,” or “participant” refers to a person, entity, system, or combination thereof that employs system 100 (or additional systems described in this disclosure).

A client device 120 can include any suitable computing device associated with a user and configured to interact with healthcare management server 102 and/or one or more healthcare information sources 118. For example, client device 120 can include a desktop computer, a laptop computer, a television, an Internet enabled television, a mobile phone, a smartphone, a tablet personal computer (PC), or a personal digital assistant PDA. In an aspect, client device 120 can include presentation component 122 to generate and/or display a graphical user interface (GUI) configured by interface component 112 that facilitates navigating and viewing information generated by healthcare management server 102 and interacting with healthcare management server to access and develop reports/visualization based on processing capabilities of healthcare management server 102.

In an aspect, presentation component 122 can include an application (e.g., a web browser) for retrieving, presenting and traversing information resources on the World Wide Web. According to this aspect, healthcare management server 102 can provide processed information and interactive data evaluation tools (e.g., for report generating and the like described infra) to users via a website platform that can be accessed using a browser provided on their respective client devices 120. In another aspect, healthcare management server 102 can provide processed information and interactive data evaluation tools (e.g., for report generating and the like described infra) to users via a mobile application platform.

The various components and devices of system 100 can be connected either directly or via one or more networks, (not shown). Such network(s) can include wired and wireless networks, including but not limited to, a cellular network, a wide area network (WAD, e.g., the Internet), a local area network (LAN), or a personal area network (PAN). For example, a client device 120 can communicate with content healthcare management server 102, one or more healthcare information sources 118 and/or another client device (and vice versa) using virtually any desired wired or wireless technology, including, for example, cellular, WAN, wireless fidelity (Wi-Fi), Wi-Max, WLAN, and etc. In an aspect, one or more components of system 100 are configured to interact via disparate networks. It is to be appreciated that although various components of healthcare management server 102 are depicted as co-located on a same device, such implementation is not so limited. For example, one or more components of healthcare management server 102 can be located at another device or associated system, a client device 120, another server, and/or the cloud.

In accordance with various embodiments, health care management server 102 can include general performance evaluation component 104 and interface component 112 to provide for measuring, analyzing, and visualizing the clinical and financial performance of a healthcare organization or environment. General performance evaluation component 104 is configured to facilitate high level investigation/evaluation of the overall performance of a healthcare organization. For example, general performance evaluation component 104 can provide a big picture of the clinical and financial performance of different patient groups of the health care organization to facilitate identifying certain patient groups to select for further analysis in association with determining changes to the processes via which care is delivered to reduce cost and improve clinical efficiency and quality.

As used herein, the term patient is used to refer to a has received some form of medical care from a healthcare organization. A patient group refers to two or more patients grouped by at least one common parameter. In some contexts described herein, the term patient encounter refers to an instance of interaction between a patient and a healthcare organization in association with provision of a healthcare service to the patient by the healthcare organization. For example, a patient encounter can refer to a surgical procedure performed on patient and the associated post operative care. In another example, a patient encounter can refer to care received by a patient from a particular sector of the healthcare organization or for a particular healthcare reason (e.g., pregnancy). In various other contexts described herein, the term patient encounter refers the course of care received by a patient from a healthcare organization. The phrase course of care refers to the timeline of care from initial consolation and/or admission of a patient to discharge of the patient by the healthcare organization. The course of care can include all patient encounters (e.g., in-patient and/or out-patient) associated with care of the patient with respect to any particular medical condition.

General performance evaluation component 104 can include scoring component 106, ranking component 108 and comparison component 110. Scoring component scoring 106 is configured to score patient groups with respect to various clinical and financial performance criteria. In an aspect, scoring component 106 is configured to determine scores for different patient groups that reflects the overall quality and efficiency of clinical service provided to the respective groups of patients and a degree of cost to the healthcare organization in association with provision of the service. The scores associated with the different patient groups allow the healthcare management server 102 and/or a user to that quickly assesses how a patient group has performed for rapid comparison on both clinical and financial criteria.

The different patient groups can be selected by a user and/or automatically selected by general performance evaluation component 104 based one or more filtering criteria or parameters, referred to herein as ‘healthcare service parameters.’ The different patient groups will be associated with at least one common healthcare service parameter (e.g., same diagnosis, same procedure, etc.), and various uncommon healthcare service parameters (e.g., different course of care, different facility of service, different physician, different medical device employed for surgery, etc). Evaluation is performed to determine one or more uncommon healthcare service parameters associated with the respective patient groups that are attributed to observed variances in the quality, efficiency, and cost of healthcare provided to the respective patient groups by the healthcare organization.

These healthcare service parameters can include any potential aspect of healthcare delivery that can have a direct or indirect affect on the clinical and/or financial outcome of healthcare provided to a patient. For example, these healthcare service parameters can relate to the patient, such as but not limited to: a diagnosis of the patient, a procedure performed on the patient (e.g., a surgical procedure, an imaging procedure, a laboratory test, etc.), a medical complication associated with care of the patient, a preference of the patient, a health history of the patient, a demographic profile of the patient (e.g., age, gender, ethnicity, etc.), an insurance carrier, a risk score associated with the patient, or a type of patient (e.g., inpatient vs. outpatient). These healthcare service parameters can also relate to the medical personnel involved in caring for the patient (e.g., physicians, nurses, technicians, midwifes, etc.), the facility or place where care is provided (e.g., emergence room (ER), skilled nursing facility, intensive care facility, etc.), and supplies utilized in care (e.g., imaging devices, implantable devices, medical devices, biological supplies, pharmaceuticals, monitoring tools, network/computer based medical related communication/management systems, hospital infrastructure, etc.). In another aspect, these healthcare service parameters can relate to various aspects of a course of care, such as the time period of care, the order in which care activities were provided, the duration between care activities, the frequency or repetition of certain care activities, etc.

It should be appreciated that the healthcare service parameters described above are merely examples of possible factors that can influence the cost and clinical quality/outcome of medical care. These example healthcare service parameters are not intended to limit the scope of the subject discloser and other possible healthcare service parameters are considered within the spirit of the subject disclose.

In various embodiments, different groups of patients can be determined based on association with at least one shared healthcare service parameter, such as a common diagnosis or a common procedure received, and association with two or more uncommon healthcare service parameters, such as but not limited to: treating physician, a time period of care, a risk score (e.g., where the risk score reflects a predetermined level of clinical and/or financial risk to the healthcare organization in association with caring for the patient), a demographic (e.g., age, gender, health history, etc.), an insurance carrier, a type of patient (e.g., inpatient vs. outpatient), a treating facility or unit (e.g., emergency room, referral), etc.

The scoring component 106 is configured to evaluate each patient group on the basis of one or more of the following metrics: cost of care delivery, length of stay (LOS), readmission rate, complication rate, financial variance, and complexity of case and/or clinical risk. In an aspect, scoring component 106 can determine a score for each of the individual metrics and an overall operating score that reflects overall performance of the healthcare organization based on all the metrics. Using these performances scores, the healthcare management server 102 and/or clinicians and operators can rapidly develop apples to apples comparisons across patient populations, supporting rapid analysis and root cause investigation of variance between groups of patients or clinical approaches.

Scoring component 106 can score each group of patients (respectively aggregated by a common healthcare service parameter, such as facility, diagnosis, diagnosis related group (DRG), risk score, or any other possible aggregation factor) based on their relative performance against the metrics noted above. In an aspect, the scoring component 106 can weigh each of the relevant metrics based on working with a select group of clinicians, forcing the results to the range of 0-100. In an aspect, the scoring component can employ Equation 1 below to generate an overall operating performance (OP) score.

$$OP score = {F}_{1} ( Cost of Care ) + {F}_{2} ( LOS ) + {F}_{3} ( Readmission Rate ) + {F}_{4} ( Avoidable Complication Rate ) + {F}_{5} ( Financial Variance ) + {F}_{6} ( Case Complexity ) \qquad Equation 1$$

The values of the respective variables including cost of care, LOS, readmission rate, avoidable complication rate, financial variance and case complexity can be received by the healthcare management server 102 by the one or more healthcare information sources 118 and/or be previously determined by the healthcare management server 102 and stored in memory (e.g., memory 116) accessible to the healthcare management server. In an aspect, the respective coefficients are calculated so that the resulting OP score has a numerical value on a scale from 0-100 with 0 being the minimum OP score and 100 being the maximum. In an aspect, initial values for the coefficient F1-F6 are determined using a linear regression model that is run to measure the OP score against known quality measures. The initial coefficient values are then calibrated based on actual feedback provided by physicians and/or other medical staff caregivers regarding their interpretation of the relative importance of the respective performance measure variables.

In some aspects, for each variable except case complexity, a lower number improves the OP score. F1-F6 are weighted coefficients that the relative importance of the associated variable with respect to overall financial and clinical operating performance of the healthcare organization. For example, a group of patients with a low cost of care, low LOS, low readmission rate, low complication rate, low financial variance and high case complexity will score better than similar results with low case complexity. The OP score provides a standardized metric that allows for any group of patients to be compared to any other group of patients and any physician specialty to be compared to another. Inherently, LOS will be higher for more complex cases. Accordingly, if a hospital regularly handles high complexity cases that are high cost but does so with low readmission and complications as well as with high consistency, the scoring component 106 will generate low number score that compares favorably with another hospital that has lower case complexity (with lower cost and LOS) but struggles with outcomes and with consistency. This unique approach gives operators a quick glance view for where quality outcomes and consistent financial discipline are generally practiced.

Ranking component 108 is configured to rank different patient groups based on their respective OP scores. In an aspect, healthcare management server 102 can select a subset of the patients groups for deeper investigation based on their ranking. In another aspect, healthcare management server 102 can select a subset of the patient groups for further analysis (e.g., by improvement evaluation component 202 discussed infra) based on their OP scores failing to meet a threshold score value.

Comparison component 110 can facilitate comparison between different patient groups based on their respective OP scores to identify factors responsible for variances between certain OP scores and to identify factors responsible for consistency between other OP scores. For example, comparison component can 110 can identify similar patient groups having substantially disparate OP scores (e.g., based on a threshold degree of variance/deviation) for comparing on additional levels of granularity (e.g., by improvement evaluation component 202 discussed infra) to determine root causes of the variance. The similarity among the patient groups for example can be based on an initial filtering criteria (e.g., identify all patients admitted in the past three months) and the establishment of the different groups can be based on a secondary filtering criteria (e.g., diagnosis code, primary operating procedure, physician, etc.). For example, different groups of patients having a similar diagnosis yet a different treating physician and various other potential differences (e.g., with respect to facility, course of care, primary surgical procedure, insurance carrier, etc.) can be identified.

In one or more embodiments, scoring component 106 can generate OP scores for a large number of potential patient groups determined based on fixed filtering criteria. For example, scoring component 106 can be configured to analyze a group of all patients of a healthcare organization diagnosed with a specific cancer having a diagnosis code number 1248. This group of patients diagnosed with cancer 1248 can be associated with an OP score determined by scoring component 110 in accordance with Equation 1 above. According to this example, scoring component 106 can filter the patient group into a plurality of different group clusters based on different filtering criteria. For example, scoring component can employ a first filtering criteria (e.g., physician) to establish a first group cluster of patient associated with diagnosis code 1248. Scoring component 106 can then employ Equation 1 above to determine OP scores for the respective patient encounter subgroups in the first cluster. Scoring component 110 can also establish second, third, fourth, etc., patient group clusters based on predetermined second, third, fourth, etc., filtering criteria, and determine OP scores for each of the different patient groups included in each of the different clusters. It should be appreciated that the number of different patient clusters can be predefined based on a set of predefined filtering parameters which can include any of the healthcare service parameters discussed herein (e.g., physician, care path, facility, inpatient vs. outpatient, insurance carrier, etc.).

Comparison component 110 can employ the OP scores respectively associated with the different patient groups in each of the different clusters to determine the specific filtering criteria that is associated with high variance in OP scores and/or associated with low OP scores. The specific filtering criteria associated with a group cluster having high variance in OP scores (e.g., with respect to a variance threshold) and/or low OP scores (e.g., with respect to a score value threshold) can be identified as a healthcare service parameter that contributes significantly to the overall OP score for the patient group diagnosed with cancer 1248. For example, the specific healthcare service parameters can be identified as an area in which improvement can be achieved with respect to the overall clinical and financial performance of the healthcare organization.

For example, comparison component 110 can compare respective patient groups included in a same cluster (e.g., first cluster, second cluster, third cluster, etc.) established based on a specific filtering criteria (e.g., physician) and evaluate the degree of variance between the OP scores for the respective groups. In an aspect, a threshold variance percentage can be employed to determine or infer whether a specific filtering parameter is associated with a high degree of variance. For example, where performance scores for a set vary above an N percentage, comparison component 110 can determine the filtering parameter for the set significantly impacts the respective OP scores and/or significantly impacts the overall OP score for the entire patient group diagnosed with cancer 1248. For instance, if respective patient groups established based on treating physician have substantially different OP scores (e.g., above the threshold percentage deviation), comparison component 110 can determine that the treating physician substantially contributes to the resulting OP scores for patients diagnosed with cancer 1248. Comparison component 110 can further identify substantially low performance scores for patient groups in the set to pinpoint the specific treating physician that is associated with low OP scores. Comparison component 110 can perform this evaluation process for each set of patient groups established based on the various different predefined filtering criteria to determine what specific healthcare service parameters have a significant impact on the clinical and financial performance of the healthcare organization with respect to a particular patient group (e.g., cancer patients diagnosed with code 1248), and the degree to which the respective healthcare service parameters impact the respective OP scores.

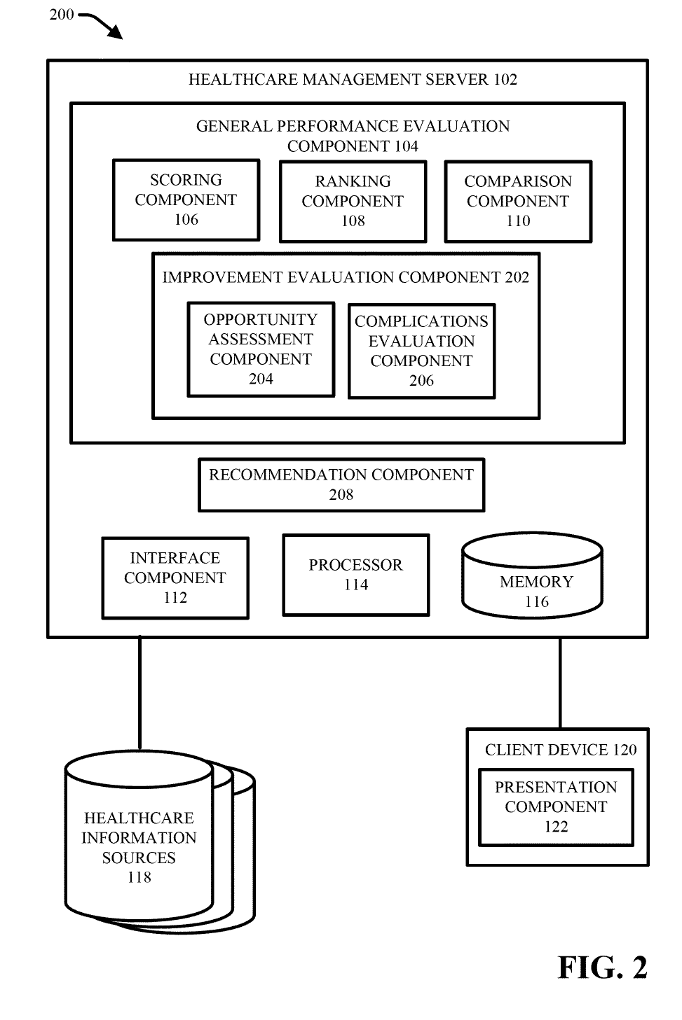

FIG. 2 illustrates another example system 200 that facilitates providing clinically informed financial decisions that improve healthcare performance in accordance with various aspects and embodiments described herein. System 200 includes same or similar aspects as system 100 with the addition of improvement evaluation component 202 and recommendation component 208. Repetitive description of like elements employed in respective embodiments of systems described herein is omitted for sake of brevity.

Improvement evaluation component 202 is configured to perform comparative analysis between various aspects of a healthcare organization to identify areas where clinical and/or financial performance improvement can be achieved. For example, improvement evaluation component 202 can compare departments of the healthcare organization, procedures performed by the healthcare organization, caregiver personnel (e.g., physicians, nurses, technicians, etc.) of the healthcare organization, courses of care of the healthcare organization, patients of the healthcare organization, clinical cases of the healthcare etc., with respect to performance quality, efficiency, ROI, or any other comparative metric to identify variances between the compared objects. Improvement evaluation component 202 can then determine or infer type and nature of variability at the category level (e.g., supports granular analysis of root drivers). For example, improvement evaluation component 202 can determine why one department, procedure, physician group, clinical case type, course of care, etc., is more profitable and/or efficient than the other. In another example, improvement evaluation component 202 can determine or infer why certain days in the emergency room are associated with better quality of patient care than other days.

Improvement evaluation component 202 can also develop a likely linear regression model based on comparison between aspects of departments, procedures, physicians, courses of care, etc., that correlates variances with true cost drivers. Based on cost analysis, improvement evaluation component 202 can determine current and potential ROI with respect to capital expenses (e.g., equipment, construction of new facility, construction of new operating room, etc.). In addition, improvement evaluation component 202 can analyze a healthcare organization's overall service portfolio (service portfolio optimization) with respect to ROI. For example, improvement evaluation component 202 can determine or infer what services are being offered and can be offered at a reasonably profitable margin based on reimbursement rates. Furthermore, in addition to comparative analysis of internal aspects of a healthcare organization, improvement evaluation component 202 can compare aspects of the healthcare organization to external systems, organizations and recognized standards. For example, improvement evaluation component 202 can provide benchmarking services for a procedure against peer organizations.

In various implementations, improvement evaluation component 202 can include opportunity assessment component 204 and complications evaluation component 206. Opportunity assessment component 204 is configured determine amounts of clinical and financial improvement opportunities available for different patient encounter groups. For example, opportunity assessment component 204 can determine an amount of improvement that can be achieved for a group of patient encounters filtered based on a common criteria (e.g., procedure performed, diagnosis, care plan, etc.) with respect to cost of care, LOS, and readmission rate. In particular, opportunity assessment component 204 can determine an amount of cost, days (e.g., with respect to LOS), or readmissions that could have been avoided by a group of patients or a group of encounters while maintaining or improving quality of care. Opportunity assessment component 204 can also determine an amount of potential financial savings/gain that could be achieved in association with performing a particular procedure, caring for a particular type of patient, or performing a particular course of care, and a mechanism that can result in the achievement of the financial savings/gain (e.g., a procedural change, a supply change, a personnel change, etc.).

In one embodiment, opportunity assessment component 204 is configured to select groups of patients to perform opportunity assessment analysis on based on their OS ranking (e.g., groups having OP score below a threshold value), and/or similar groups of patients identified by comparison component 110 having substantially disparate OP score. In another embodiment, opportunity assessment component 204 can automatically select groups of patients for opportunity assessment component that are grouped by billing code, diagnosis code), primary procedure code ((surgery or other procedure), admission source (direct admit, referral, emergency room), patient demographic data (gender, age), or admitting or primary physician. This allows for the opportunity assessment to span a broad number of potential drivers behind clinical and financial variance, leading to novel insights in how patients are treated and identification of the root sources of the clinical and financial variance.

In one or more embodiments, opportunity assessment component 204 assesses cost variance across controllable criteria and compiles the various costs into an accessibility metric. The controllable criteria can be predefined. For example, the controllable criteria can include criteria such as operating room costs, emergency department costs, supply costs, laboratory costs, radiology costs, LOS, etc.). The assessment controls for variance in quality outcomes, showing where additional expense is producing a clinical benefit. If the additional expense does not produce a clinical benefit, it is shown as a controllable cost.

With respect to readmission rate and LOS, the opportunity assessment component 204 calculates the variance by comparing each observation to a specific standard (the mean, a specific percentile or a statistical benchmark such as standard deviation) and assessing the distance between that observation and that target. Those observations that are above that mark are considered opportunity, and opportunity assessment component 204 calculates the difference then sum up the differences. If the observations are below the mark, the opportunity assessment component 204 considers them better than the standard.

In an aspect, because LOS and readmission are outcomes variables, opportunity assessment component 204 does not calculate whether there is clinical benefit. However for cost, the opportunity assessment component 204 performs the same calculation but with one clear distinction. The opportunity assessment component 204 uses the outcomes measures (LOS, readmissions, complication rates and mortality) to determine if there is a clinical benefit from the associated cost. If a group costs more but produces better outcomes, the financial opportunity is discounted.

In an aspect, opportunity assessment component 204 presents opportunity in two ways. LOS and Readmission are presented in aggregate, meaning, this is the total improvement opportunity for the population. Cost, on the other hand, is presented both in aggregate (total opportunity) and at the cost category level (pharmacy, ICU, laboratory, radiology, OR, etc.). This tells the healthcare organization the specific cost category that is responsible for the deviation and the percentage of the total opportunity that is associated with that operating category.

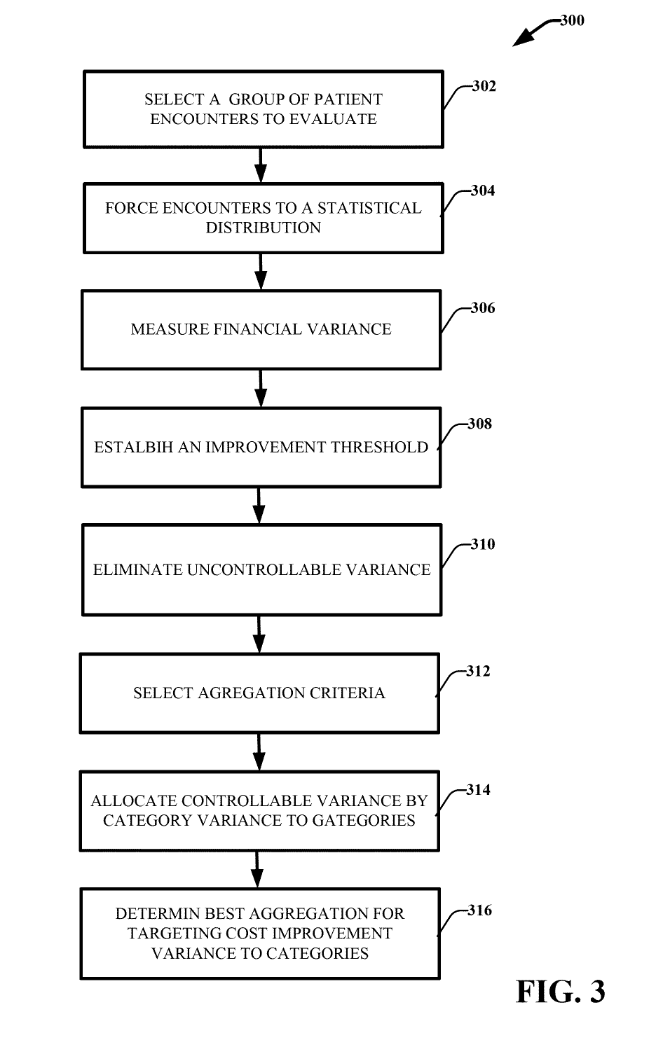

FIG. 3 provides an flow diagram of an example method 300 for assessing an amount of clinical and financial improvement opportunities available for different patient groups by opportunity assessment component 204 in accordance with various aspects and embodiments described herein.

At 302, the opportunity assessment component 204 can select or receive a selection of a group of patient encounters to evaluate (e.g., a group of patients that have undergone a particular procedure, a group of patients that have had a particular diagnosis, a group of patients that have undergone a particular course of care, etc.). For example, a user employing system 200 can provide filtering criteria that selects a particular group of patients encounters. In another example, opportunity assessment component 204 can examine specific group of patients based on being associated with an OS ranking below a threshold value. At 304, the opportunity assessment component 204 forces the group of encounters or patients to a standard normal statistical distribution (e.g., a bell curve) with respect to total cost of care or total LOS. At 306, the opportunity assessment component 204 measures the degree of financial or LOS variance between the different encounters. Based on the degree of financial or LOS variance, at 308 the opportunity assessment component 204 determines a desired improvement threshold. For example, the improvement threshold can be based on a standard deviation in the financial/LOS variance, the mean cost of care or LOS, or the decile value.

At 310, the opportunity assessment component 204 eliminates the financial and/or LOS variance amounts that are considered uncontrollable variance. In particular, opportunity assessment component 204 is configured to examine opportunity with respect to LOS and cost is divided into two groups—controllable variance and uncontrollable variance. Controllable variance are those elements of the total opportunity that are clinically within the realm of a healthcare organization to address. For example, a good portion of variance associated with LOS falls into cost in the ‘room and board’ category. This type of cost variance can be classified (e.g., based on previously determined information identifying controllable and non-controllable variance) as uncontrollable variance and thus the cost associated with ‘room and board’ is eliminated as an opportunity cost. In an aspect, the costs that can be controlled are included in specific predetermined clinical areas, including but not limited to: operating room (OR), laboratory, radiology, pharmacy, intensive care (ICU), anaesthesia and supply costs. Other components of cost are ignored as uncontrollable.

At 312, the opportunity assessment component 204 can receive selection of an aggregation criteria (or automatically perform analysis for a set predefined aggregation criteria (e.g., facility, procedure, physician, diagnosis, DRG, supply, etc). At 314, the opportunity assessment component 204 allocates the controllable variance by category, and at 316 the opportunity assessment component 204 (and/or a user) can determine an aggregation criteria that provides the best opportunity for improving cost or LOS. For example, the opportunity assessment component 204 can identify other drivers of variance by examining the costs through certain aggregation filters. For instance, the opportunity assessment component 204 can determine that one physician is responsible for much more variance than another and thus recommendation component 208 can direct the organization to focus on that physician's approach. In another example, the opportunity assessment component 204 can determine that a group of patients with a particular diagnosis have much more variance in cost than another group. In turn, recommendation component 208 can recommend the healthcare organization focus on how those patients are being treated.

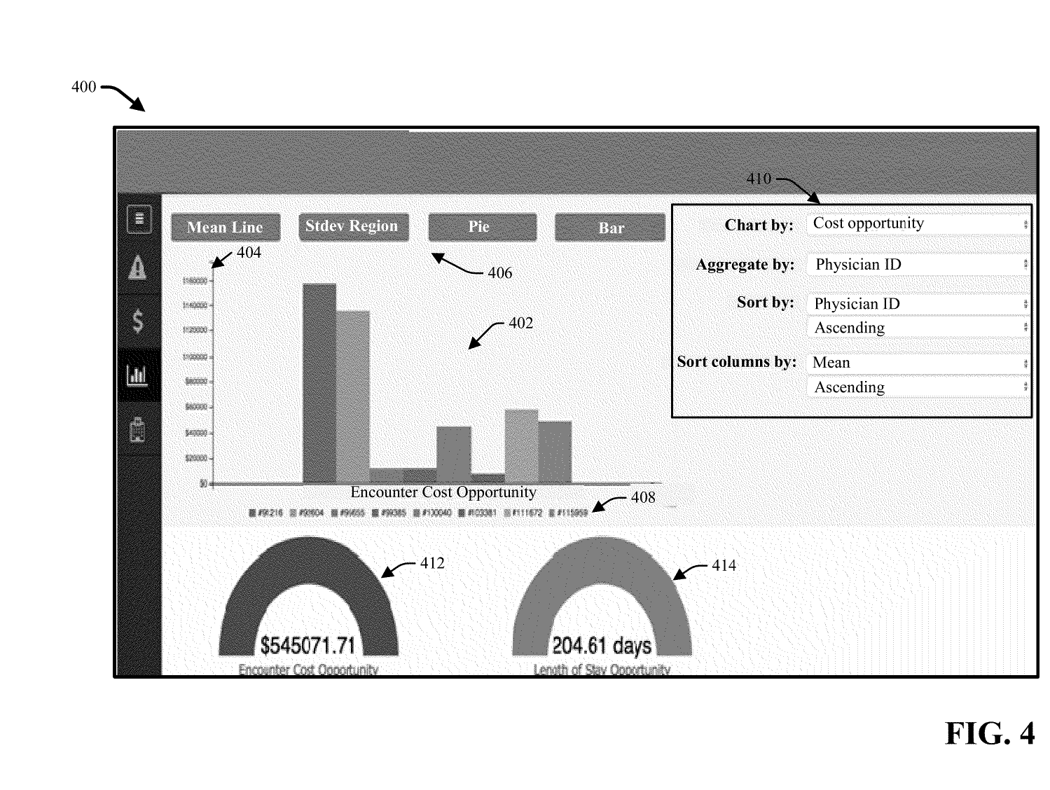

FIG. 4 presents an example graphical user interface 400 that facilitates generating and providing visualizations representing amounts of clinical and financial improvement opportunities available for different patient groups in accordance with various aspects and embodiments described herein.

In various embodiments, interface 400 is generated/configured by interface component 112 and rendered at a client device 120 via presentation component in response to a request to perform an opportunities assessment application provided by the healthcare management server 102 and driven by the opportunity assessment component 204. Interface 400 includes a graphical representation 402 depicting the different amounts of opportunity cost for a group of selected patient encounters. Each bar of the bar diagram corresponds to a different patient encounter subgroup sorted and filtered based on physician ID. The different bar can be distinguished by a different color or pattern assigned to a different physician ID, as identified in legend 408. The vertical axis 404 corresponds to incremental monetary amounts. A total opportunity cost 412 and a total LOS opportunity cost 414 for the group is shown below the graphical representation 402.

An interactive menu 410 is included in the user interface that includes various drop down menu item with different selection criteria via which a user can provide input to control the content being evaluated and the manner in which it is displayed and aggregated. For example, the selection criteria can include ‘chart by,’ ‘aggregate by,’ ‘sort by,’ and ‘sort columns by. A user can provide input selecting the particular aggregation criteria to control how a group of patient encounters is evaluated with respect to available opportunity. For example, the graphical representation 402 depicted in interface 400 is aggregated by physician ID. By looking at the representation and output indicating total cost opportunity 412 and LOS opportunity 414, it is apparent that a change to the manner of operation by the physician ID corresponding to the first two columns can provide for a significant gains in terms of cost and LOS. By changing the aggregation criteria, a user can quickly compare the degree in which different care delivery factors (e.g., physician, supply, procedure performed, laboratory studies conducted, etc.) contribute to cost opportunity and LOS opportunity for the particular group of patient encounters being evaluated. The ‘chart by’ menu item can include for example, chart by cost opportunity, chart by LOS opportunity, chart by readmission rate decrease opportunity, etc. In addition, a menu above the graphical representation allows the user to select different types of graphical views (e.g., mean line, standard deviation region, pie, and bar) via which to view the data.

With reference back to FIG. 2, complications evaluation component 206 is configured to quantifying the financial impact of complications associated with different patient encounters. Complications are defined as an unfavorable evolution in a disease, health condition or therapy. Complications fall into two categories: potentially avoidable and unavoidable. For example, fractured ribs due to CPR are a common unavoidable complication when CPR is administered on elderly patients. In another example, infection is often an unavoidable complication for transplant patients who are taking immune-suppressive drugs to prevent rejection of a transplanted organ. Some avoidable complications can include for example: wound infections due to poor infection control, unusually high blood utilization due to bleeding, intestinal obstructions (ileus) due to improper pharmaceutical management, or a second surgery due to poor surgical processes in the first instance.

Avoidable complications have a substantial impact on the cost and quality of care. The complications evaluation component 206 uses proprietary techniques to assess avoidable complications and determines and/or facilitates determining which complications should be prioritized for improvement and which may not have as much fiscal impact and therefore can be addressed later.

In various implementations, complications evaluation component 206 is configured to compare a group of similar patient encounters and identify those which experienced complications and those which didn't are without complications. For example, complication evaluation component 206 can examine a group of patients that received treatment for a same illness or conditions (e.g., same diagnosis) and identify respective patients in the group that experienced one or more medical complications in association with treatment. In another example, complications evaluation component 206 can examine a group of patients having received a same or similar surgical procedure and identify respective patients in the group that experienced one or more medical complications.

The complications evaluation component 206 can further characterize the respective complications as either avoidable or unavoidable based on predetermined clinical criteria regarding avoidable and non-avoidable complications (e.g., stored in memory 116, provided by the one or more healthcare information sources 118, and/or otherwise accessible to the healthcare management server 102). For example, complications evaluation component 206 can employ a look-up table that identifies a plurality of possible medical complications as either avoidable or unavoidable. In another example, complications evaluation component 206 can employ a look-up table or algorithm that identifies or generates an output identifying a complication as either avoidable or unavoidable based on the complication and one or more parameters specific to the patient encounter that involved the complication. For example, these parameters can relate to the patient's demographics (e.g., age, gender, etc.), and/or a pre-existing medical condition or status of the patient prior to involvement of the medical organization in treatment. Complications evaluation component 206 further eliminates patient encounters involving unavoidable complications from consideration.

The complications evaluation component 206 employs a proprietary technique to identify the additional cost of encounters with one or more complications, and to isolate the portion of that cost that is genuinely driven by the presence of the one or more complications, respectively. In an aspect, for a group of patient encounters, complications evaluation component 206 identifies the various avoidable complications that occurred. For each avoidable complication, the complications evaluation component 206 identifies the encounters that involved the avoidable complication and determines the mean cost for the encounters that involved the complication. The complication evaluation component further determines a mean cost of encounters that did not involve the complication and determines a mean cost for the specific complication based on a difference between the mean cost of encounters involving the complication and the mean cost of encounters not involving the complication. (e.g., mean cost of complication A=mean cost of encounters with complication A−mean cost of encounters without complication A).

Complication evaluation component 206 further isolates the unique cost due to each specific complication that occurred in the group of patient encounters by identifying a subset of the patient encounters involving the specific complication and at least one or more other complications. This process is known as addressing covariance. Covariance is a statistical process that measures how much two or more variables change as a result of the existence of the other variable. For example, if a patient has complication A, (e.g. an infection), the increase in the cost of an encounter may be $1,000. If the patient experiences complication A and complication B, the increase in the cost of the encounter may be $1,500. If the patient experiences complication A and complication C, the cost of the encounter may be $1,750. The process of applying the covariance calculation allows for the isolation of the cost that is entirely attributable to complication A and only complication A, thereby mathematically eliminating or addressing the impact of other complications on the cost of a complication. By applying this methodology, the true financial impact of the complication is identified. Complications evaluation component 206 can perform this process across all patient encounters where more than one complication that occurred within the encounter. At the end of the analytic run, the specific contribution to cost for each potential avoidable complication is isolated for further analysis and evaluation in association with determining mechanisms to improve clinical and financial performance of the healthcare organization (e.g., by improvement evaluation component 202 and/or recommendation component 208).

In various implementations, for a specific group of patient encounters analyzed by complications evaluation component 206, ranking component 108 can rank the respective complications based on respective amount of costs associated therewith. For example, an avoidable complication with the highest cost can be ranked first, followed by another avoidable complication with the second highest and so on. Complications evaluation component 206 can further determine a priority order for addressing avoidable complications based on their respective ranking. For example, complications evaluation component 206 can be configured to select the top N highest ranked complications. In another aspect, complications evaluation component 206 can select an avoidable complication based on association with a cost value above a threshold value. For example, the threshold value can be based on the amount of contribution of the avoidable complication cost to the total mean cost associated with all identified avoidable complications for the analyzed group of patient encounters. For instance, complications evaluation component 206 can select those complications whose cost is X % or more of the total cost associated with all identified complications. In another example, the threshold value can be a predetermined monetary amount. For instance, complications evaluation component 206 can be configured to select the avoidable complications associated with a financial cost greater than M amount of dollars.

In some embodiments, recommendation component 208 is configured to generate and provide a recommendation identifying the complications selected by complication component 206 as target or priority complications for the healthcare organization to address in association with servicing future patients that are associated with a same or similar encounter. For example, recommendation component 208 can provide a recommendation identifying avoidable complications A and D as high cost contributors for patients encounters involving surgical procedure XYZ (or whatever other aggregation factor grouping the analyzed patient encounters, such as a same diagnosis, a same physician, a same facility, etc.).

In various additional embodiments, complications evaluation component 206 is configured to perform additional analysis on the selected avoidable complications to determine or infer one or more mechanisms to reduce costs associated with the respective complications. For example, complications evaluations component 206 can determine mechanisms to reduce future occurrence of the complications and/or mechanisms to reduce costs associated with the complications if and when they do occur in the future. In an embodiment, improvement evaluation component 202 can analyze (e.g., using care path evaluation component 1402) the care paths followed for the respective patient encounters involving an avoidable complication determined to be high cost priority complication to address with priority (e.g., via the mechanisms discussed supra). Based on the analysis, improvement evaluation component 202 can determine or infer clinical and/or procedural factors contributing to the occurrence and/or costs of the complications. In addition, based on the identified factors, healthcare management server 102 (e.g., via care path creation component 1404) can develop a model care path for the type of patient encounter being evaluated that is determined to minimize the occurrence and/or cost of the complications in similar future patient encounters.

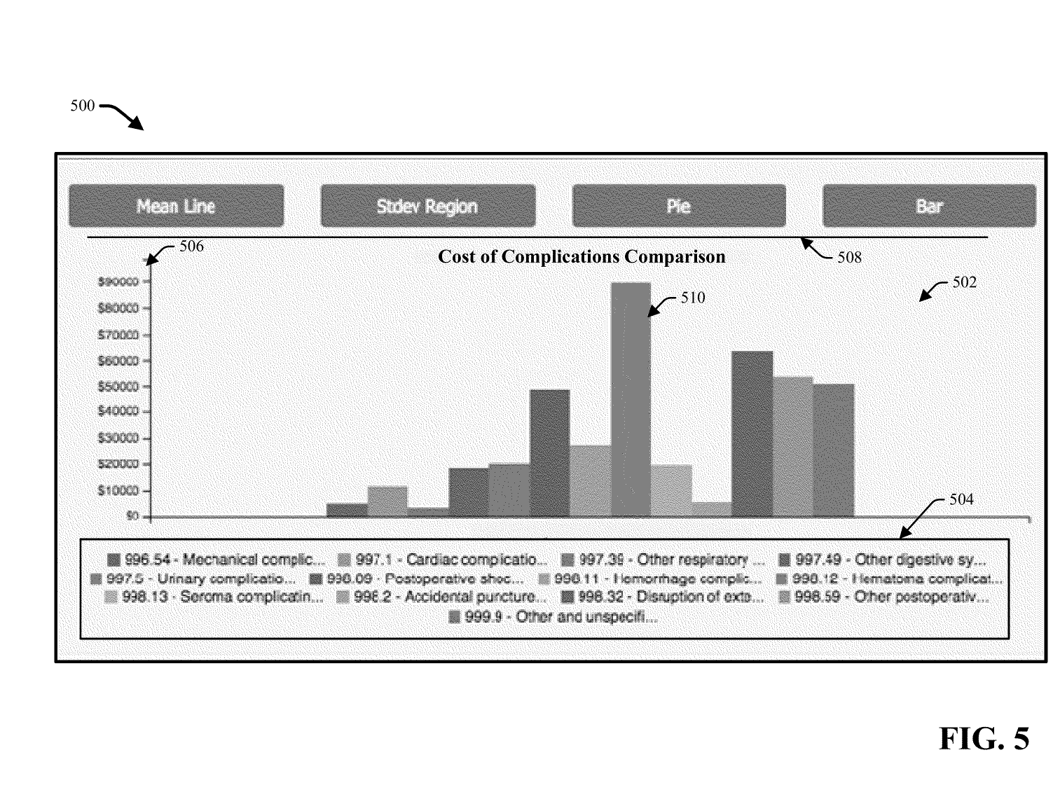

FIG. 5 presents an example graphical user interface 500 providing a visualization that quantifies the financial impacts of complications associated with a group of similar patient encounters in accordance with various aspects and embodiments described herein.

In various embodiments, interface 500 is generated/configured by interface component 112 and rendered at a client device 120 via presentation component 122 in response to a request to perform a complications assessment application provided by the healthcare management server 102 and driven by the complications evaluation component 206. Interface 500 includes a graphical representation 502 depicting the different monetary costs associated with various types of medical complications that have occurred with respect to a particular group of patient encounters (e.g., encounters associated with a particular diagnosis, procedure, course of care, facility, physician, time period, etc.). Each bar of the bar diagram corresponds to a different type of complication. The different bars can be distinguished by a different color or pattern assigned to each complication, as identified in legend 504. The vertical axis 506 corresponds to incremental monetary amounts.

In addition, a menu 508 above the graphical representation allows the user to select different types of graphical views (e.g., mean line, standard deviation region, pie, and bar) via which to view the data. As can be seen by looking at the bar graphical representation 502, the complication corresponding to bar 510 has the greatest financial impact on the healthcare organization for the group of patient encounters being evaluated. Accordingly, based on the analysis provided by complications evaluation component 208 as visually depicted in interface 500, healthcare management server 102 (and/or a user of the system) can determine that measures to reduce the number of occurrences and/or controllable costs associated with that complication should be investigated and implemented as a high priority.

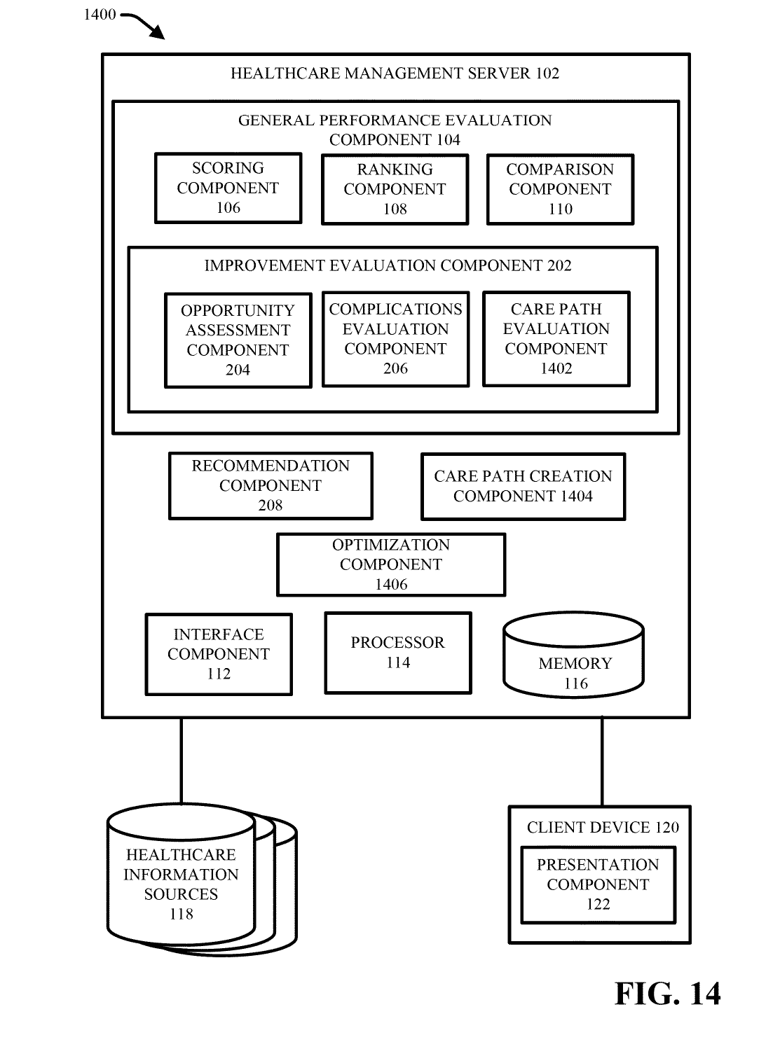

Referring back to FIG. 2, recommendation component 208 is configured to determine or infer and recommend mechanisms to optimize performance and operation of a healthcare organization in terms of efficiency, quality/standard of care, cost, course of care outcome, patient satisfaction, employee satisfaction, etc., based on the analysis performed by improvement evaluation component 202 (e.g., opportunity assessment component 204, complications evaluation component 206, and care path evaluation component 1402 discussed in FIG. 14). In particular, recommendation component 208 can determine one or more changes to aspects of the healthcare organization to increase or improve efficiency, quality/standard of care, cost, course of care outcome, patient satisfaction, employee satisfaction, service portfolio, etc., based on identified healthcare service parameters responsible for variance in OP score, demonstrating room for increased clinical and financial opportunity, and/or considered to have a significant impact on cost (e.g., as determined by comparison component 110, opportunity assessment component 204, complications evaluation component 206, and care path evaluation component 1402 discussed in FIG. 14). These changes can consider impact on the entire healthcare organization or a sub-sector of the healthcare organization (e.g., a specific clinical group, a specific procedure, a specific division of the healthcare organization, a group of patients, a staff division, a course of care for a particular condition).

For example, based on analysis regarding variance in efficiency of performance of a medical procedure with respect to number and type of caregivers involved, recommendation component 208 can determine or infer a change to number of caregivers required for provision of the medical procedure that will increase quality of care and efficiency of performance of the medical procedure. In another example, based on analysis regarding opportunity cost associated with usage of a particular medical device or medical service, recommendation component 208 can determine or infer that the particular medical device or medical service should be removed from the healthcare organization's service portfolio. In yet another example, based on analysis regarding ROI of a high salaried physician in terms of services provided by the physician, profits associated with services provided by that physician, referrals received based on the physician, and other measurable metrics regarding ROI of the physician, recommendation component 208 can determine or infer a change in the physician's salary.

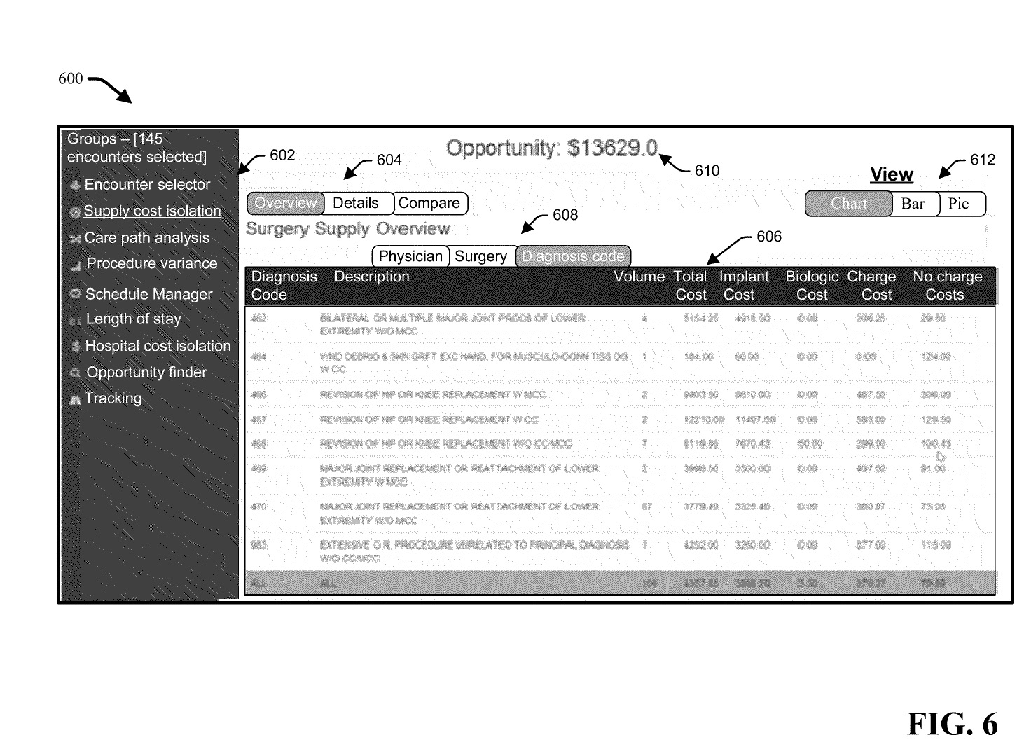

FIGS. 6-13 present a series of example graphical user interfaces 600-1300 that facilitate generating and providing visualizations quantifying financial and clinical variances in supply cost for different patient groups in accordance with various aspects and embodiments described herein. In various embodiments, interfaces 600-1300 are generated/configured by interface component 112 and rendered at a client device 120 via presentation component 122 in association with a supply cost isolation function/application provided by the healthcare management server 102 and driven by comparison component 110 and/or improvement evaluation component 202. The supply cost isolation function/application is configured to facilitate identifying and visualizing variances in supply costs associated with provision of healthcare services by a healthcare organization for different patient encounter groups and different filtering criteria. The patient encounter groups can be predefined and/or selected by the user.

Using the supply cost isolation function/application, a user can provide input selecting one or more healthcare service parameters for which to evaluate the impact on supply cost (e.g., physician, diagnosis, procedure, supply type, manufacturer). The user can also provide input selecting a preferred visualization format (e.g., chart, bar graph vertical, bar graph horizontal, pie graph, etc.). The supply cost isolation function/application further allows the user to select different patient groups for comparison with respect to variances or commonalities in supply costs or a specific characteristic of the supply costs (e.g., supply type, manufacturer, etc.) and variances in clinical and other financial quality/efficiency metrics (e.g., LOS, readmission rate, mortality rate, total hospital cost, etc.). Repetitive description of like elements employed in respective embodiments of interfaces, systems and methods described herein is omitted for sake of brevity.

With reference to FIG. 6, interface 600 includes a chart generated in association with a request to perform supply cost isolation analysis in association with a selected group of patient encounters. As indicated at the top of a side bar menu 602, 145 patient encounters have been selected for evaluation. In an aspect, the groups of patient encounters was selected an ‘encounter selector’ application/function provided by the healthcare management server 102. For example, the top menu item in the side bar menu 602 corresponds to an ‘encounter selector application.’ Selection of the ‘encounter selector’ menu item can open an application that allows the user to select a previously defined/identified group of patient encounters, and/or to provide filtering criteria that defines a new group of patient encounters. For example, the filtering criteria can include a time period, a type of procedure, a diagnosis group, a physician, etc. The side bar menu 602 further includes a plurality of additional menu items corresponding to other functions/applications provided by the healthcare management server, including: ‘supply cost isolation,’ care path analysis, ‘procedure variance,’ ‘schedule manager,’ ‘length of stay,’ ‘hospital cost isolation,’ ‘opportunity finder,’ and ‘tracking.’ The side bar menu item ‘supply cost isolation,’ is underlined in interface 600 to indicate that the application is currently selected and running.

In association with performance of the ‘supply cost isolation’ function/application by healthcare management server 102, interface 600 includes a function menu bar 604, a filtering criteria menu bar 608, and a view menu bar 612. The function menu bar 604 includes an option to examine an overview of supply cost for the selected group of patient encounters, examine details of supply cost for the selected group of patient encounters, and to compare supply costs for the selected group of patient encounters with one or more other groups of patient encounters. The filtering criteria menu bar 608 includes different filtering criteria for which to filter the supply cost, including by physician, by surgery, and by diagnosis code. It should be appreciated however that these filtering criteria are merely exemplary and menu options for other types of filtering criteria disclosed herein can be provided in the filtering menu bar 608. The view menu bar 612 include different options for which to view the selected data set, including (but not limited to): a chart view, a bar graph view, and a pie graph view.

As seen in interface 600, the overview function is selected from the function menu bar 604 (e.g., as indicate by the darkened fill color), the diagnosis code option is selected from the filtering criteria menu bare 608, and the chart view is selected from the view menu bar 612. Chart 606 is generated and displayed based on the selected input menu items, input fields, and patient encounter. Chart 606 includes an on overview of the supply cost associated with the selected patient group as filtered based on diagnosis code. The top menu bar of the chart includes fields identifying the diagnosis code, a description of the diagnosis code, volume (e.g., number of patient encounters associated with the diagnosis code), total cost, implant cost, biological cost, chargeable cost, and non chargeable costs. The specific values/text for each of these fields provide in the chart are merely exemplary and not germane to the described functional aspects of the described supply cost isolation application.

Interface 600 further includes a total opportunity cost value 610 presented at the top of the display. This opportunity cost value is determined by opportunity assessment component 204 as described herein based on the specific criteria being evaluated (e.g., supply cost), the encounter population selected, and the filtering parameters selected by the user.

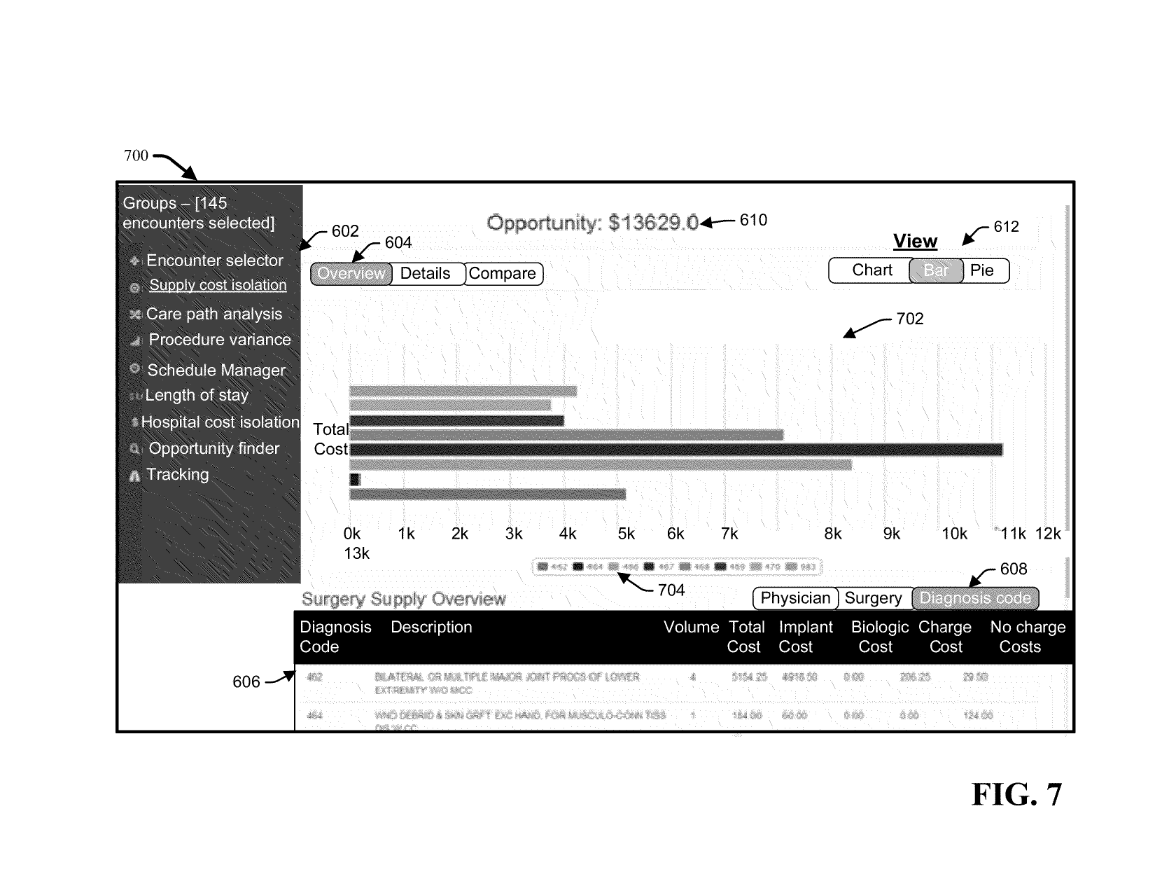

FIG. 7 presents an example user interface 700 generated in response to selection of the bar chart view from the view menu 612 of interface 600. The other input/filtering criteria described with respect to interface 600 remain the same. Interface 700 includes a graphical visualization 702 of the total supply cost for the selected patient encounter population with respect to diagnosis code. Each bar of the bar graph corresponds to a different diagnosis code and can be provided in a distinguishing color. The horizontal axis corresponds to cost. A legend 704 is provided below the visualization associating each bar color with a specific diagnosis code. By examining visualization 702, the user can quickly evaluated the impact of supply costs with respect to the different diagnoses.

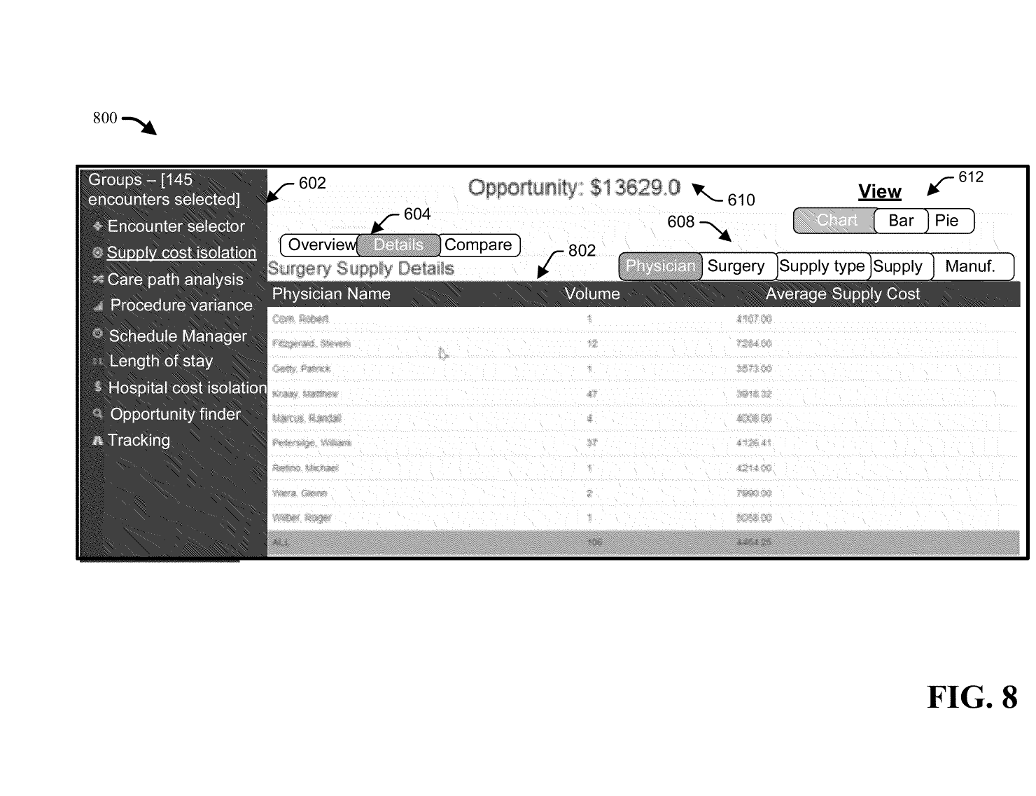

FIG. 8 presents an example user interface 800 generated in response to selection of new input criteria from interface 600 or 700. In interface 800, the details function is selected from the function menu bar 604, physician filtering criteria is selected from the filtering criteria menu bar 608, and the chart view is selected from the view menu bar 612. As a result a new chart 802 is generated and presented that identifies the average cost of supplies per physician and the respective volume of patient encounters that each physician treated (with respect to the selected patient encounter group). As previously noted, the actual input values included in the chart 802 are not essential to the subject description and thus not described. In an aspect, in response to selection of the details function from the function menu bar 604, additional filtering criteria menu options are presented (e.g., supply type, supply, and manufacturer).

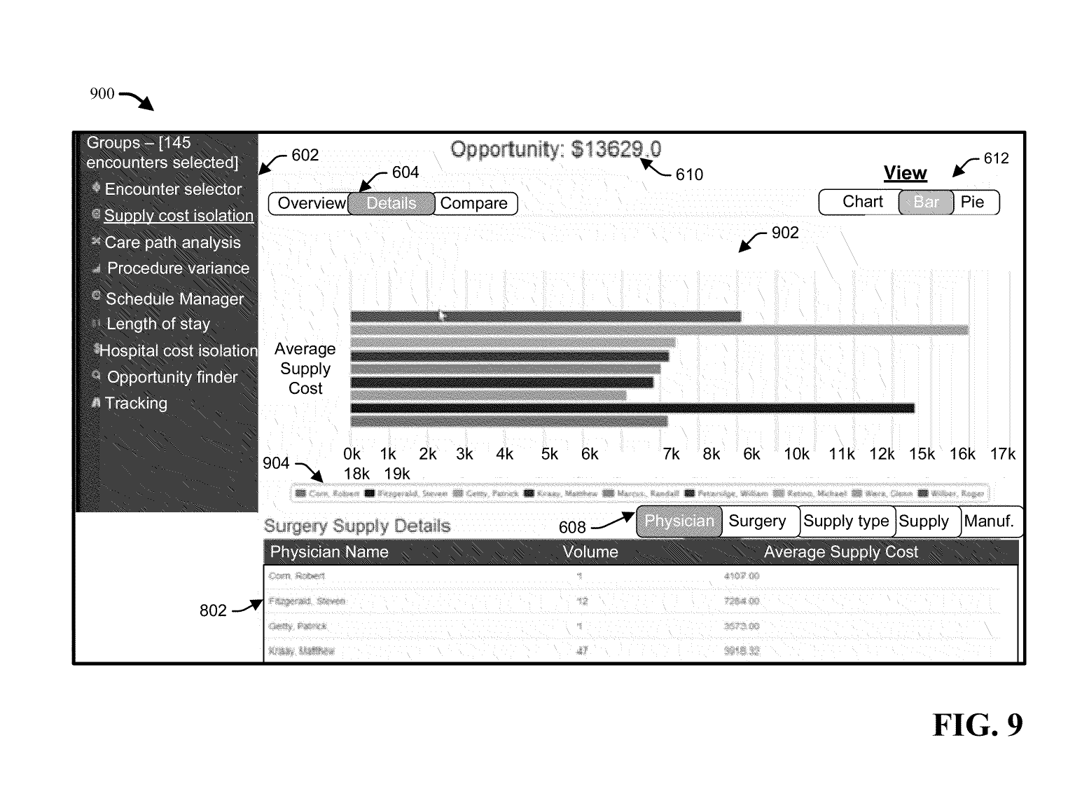

FIG. 9 presents an example user interface 900 generated in response to selection of the bar chart view from the view menu 612 of interface 800. The other input/filtering criteria described with respect to interface 800 remain the same. Interface 900 includes a graphical visualization 902 of the total supply cost for the selected patient encounter population with respect to each treating physician. Each bar of the bar graph corresponds to a different physician name and can be provided in a distinguishing color. The horizontal axis corresponds to cost. A legend 904 is provided below the visualization associating each bar color with a specific physician name. By looking at visualization 902, a user can efficiently evaluate the amount of supply cost attributed to each of the different physicians and identify those physician's that are responsible for the greatest amount of supply costs.

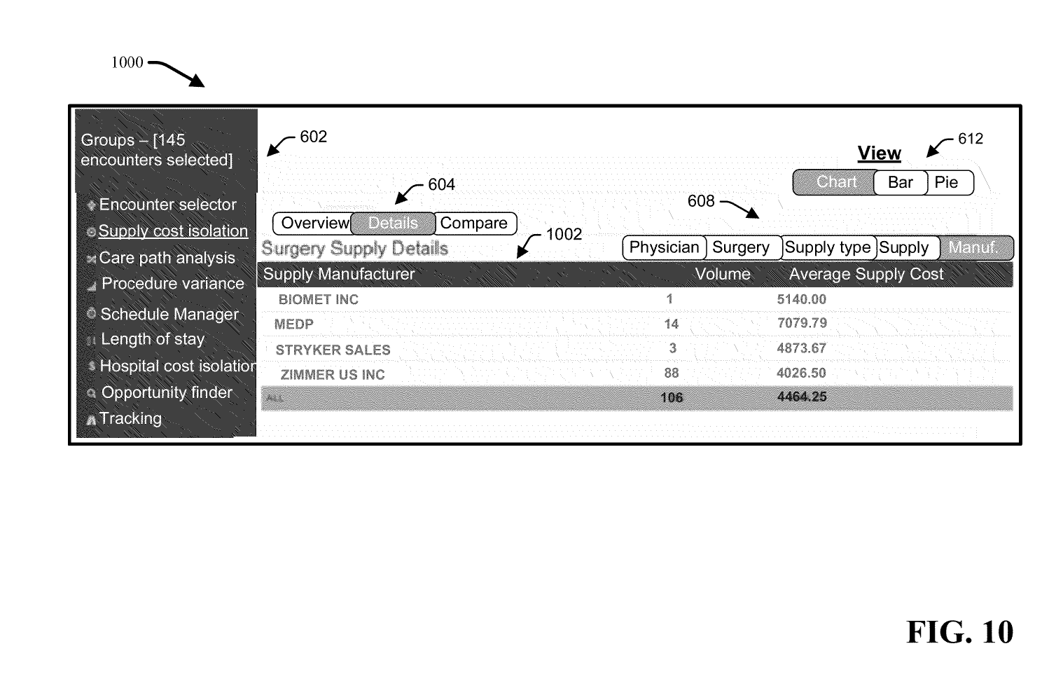

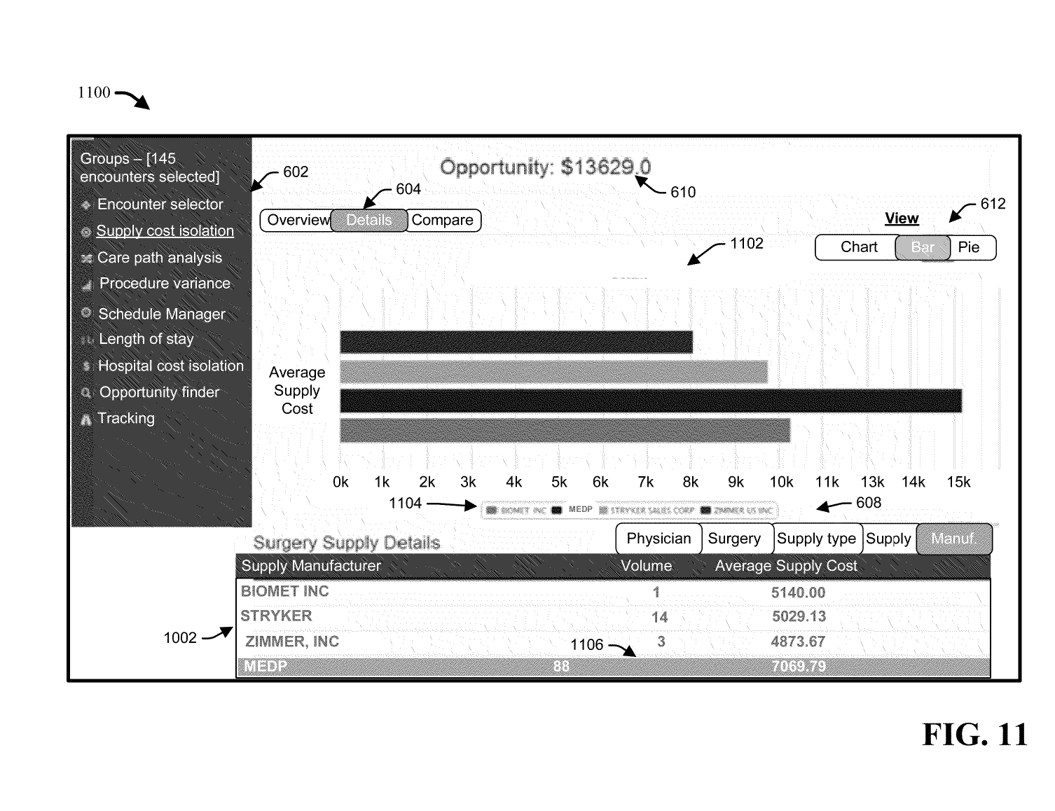

FIG. 10 presents an example user interface 1000 generated in response to selection of new input criteria from interface 600, 700, or 900. In interface 1000, the details function is selected from the function menu bar 604, manufacturer filtering criteria is selected from the filtering criteria menu bar 608, and the chart view is selected from the view menu bar 612. As a result a new chart 1002 is generated and presented that identifies the average cost of supplies per manufacturer and the volume of cases (from the 145 encounter groups) associated with each manufacture. In this example interface 1000, the actual input values included in the chart 1002 are clarified to facilitate describing an example comparison application initiated based on the data presented in FIGS. 11-13.

FIG. 11 presents an example user interface 1100 generated in response to selection of the bar chart view from the view menu 612 of interface 1000. The other input/filtering criteria described with respect to interface 1000 remain the same. Interface 1100 includes a graphical visualization 1102 of the average supply cost for the selected population with respect to manufacturer. Each bar of the bar graph corresponds to a different manufacturer and can be provided in a distinguishing color. The horizontal axis corresponds to cost. A legend 1104 is provided below the visualization associating each bar color with a specific physician name. By looking at visualization 1102, the user can quickly determine which of the different manufacturers are associated with the greatest and the least average supply cost. In addition, by looking at chart 1002, the user can learn that the manufacturer ‘MEDP.’ provide about 90% (e.g., 88 cases per volume, indicated by reference arrow 1106) of the supplies for the studied patient population. Based on this observation, the user has decided to select a subset of the patient encounters that involved supplies from the manufacturer ‘MEDP’ for comparison analysis.

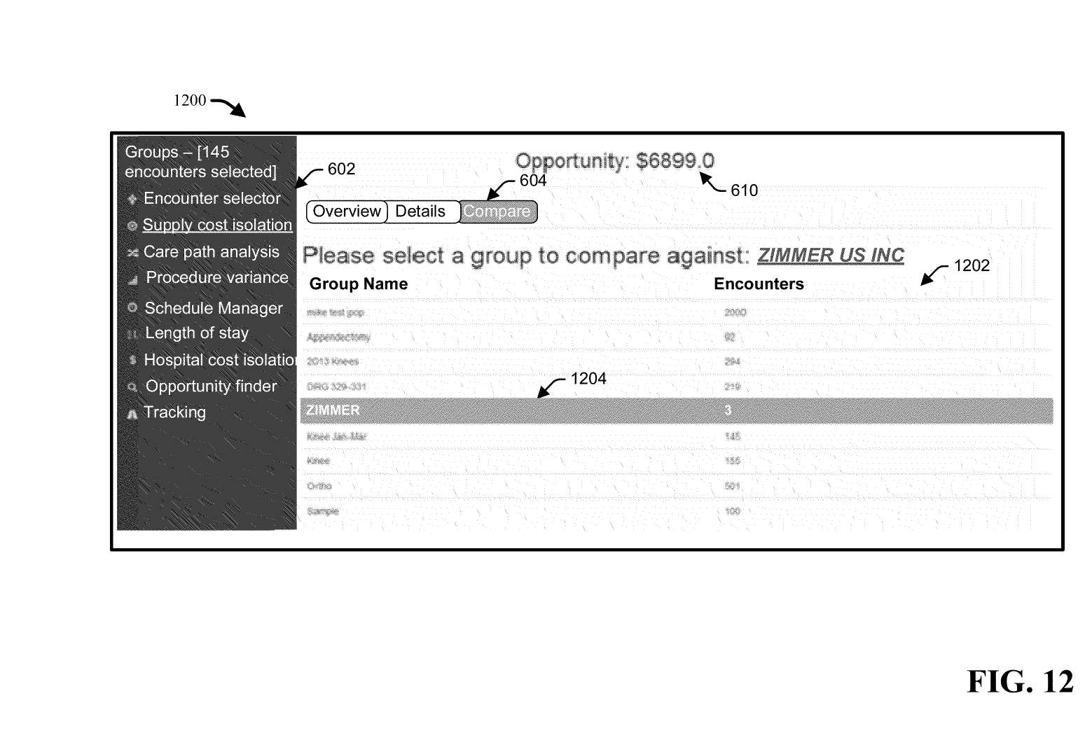

FIG. 12 presents an example user interface 1200 generated in response to selection of the manufacturer ‘MEDP’ from chart 1002 and selection of the compare function from the function menu bar 604. Interface 1200 presents a prompt 1202 with a plurality of different patient encounter groups that the user can select for comparison with the selected subset of patient encounters that involved supplies from the manufacturer ‘MEDP.’ For example, the comparison function can compare the selected subset of patient encounters whose supply usage was from ‘MEDP’ with another group of patient encounters that involved a less expensive supply manufacturer, with respect to various clinical and financial performance metrics. In an aspect, the possible patient groups included in prompt 1202 can be predetermined based on prior usage of the encounter selector application. In another example, the possible patient groups can be predetermined by healthcare management server 102. Still in yet another example, the possible patient groups can be created on the fly by the user using the patient encounter selector application. As shown in interface 1200, the patient group named ‘Zimmer, Inc.’ has been selected for comparison.

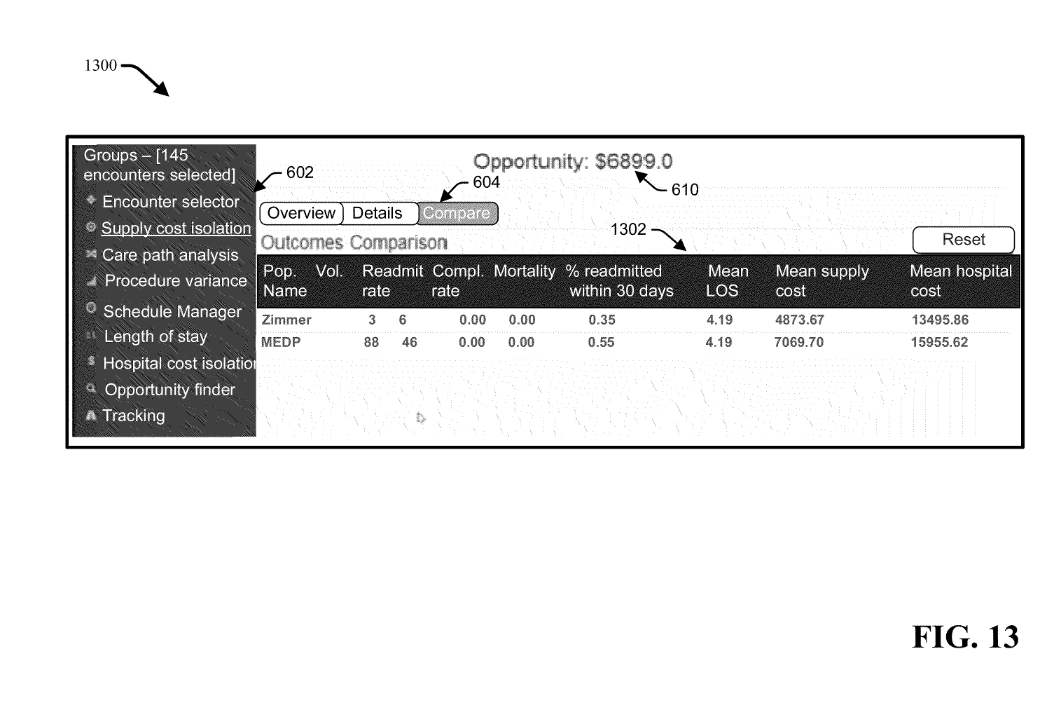

FIG. 13 presents an example user interface 1300 generated in response to selection of the patient encounter group named Zimmer, Inc. from interface 1200 for comparison with the subset of patients whose supply usage was from the manufacturer ‘MEDP.’ The resulting graph 1302 compares the two patient encounter populations with respect to volume, readmission rate, complication rate, mortality rate, % readmitted within 30 days, mean LOS, mean supply cost and mean hospital cost. By looking at the comparison chart, a user can learn that the two patient populations have similar clinical outcomes with respect to readmission rate, complication rate, mortality rate, % readmitted within 30 days, and mean LOS, despite the difference in cost associated with using the more expensive supply manufacturer MDEP. Accordingly, the user can easily determine that usage of the more expensive supply manufacturer does not produce a clinical benefit and thus the less expensive supply manufacturer Zimmer, Inc. should be used in the future.

Referring now to FIG. 14, presented is another example system 1400 that facilitates providing clinically informed financial decisions that improve healthcare performance in accordance with various aspects and embodiments described herein. System 1400 includes same or similar aspects as system 200 with the addition of care path evaluation component 1402, care path creation component 1404, and optimization component 1406. Repetitive description of like elements employed in respective embodiments of systems described herein is omitted for sake of brevity.

As previously described, improvement evaluation component 202 is configured to provide various analytical tools that facilitate identifying areas or factors of a healthcare delivery system where financial and/or clinical improvement can be achieved. For example, opportunity assessment component 204 is configured to identify and quantify avoidable financial and clinical loss associated with different patient encounters based on different controllable contributing factors, such as treating physician, procedures performed, supplies used, facility, inpatient vs. outpatient, etc. Because the clinical and/or financial loss is attributed to a parameter that can be adapted without substantially impacting the quality of care (e.g., with respect to the followed standard of care), the amount of clinical and/or financial loss is considered an amount of potential opportunity increase that can be achieved in association with a modification of the contributing factor.

Recommendation component 208 can further provide recommendations regarding the identified controllable contributing factors as areas to target for modification in association with a particular type of patient encounter in the future. For example, opportunity assessment component 204 can identify factors associated with clinical procedures, supply usage, laboratory testing, radiology performance, facility usage, etc., that do not result in a clinical benefit, (e.g., with respect to LOS, readmission rate, mortality rate, complication rate, etc.) yet result in added cost. Opportunity assessment component 204 can further determine the amount of financial and/or clinical gain that could be achieved in response to a change to those factors (e.g., usage of a less expensive supply manufacturer, usage of a less expensive pharmaceutical, elimination of radiology or laboratory testing for certain patient conditions, etc. Recommendation component 204 can in turn recommend the potential changes to the factors contributing to financial and/or clinical loss based on the amount of opportunity (e.g., clinical and/or financial) that can be achieve in association with implementation of the changes.

Similarly, complications evaluation component 206 can determine the clinical and financial impact of various avoidable complications. Recommendation component 208 can further determine which complications are associated with the greatest loss (e.g., both clinical LOS, readmission rate, and financial loss) and recommend those complications as priority targets for investigation and implementation of mechanisms to minimize the complications and/or associated loss. Furthermore, complications evaluation component 206 can determine mechanisms to reduce the occurrence of these avoidable complications and/or reduce the financial and/or clinical loss due the occurrence of these avoidable complications.

Care path evaluation component 1402 can facilitate identifying areas or factors of a healthcare delivery system where financial and/or clinical improvement can be achieved, as well as mechanisms to modify and/or improve the manner in which care is delivered to achieve financial and/or clinical improvement. In particular, care path evaluation component 1402 is configured to facilitate various comparative analysis of different care paths followed for similar groups of patient encounters (grouped by at least one common healthcare service parameter) to identify clinical and financial variances between the different care paths. Based on the care path analysis, care path creation component 1404 can determine changes to the manner in which a particular course of care is delivered to improve the clinical and financial performance of the healthcare organization. The patient encounters can be grouped for example by diagnosis or procedure and/or other suitable filtering criteria (e.g., physician, facility, condition severity, inpatient vs. outpatient, a demographic criteria such as age, gender, etc., type of insurance carrier, etc.).

A course of patient care can include some or all patient encounters (e.g., in-patient and/or out-patient) associated with care of a patient with respect to the particular medical condition, diagnosis, or operating procedure. For example, the course of care can begin upon an initial patient visit/consolation, condition diagnosis, prescription of treatment, initiation of treatment, and/or admittance (e.g., to a other medical institution admittance). A course of patient care can end after the patient has stopped receiving care (e.g., either electively or at the direction of a medical caregiver), or is otherwise released from care. In an aspect, a course of patient care can include readmission.

Information (e.g., provided by one or more information sources 118) regarding a course patient care can include but is not limited to: information identifying activities/events associated with the course of care, timing and sequence of performance of the activities/events, resources associated with the activities/events, and medical personal associated with the activities/events.

A patient event or activity associated with a course of care can include information associated with any action that was performed over the course of care, including but not limited to: a patient encounter with medical personnel (e.g., doctor visits, check-ups, therapy sessions, etc.), patient admittance to a hospital (or other medical institution), patient movement/relocation to a different sector of a hospital or medical institution, patient discharge, a medical procedure performed, a laboratory test performed, an imaging study performed, administration of a pharmaceutical, or other medical aid provided. A patient care event or activity can also include information regarding patient status checks and associated findings performed over the course of care (e.g., patient vital signs, changes in medical condition or state, etc.).

Information pertaining to timing of the activities/events can be employed to generate a longitudinal timeline establishing when respective activities occurred, the duration of the respective activities, and time between activities. For example, care path timing information can include information identifying when a patient was admitted to a hospital and total LOS, information identifying when a patient was moved to different parts of the hospital, and time of stay at the different parts of the hospital (e.g., in surgery, in the ICU, etc.). In another example, care path timing information can include information pertaining to an amount of time that was required to perform a specific procedure and timing of events between different aspects of a surgical routine.

Information pertaining to resources associated with the activities/events can include medical supplies and equipment employed in association with the activities, such as drugs administered, devices deployed (e.g., pacemakers, batteries, knee implants, etc.), supplies used (e.g., bandages, stitches, stents, braces, etc.), biological materials employed (e.g., blood usage, organ usage, etc.), radiology and other imaging machines employed, and usage of other medical equipment.

Information pertaining to caregiver personal associated with patient events/activities can include information identifying medical caregivers that performed respective actions associated with the activities (e.g., nurses, doctors, midwives, technicians, etc.) and the extent of their involvement (e.g., with respect to time and effort). This information can also identify who made certain decisions associated with performance of the respective action and activities (e.g., who decided to operate, who decided to administer a drug, who decided to move the patient, who is responsible for a diagnosis, etc.).

In addition, information related to a course patient care can include billing information associated with the various activities that occur throughout the course of care. For example, billing information can include in costs to the healthcare organization for provision of the care in total and with respect to each of the individual activities/aspects of the care (e.g., based on activities performed, timing of the activities, resources employed in association with the activities, personnel employed in association with the activities, etc.), costs to the patient and/or insurer in total and with respect to each of the individual activities/aspects of the care, and profits received in total and with respect to each of the individual activities. Other information pertaining to a course of patient care can pertain to a measure of quality of care, outcome associated with the care, patient satisfaction with the care and any other type of measurable metric that can provide insight regarding quality, performance, results and efficiency of a course of care patient care.

In one or more embodiments, care path evaluation component 1402 is configured to facilitate user visualization and comparison of different care paths via an interactive graphical user interface that includes visualizations depicting the different care paths. For example, care path evaluation component 1402 can receive user input identifying a group of patients based on a particular filtering criteria, such as a diagnosis, a procedure, a demographic, a time frame of admittance, a physician, etc. In another aspect, the group of patients can be automatically selected/identified by care path evaluation component 1402 based on association with a particular performance score (e.g., determined by scoring component 106), such as a performance score that is below or above a threshold performance score. For example, care path evaluation component 1402 can identify a group of patients associated with a performance score below a threshold score and direct interface component 112 to generate a care path flow diagram that depicts the various care paths followed for the respective patients in the group.

After a group of patients or patient encounter is selected, care path evaluation component 1402 is configured to determine (e.g., via information provided by the healthcare information sources 118) the respective care paths followed for each patient in the group. For example, care path evaluation component 1402 can determine the care path events/activities that were performed, the order of performance, and the timing of performance. Care path evaluation component 1402 can also determine, for each care path followed, information regarding the total number of cases (or patients) that followed the care path, costs associated with the care path (e.g., total costs, total profit, supply costs, reimbursement costs, etc.), LOS associated with the care path, readmission rate associated with the care path, and complication rate associated with the care path.

In various embodiments, interface component 112 is configured to generate an interactive visualization that depicts all of the different care paths followed for the selected group of patients/encounters. The visualization provides a comprehensive picture of the clinical variance in care delivery associated with patients having a common diagnosis, procedure, physician, (or other common filtering criteria). In addition the visualization provides a longitudinal picture of the sequence in which care was delivered for the different care paths. The interactive visualization further facilitates efficient selection and isolation of different care paths for further variance analysis by the user and/or by the care path evaluation component 1402.

In an aspect, the visualization includes a care path flow diagram that includes a plurality of icons respectively corresponding to care path events or activities that occurred over the courses of care for the respective patients in the group. For example, the icons can correspond to a procedure performed, a complication that occurred, a monitored patient state or status, a test performed, a drug administered, and/or a transfer to a different hospital sector or facility. In an aspect, the types of information represented by the icons included in a care path chart can be selected and/or filtered by a user. For example, the user can identify what types of care path events/activities to include and display in a care path flow diagram. A particular care path that was followed for one or more of the patients in the group is identified in the care path flow diagram via a connector line to respective icons corresponding to the respective care path events/activities that occurred during the care path. The connector line further connects the respective icons in the order in which the activities/events represented by the icons occurred during the care path. A plurality of different care paths can thus be represented in the same care path flow diagram visualization, wherein each different care path includes either a different subset of icons or a different sequence of connected icons.

In an aspect, the icons of the care path flow diagram are arranged into rows and columns. According to this aspect, respective care path event icons included in a particular care path are provided in separate columns (e.g., a single care path will not include two or more care path icons in a same column). Further, care path icons included in a particular care path flow from one column to another in a sequential horizontal manner (e.g., from left to right). In some aspects, a care path icon corresponding to a specific care path event or activity can be provided in two or more different columns (e.g., a plurality of instances of a care path icon corresponding to a specific event can occur in a single care path flow diagram).

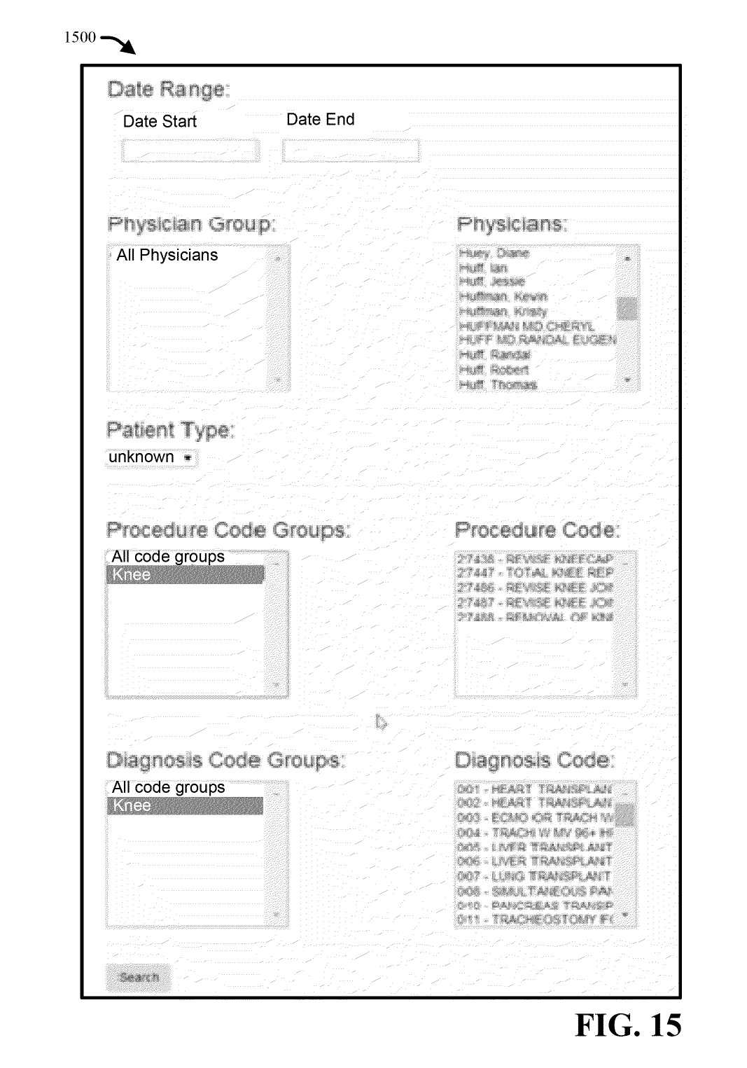

Care path evaluation component 1402 can also include information with the visualization that identifies and summarizes characteristics of the different care paths, such as information indicating whether the standard of care was met, number of cases/patients that followed the care path, average LOS associated with the care path, average supply cost, average hospital cost, etc. Using this visualization, the user can efficiently compare different care paths to uncover a degree/amount of variances associated with the different care paths and further explore these variances to determine whether they are clinically and/or financially justified. The various features and functionalities of an interactive care path graphical user interface are discussed in greater detail with respect to FIGS. 15-22.

For example, FIGS. 15-22 present a series of example graphical user interfaces 1500-2200 that facilitate generating and providing visualizations identifying financial and clinical variances associated with different care paths for similar patient groups in accordance with various aspects and embodiments described herein. In various embodiments, interfaces 1500-2200 are generated/configured by interface component 112 and rendered at a client device 120 via presentation component 122 in association with a care path analysis function/application provided by the healthcare management server 102 and driven by care path evaluation component 1402.

The care path analysis function/application is configured to allow users to visualize, for a group of procedures or for a group of diagnoses, the variance in care delivery or the way in which care was delivered longitudinally. This flexible application allows you to user to see the sequence in which care is delivered and allows users to uncover the degree/amount of variance associated with care delivery. Users can interact with the visualization and isolate the care paths of interest. When a care path is isolated, summary information for the care path is presented to the user, such as the number of cases that followed that care path, length of stay, the supply cost, hospital cost. A user can further select and save a particular care path to be a reference care path for further variance analysis (e.g., by the user and/or by care path evaluation component 1402). Care path analysis often a good way to begin the analysis of variance, whether it is a supply cost variance to be uncovered, a length of stay variance you to be uncovered, or an overall hospital cost variance to be uncovered.

The patient groups can be predetermined and/or selected by the user. For example, FIG. 15 presents an example graphical user interface 1500 that allows a user to provide various input criteria in association with selecting a group of patients/patient encounters to analyze. In particular, interface 1500 includes a date range field wherein a user can select a time period associated with a group of patients. Interface 1500 also includes a physician group category wherein a user can filter a group of patients by a specific physician or group of physicians. A patient type category provides for filtering by patient type (e.g., inpatient vs. outpatient). In another aspect, a user can filter a selected group of patients by procedure code and/or diagnosis code.

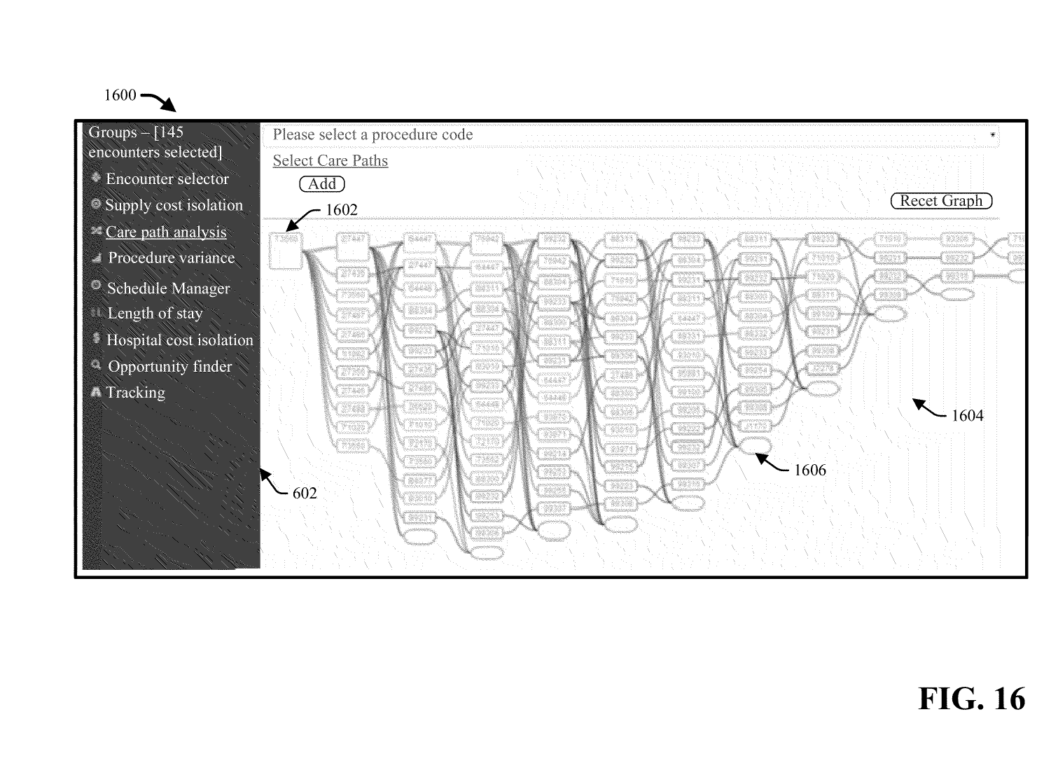

FIG. 16 presents an example graphical user interface 1600 including a care path flow diagram 1604. The care path flow diagram 1604 includes a plurality of icons, depicted as ovals or bubbles, wherein the respective icons correspond to a care path activity or event. The respective icons are arranged or organized into a plurality of rows and columns. It should be appreciated that the size, shape, appearance, and arrangement of the icons can vary.

In this example embodiment, each icon corresponds to a particular procedure (or procedure code). According to this example, the care path flow diagram 1604 depicts a plurality of different care paths followed for a group of patients that have received a particular procedure. For example, the specific procedure can be selected via interface 1500 (along with other filter criteria). A similar flow diagram can be generated based on another selected filtering criteria, such as a group of patients having a specific diagnosis code, or a group of patients having a particular medical complication. In an aspect, the common denominator grouping the patient encounters is provided as the first icon of the flow diagram. For example, the procedure code for which the flow diagram 1604 is based is provided in the first bubble 1602.

In an aspect, a user can provide input defining the types of care path events/activities to be represented by the respective icons of the care path flow diagram. For example, a user can provide input indicating that a care path flow diagram that depict only the different procedures performed for the different care paths, as is depicted in care path flow diagram 1604. It should be appreciated however, that a variety of different types of care path events/activities (e.g., procedure performed, drug administered, complication that occurred, transfer to different facility, test performed, etc.) can be included in a care path flow diagram. In an aspect, the different types of care path events/activities can be visually distinguished from one another (e.g., via a different color or different shape or icon). For example, icons corresponding to procedures can have an oval shape, icons corresponding to drugs administered can have a rectangular shape, icons corresponding to tests performed can have a triangle shape, etc.

With respect to care path flow diagram 1604, each icon or bubble corresponds to a particular procedure, indicated by the code provided therein. A particular care path is identified by a particular connector line that connects a subset of the different bubbles together in a sequence, beginning with the first procedure in the initial bubble 1602. In particular, care path flow diagram 1604 presents a plurality of different care paths, each beginning with the procedure corresponding to the first icon or bubble 1602 and ending at another icon or bubble included in the graph. Each of the care paths involve a different number and/or sequence of procedures. The empty bubbles (e.g., 1606 and the like) correspond to care path endpoints (e.g., the last procedure code bubble prior to the endpoint bubble was the last procedure in the care path).

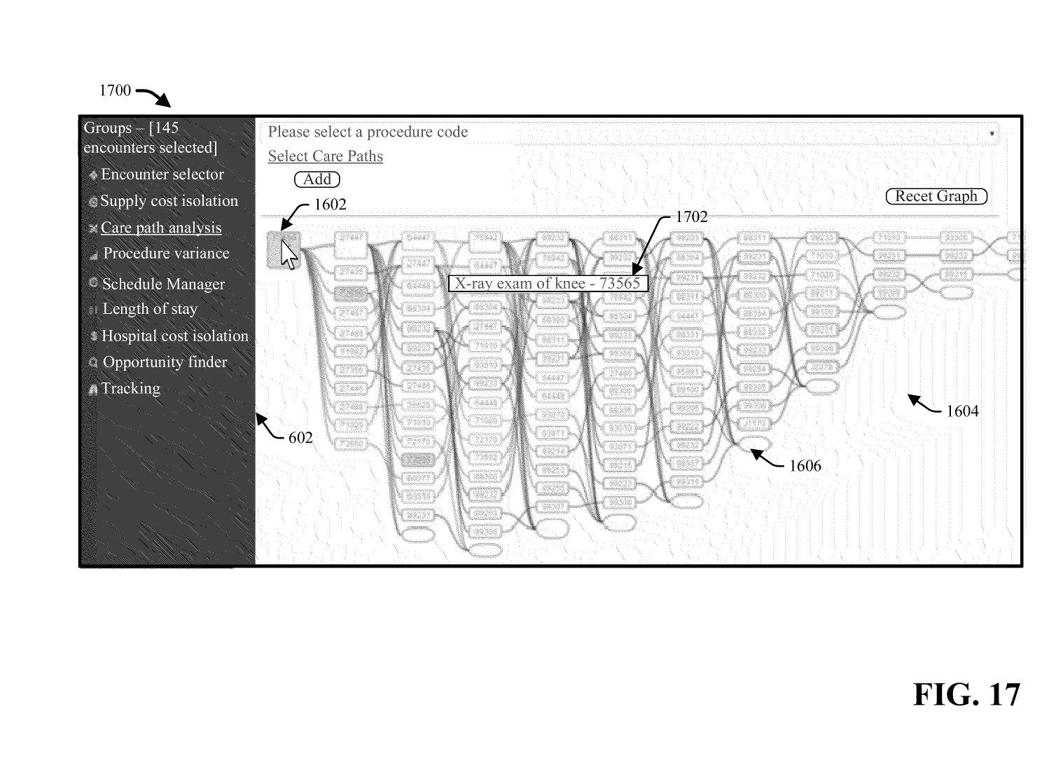

FIG. 17 presents another graphical user interface 1700 including care path flow diagram 1604. In interface 1700, a cursor is shown hovering over the initial icon bubble 1602. In various embodiments, in response to hovering over an icon or bubble in a care path flow diagram in any column or of the chart, all other instances of the care path event/activity represented by the icon or bubble are called out or highlighted. For example, as shown in interface 1700, there are three icons or bubbles corresponding to the procedure code represented by bubble 1602. In an aspect, information identifying the particular care path event/activity corresponding to a selected icon/bubble can also be presented to the user in the form of a pop up. For example, pop up 1702 includes text identifying the type of procedure corresponding to the selected bubble 1602, which is in this example, procedure 73565—X-ray exam of the knee.

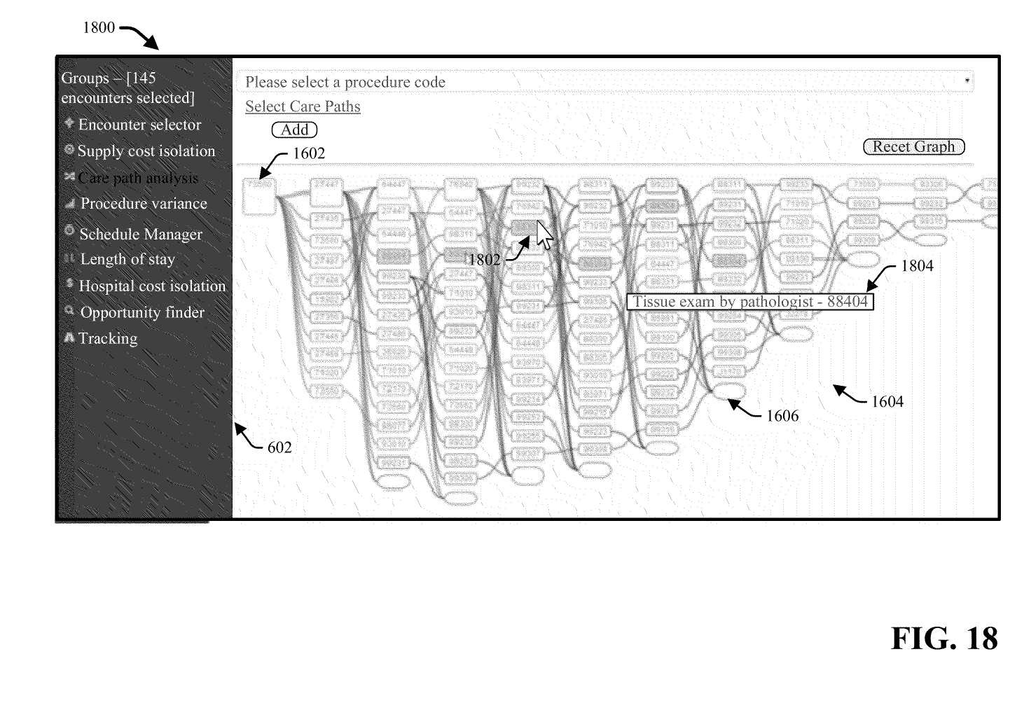

FIG. 18 presents another example, graphical user interface 1800 similar to interface 1700 yet with the cursor located over a different procedure bubble. In particular, the cursor has moved over to a new procedure bubble 1802. In response, the other instances of the procedure corresponding to the procedure in bubble 1802 are highlighted (e.g., 6 total in this case), and a pop up 1804 is presented that identifies the procedure (e.g., procedure 88404—tissue exam by pathologist) corresponding to the selected bubble.

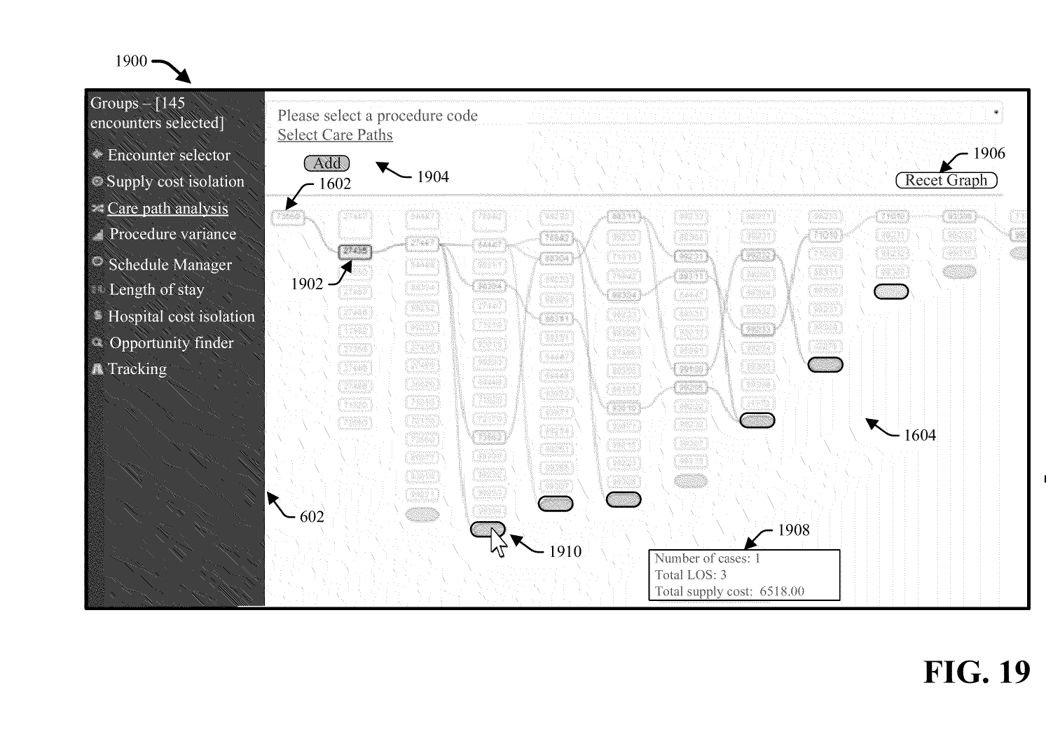

FIG. 19 presents another example, graphical user interface 1900 including care path flow diagram 1604 demonstrating a change to the appearance of the flow diagram 1604 in response to selection of a particular icon or bubble (as opposed to simply hovering over the icon). In interface 1900, the procedure bubble 1902 has been selected. In response to selection of a particular icon or bubble, all care paths that flow from the selected icon or bubble are identified or distinguished (e.g., highlighted or otherwise called out). The icons or bubbles and connector lines that are not involved in the identified care paths are lightened, ghosted, removed or otherwise made less prominent in the visualization. For example, as shown in interface 1902, a plurality of different care paths that include the procedure corresponding to procedure bubble 1902 are identified via darkening in color of the respective bubbles involved and darkening of the connector lines for the different care paths involved. These care paths each begin with the procedure corresponding to bubble 1602, followed by the procedure corresponding to bubble 1902. The end points of each of the different care paths that flow from the selected bubble 1902 are further highlighted (e.g., indicated by the darkened line around them) while the non-participating endpoints are lightened or ghosted.

From interface 1900, a user can further select a particular care path to call out and analyze by selecting the end point corresponding to that care path. For example, as shown in interface 1900, the cursor is hovering over end point icon/bubble 1910. In an aspect, in response to hovering over an end point bubble, information about that care path can be presented in the form of a pop up. For example, pop up 1908 includes information identifying the number of cases (or patients) that followed that care path, the total LOS and the total supply cost. The user can further select the endpoint bubble 1910 and select the add care path command icon 1904 at the top of the interface to save the selected care path for additional analysis. Interface 1900 also includes a reset button 1906. Selection of the reset button can clear the changes applied to chart 1604 and return the chart to its initial state as presented in interface 1600.

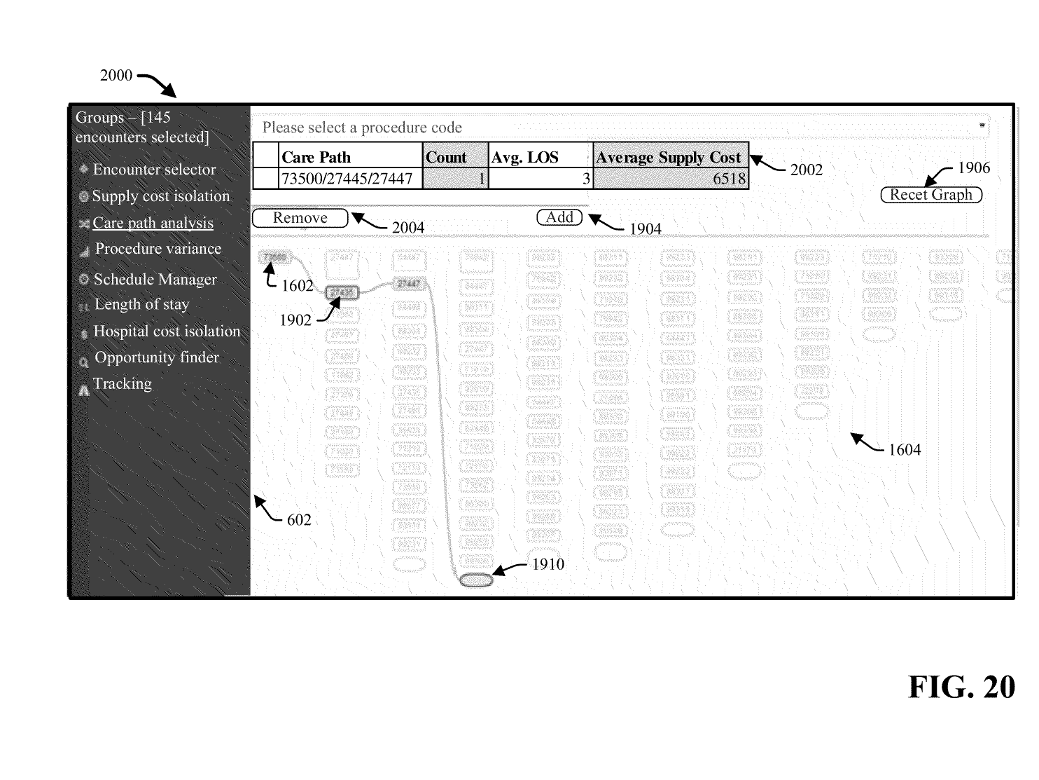

FIG. 20 presents an example graphical user interface 2000 generated in response to selection of the end point bubble 1910 and the add care path command icon 1904 from interface 1900. As shown in interface 2000, selection of a particular end point corresponds to selection of a particular care path. In an aspect, in response to selection of a care path end point, the care path icons/bubbles and connector lines involved in the care path associated with the end point are visually distinguished (e.g., via darkening, highlighting, etc.) from the non-selected elements of the care path flow diagram. In response to a request to add the selected care path to a saved form (e.g., via add care path command icon 1904), the care path is included and presented in a chart 2002 presented in the graphical user interface 2000. For example, chart 2002 includes information identifying the selected care path by the sequence of procedure codes involved. Additional information about the care path is also included in the char regarding the number of cases (e.g., count), the average LOS, and the average supply cost. Remove button 2004 allows the user to select a care path included in chart 2002.

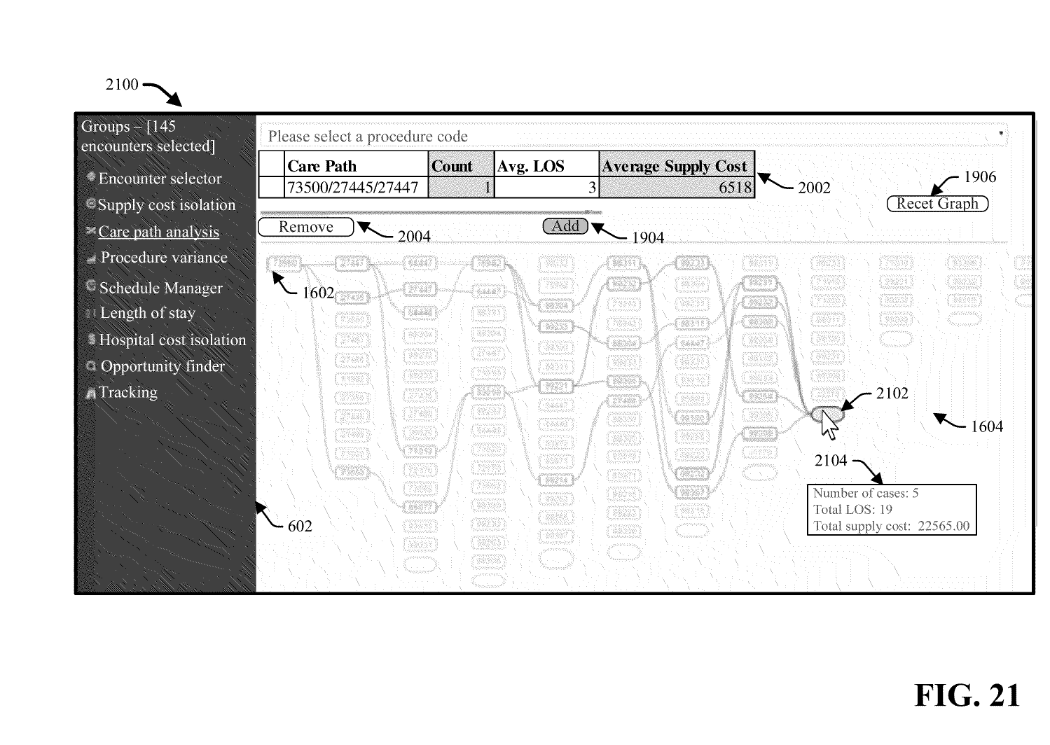

FIG. 21 presents another example graphical user interface 2100 generated following selection of the reset button 1906 from interface 2000 and selection of a new end point bubble 2102. As with interface 1900, selection of the end point bubble 2102 highlights the care paths ending with end point bubble 2102. In particular, five different care paths end with end point bubble 2102 (indicated by the five different lines connecting to end point bubble 2102). Information identifying the care paths associated with the end point bubble 2102 is also included in a pop up 2104.

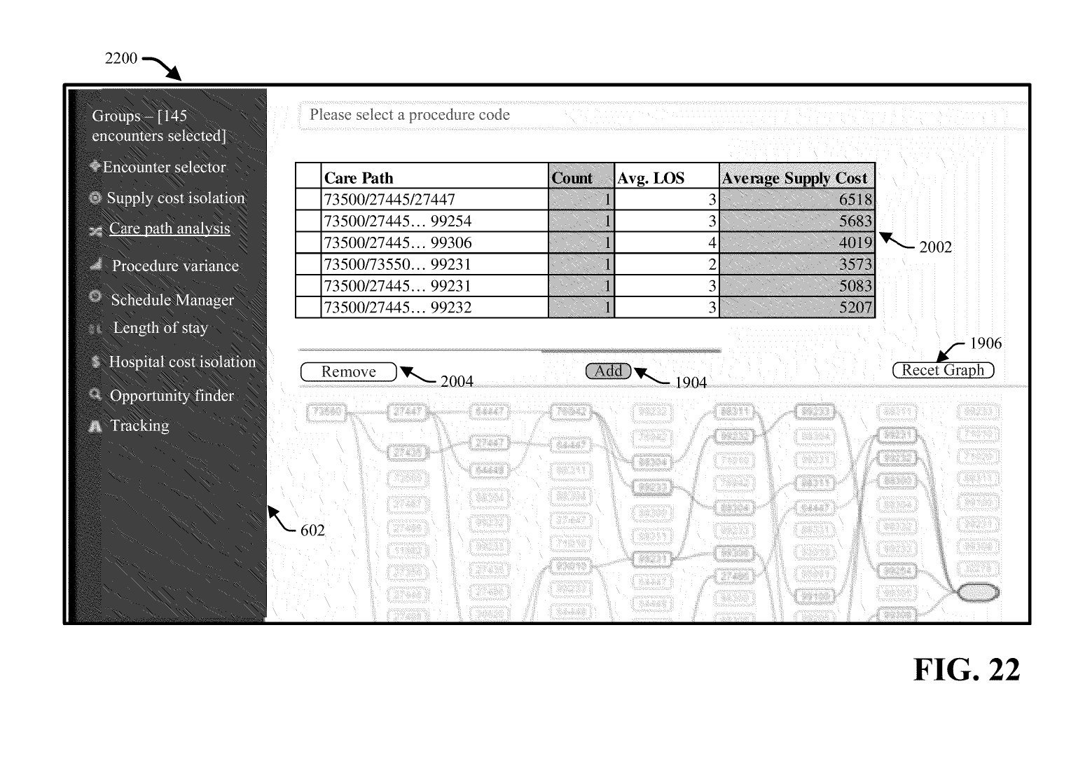

FIG. 22 presents an example graphical user interface 2200 generated in response to selection of the end point bubble 2102 and the add care path command icon 1904 from interface 2100. As shown in interface 2200, selection of end point bubble 2102 and the add care path command icon 1904 results in the addition of five new care paths to chart 2002. The care paths included in chart 2002 can further be compared with one another to identify clinical factors (e.g., healthcare service parameters) attributed to financial variances between the respective care paths as well as variances with respect to LOS, readmission rate, complication rate, and quality of care.

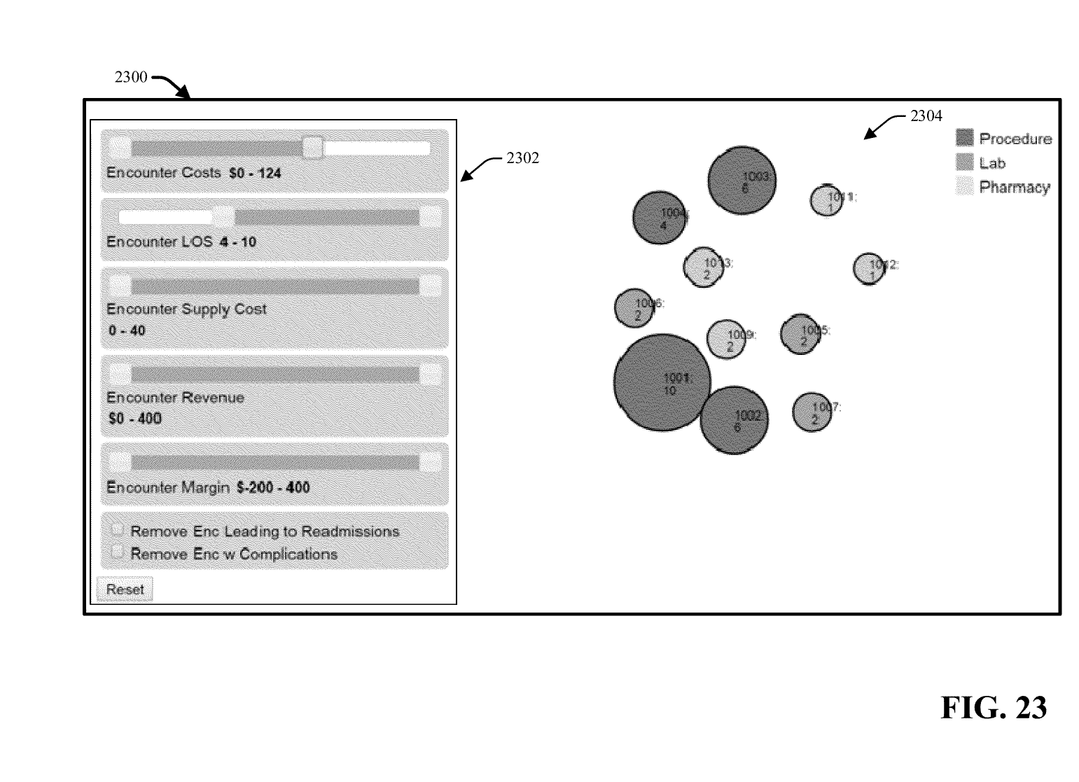

FIG. 23 presents another example graphical user interface 2300 that facilitates identifying financial and clinical variances associated with different care paths for similar patient groups in accordance with various aspects and embodiments described herein. Repetitive description of like elements employed in respective embodiments described herein is omitted for sake of brevity.

Interface 2300 provides a tool for visualizing the degree to which different patient care events/activities (e.g., procedures performed, drugs administered, laboratory tests performed, etc.) impact various metrics (e.g., cost, LOS, etc) associated with one or more patient encounters (e.g., courses of patient care). The visualization tool associated with interface 2300 can be employed to evaluate a single patient encounter with respect to costs, LOS, and other potential performance evaluation metrics as well as a particular group of patient encounters (e.g., grouped by diagnosis, primary procedure, facility, physician, etc.). Interface 2300 can also provide for filtering out patient encounters from a selected group that involved a readmission and/or a complication.

Interface 2300 includes a metrics filtering criteria menu 2300 that includes a plurality of different metric controls corresponding do different performance evaluation metrics. These performance evaluation metrics relate to the clinical and/or financial performance of the healthcare organization in association with provision of care for the respective patient encounters being evaluated. These metrics can include for example, total encounter costs, encounter LOS, encounter supply cost, encounter revenue, and encounter margin. It should be appreciated however that other types of performance metrics can be evaluated (e.g., margin, revenue, quality of care, or any number of financial or clinical outcomes/performance measures). Each of the different metric controls include an adjustable bar that can be adjusted to reflect a desired numerical range for the corresponding metric. For example, as shown in interface 2300, the encounter costs control is set to a range of $0-124, and the encounter LOS control is set 4-10 (days). The other controls are not adjusted and set to a default range (e.g., that is not restricted to a particular numerical range).

Interface component 112 is configured to generate a visualization to the right metrics filtering criteria menu 2302 based on the selected group of patient encounters being evaluated and the numerical ranges set for the performance metrics. The visualization provides clear pictorial representation of the degree different care path events/activities impact different performance metric criteria. Visualization 2304 is generated in response to setting of the performance metrics in the metrics filtering criteria menu 2302 for a selected group of patient encounters.

Visualization 2304 includes a plurality of different colored circles. The color of the respective circles indicates the type of patient care event or activity represented by the respective circles. For example, blue colored circles can correspond to procedures, red colored circles can correspond to laboratory tests, and yellow colored circles can correspond to an administered pharmaceutical. Each of the respective circles can also include text that identifies the specific procedure, laboratory test, and pharmaceutical, respectively, represented by the respective circles. For example, the numbers 1001, 1002, 1003, etc. associated with the different circles can respectively correspond to specific procedure code, laboratory test code, or pharmaceutical code. The sizes of the respective circles corresponds to the number of times the procedure, laboratory test, or pharmaceutical represented by the circle was performed for the group of patient encounters. In an aspect, text identifying the number of times the procedure, laboratory test, or pharmaceutical represented by the circle was performed for the group of patient encounters can also be included in the respective circles, as shown in interface 2300 via the number following the colon after the procedure, lab, or pharmacy code (e.g., 1001: 10, indicates 10 patients had procedure 1001).

In order to visualize the impact the different patient care events/activities have on the various performance metrics, a user can adjust the metric ranges via menu 2302. As the metric ranges are adjusted, the circles included in visualization 2304 to the right of the menu will dynamical change. For example, circles will be added or removed and/or existing circles will change in size. By way of example, in response to decreasing the encounter costs range, the LOS encounter range, and the encounter supply cost range, visualization 2304 may adapt to include only circle 1001: 2 (this means 2 encounters that had procedure 1001), yellow circle 1013:1, and red circle 1005:1. What this adapted visualization indicates is that at a certain cost, LOS and supply cost, the encounters that fit that criteria had procedure 1001, pharmaceutical 1013 and laboratory test 1005. The visualization tool demonstrated via interface 2300 provides an new and intuitive way to define and visualize what procedures and other cost drivers are most prevalent in high cost encounters or long encounters (in terms of LOS days).

Referring back to FIG. 14, in addition to facilitating user evaluation of different care paths via the interactive visualizations discussed above, in various embodiments, care path evaluation component 1402 can analyze different care paths for similar patient encounters to automatically identify variances in care delivery and further determine or infer the financial and/or clinical impacts of those variances. For example, care path evaluation component 1402 can be configured to automatically compare care paths selected for inclusion in chart 2002 with one another to identify various clinical and/or procedural differences between the respective care paths. For example, care path evaluation component 1402 can compare two or more different care paths performed for patients admitted with a same or similar diagnosis or for patients that received a same or similar primary operating procedure and identify differences with respect to care path events/activities performed for the respective patients, supply usage associated with the different events/activities, timing of the respective care path event/activities (e.g., duration of the respective events/activities and/or time between the events/activities), sequencing of the different care path events/activities, and/or medical personal involved (e.g., physicians, nurses, technicians, etc.).

Care path evaluation component 1402 can also identify financial variances between the respective care paths (e.g., with respect to total hospital cost, total hospital revenue, supply cost, staff cost, etc.), as well as variances with respect to LOS, readmission rate, complication rate, and quality of care. Care path evaluation component 1402 can further determine or infer the degree to which the identified clinical and/or procedural differences between the respective care paths contribute to the variances in cost, LOS, quality of care, readmission rate, and complication rate.

In various embodiments, all care paths evaluated by care path evaluation component 1402 can be previously determined to have met the standard of care. However in some implementations, in association with identifying clinical and/or procedural differences between different care paths, care path evaluation component 1402 can also determine whether the care respective paths adhered to the standard of care. For example, care path evaluation component 1402 can compare a particular care path for a patient encounter involving a patient with a particular diagnosis or condition, or a particular procedure, with information defining the minimum clinical requirements of care delivery involving the diagnosis/condition and procedure. For example, this information can include care path events/activities that need to be performed and/or conditions for performance of certain care path events/activities. Based on comparison to information regarding care path events/activities performed for the care path being evaluated with the standard of care requirements, care path evaluation component 1402 can determine whether the standard of care was met.

In an aspect, patient encounters involving care paths that did not meet the standard of care are flagged and eliminated from further consideration by care path evaluation component 1402. Care path evaluation component 1402 can further generate a notification reporting the patient encounters that did not meet the standard of care and provide the notification to the healthcare organization. The notification can include information identifying the medical facility/sector involved and the medical personnel involved in care delivery for the patient encounter.

In addition to examining whether certain clinical actions required for meeting the standard of care have occurred, care path evaluation component 1402 employs a unique approach to further identify additional care that was delivered above and beyond the standard of care. In some circumstances, this additional care is necessary and provides a substantial clinical benefit to the patient. However, if this additional care is not budgeted for and/or unnecessary, it leads to waste of resources, inefficiency and additional expense, increased LOS, occurrence of certain complications, and in some cases decreased patient satisfaction (e.g., unnecessary testing can lead to unnecessary patient anxiety). Some examples of unnecessary actions during a course of patient care could include blood utilization that could have been avoided, use of additional laboratory tests, radiology, unnecessary supply or pharmaceutical use, use of critical care resources (ICU) as part of a care protocol where it wasn't necessary, or inefficient use of the OR (time, staffing, supplies, etc.).

Care path evaluation component 1402 also evaluates places of service for different actions over the course of patient care, including movement of a patient from one facility to another. For example, care path evaluation component 1402 can identify inappropriate or unnecessary expense generated by discharge of a patient to a higher level of step-down care than necessary (e.g., sending to skilled nursing instead of home care). As long as the proper care is provided in the correct manner, the place of service does not affect whether the standard of care was met. Accordingly, care path evaluation component 1402 can determine whether different places of service over the course of patient care are causes for clinical and/or financial variance between similar patient groups. For example, when treating patients undergoing a particular surgical procedure, one facility may always moves a patient from the OR directly into the intensive care unit (ICU) while another doesn't while achieving similar outcomes. In another example, one team may always discharges a patient to a skilled nursing while another discharges directly to home while achieving similar outcomes. In both of these examples, the patient can be seen as having been treated according to the “standard of care.” Accordingly, care path evaluation component can determine that the later care paths in both of these examples indicate there is enormous room for reducing unnecessary care and financial waste.

Care path evaluation component 1402 can further determine an amount of expense associated with a particular care path that isn't contributing to better care and provide an immediate assessment of the activities for a group of patients that can be eliminated with no degradation in quality. For example, care path evaluation component 1402 can compare two or more care paths followed for similar patients involving a same or similar diagnosis/condition and determine whether an observed financial various between the respective care paths correlate to higher quality of care (e.g., with respect to the standard of care, a lower LOS, a lower readmission rate, a lower complication rate, or an increased degree of patient satisfaction. Accordingly, care path evaluation component 1402 can determine how two similar groups of patients can both be compliant with the standard of care but one group is substantially more expensive to care for than the other.

In one or more embodiments, For example, care path evaluation component 1402 is configured to compare different care paths for a group of patients having a same or similar condition, diagnosis, surgical procedure, etc., and determine variances to between the care paths with respect to one or more performance metrics (e.g., cost, LOS, readmission rate, etc.). Care path evaluation component 1402 can further determine causes of the variance (e.g., why some care paths had a greater cost of care, LOS readmission rate, etc.) by finding the differences in treatment between the different care paths. Such differences can include additional/unnecessary care actions, a sequence in which care actions/activities were delivered, durations of time for care actions and between care actions, physicians/staff involved, supplies involved, facilities utilized, places of care, etc. As a result, care path evaluation component 1402 can determine what clinical decisions made by physicians, care teams or instituted as standard of care by a health system introduce unnecessary expense.

In an exemplary embodiment, care path evaluation component 1402 is particularly suited for doing comparative effectiveness analysis when there are two or more distinct ways of caring for a patient having a particular condition/diagnosis, and/or requiring a particular procedure, that meet the standard of care. In particular, care path evaluation component 1402 can compare courses of care of patients associated with a same or similar condition or diagnosis to identify variances in the course of care (e.g., with respect to various measurable metrics) and determine or infer root causes of the variances. According to this embodiment, patient conditions/diagnosis can be classified/grouped as being the same or similar based on predefined parameters provided in memory 116. These parameters can define or group conditions as similar based on both metrics related to the condition (e.g., condition severity, factors associated with the condition) and the patient (e.g., patient age, gender, other conditions effecting the patient, etc.).

In an aspect, conditions can be classified/or grouped together based on a taxonomy that employs a hierarchical structure wherein a general condition is broken down into one or more sub-conditions based on level of relatedness of specific features of the sub-conditions. For example, patients suffering from general condition A can be subdivided into patients associated with condition A type I, A type II and A type III, etc. According to this example, based on pre-defined parameters (or a requested grouping for the analysis), care path evaluation component 1402 can treat all courses of care for patients suffering from condition A as being similar or separate the courses of care for the different types of condition A.

Care path evaluation component 1402 can compare various aspects of a courses of care of a plurality of patients associated with a same or similar condition or diagnosis to identify variances in the courses of care with respect to efficiency, cost (e.g., cost to healthcare organization, cost to patient, ROI in view of reimbursement, etc.) quality of care, outcome of course of care (e.g., did the patient have a successful outcome, did the patient require re-admittance, was the course of care performed according to standardized protocol, etc.), patient satisfaction with course of care, etc.

In an aspect, care path evaluation component 1402 is configured to examine three categories of variance when comparing course of patient care (e.g., either for a similar or dissimilar condition). These include time variance, procedural variance and cost variance verses outcome improvement. Time variance reflects amount to time to perform the procedure and time to utilize resources. Procedural variance reflects increase or decreases in supporting procedures or in drug utilization driven by a change in protocol. This generally has the greatest indirect cost influence. Cost variance verse outcome improvement measures variance in cost of performing different activities and procedures during the course of care as a function of outcome differences between the courses of care. For example, in a hospital setting, new procedures are often introduced with significant increase in cost but little or no improvement in outcomes (e.g., no improvement in patient comfort and no measurable quality change). Care path evaluation component 1402 serves as good tool to manage anecdotal information that encourages endless innovation without return. It should be appreciated that data for the respective courses of care can be compared in multiple views and from multiple dimensions to determine or infer root causes of cost variability and is not limited to variability by any specific metric.

For example, care path evaluation component 1402 can compare activities (e.g., procedures performed, imaging studies performed, laboratory studies performed, medications administered, movement to different areas of the hospital, discharge, etc.) respectively performed in association with the courses of care to identify variances in the activities. According to this example, care path evaluation component 1402 may identify an activity that was performed in 40% percent of the course of cares with no effect on the efficiency, quality, or outcome of the courses of care while costing a the healthcare organization an excessive margin of cost. In another example, care path evaluation component 1402 can compare timing of activities respectively performed in association with the courses of care to identify variances in the timing of the activities. For example, care path evaluation component 1402 can identify courses of care where certain procedures took longer to perform or were postponed for performance at a later time in the course of care. Care path evaluation component 1402 can further determine or infer an effect of these time variances with respect to efficiency, quality of care, cost, course of care outcome, etc.

In another example, care path evaluation component 1402 can compare resources associated with the activities of the courses of care to identify causes of variance in costs associated with performance of the courses of care. For instance, care path evaluation component 1402 can lean why some of the course of care cost the healthcare organization more to perform based and usage of certain supplies, devices, machines, etc. In yet another example, care path evaluation component 1402 can compare caregiver personal associated with the activities of with the subset of courses of care to identify causes of variance in efficiency, quality of care, cost, etc. For instance, based on comparison of caregiver personnel involved in the respective courses of care, care path evaluation component 1402 can learn that a certain nurse or technician's poor cost the healthcare organization money due to lack of efficiency associated with performing a particular activity. In another example, care path evaluation component 1402 can learn that some of the courses of care involved an excessive amount of medical staff or involved a high pay grade employee where such an employee's services were unnecessary.

Comparison of different care paths for different patient groups by care path evaluation component 1402 yields variance and variance indicates an opportunity for standardization of care, yielding reduction in cost and improvement in quality. Care path creation component 1404 is configured to empirically derive the best care path for a particular type of patient encounter, procedure, diagnosis, etc. by combining different combinations of care and care sequences and determining or inferring the clinical/financial outcomes that can be achieved while maintaining the standard of care. In particular, care path creation component 1404 can determine or infer ideal or optimal care paths to perform for specific types of patients, procedures, or diagnosis that adhere to the standard of care, reduce or minimize cost, increase profit, and improve efficiency of delivery based on the variances identified by care path evaluation component 1402.

In an exemplary embodiment, based on comparative analysis regarding aspects of a particular course of care performed by care path evaluation component 1402, care path creation component 1404 can determine or infer one or more changes to the course of care. For example, care path creation component 1404 can look at a course of care from various perspectives and aspects to determine what changes can be made to optimize or balance quality/standard of care, cost of care, efficiency, patient satisfaction, employee satisfaction, etc., while maintaining or improving course of care outcome. Care path creation component 1404 can analyze variances between aspects of the course of care and aspects of other courses of care based on comparison to courses of care for similar or dissimilar conditions and/performed via the healthcare organization or a peer organization. Care path creation component 1404 can further analyze causes of the variances (as determined or inferred by care path evaluation component 1402) to determine or infer changes to the course of care. In addition, care path creation component 1404 can determine or infer changes to aspects of the course of care based on comparison between the aspects and recognized healthcare standards or benchmarks employed/followed by other healthcare organizations.

In an aspect, care path creation component 1404 can determine one or more changes to implement in a future course of care for a patient associated with the same or similar medical condition that minimizes one or more of the variances. For example, care path creation component 1404 can analyze a plurality of courses of care for a same or similar condition and determine that procedure C is generally only performed when there is an extended delay time (e.g., greater than a threshold time) between performance of routine procedures A and B. In order to reduce performance of procedure C in the future, care path creation component 1404 can implement a maximum time delay requirement between performance of procedures A and B and/or provide more staff available to perform procedure B.

It should be appreciated that the above optimization example regarding optimization of a course of care is not intended to limit the scope of the subject disclosure. Care path creation component 1404 can implement a variety of changes to various aspects of a course of care to facilitate optimization thereof, including aspect related to activities associated with the course of care, timing of the activities, resources employed in association with the activities, and medical personnel associated with the activities.

In an aspect, care path creation component 1404 is configured to develop a standardized or model care plan for a course of care for a particular type of patient diagnosis or procedure based in part on determined or inferred changes to the course of care. In particular, care path creation component 1404 can define standardized parameters associated with the various aspects of a course of care for a particular condition based in part on comparative analysis performed by care path evaluation component 1402 regarding the course of care and optimization determinations and/or inferences regarding how to improve the course of care (e.g., with respect to balancing and/or enhancing at least one of: efficiency, cost, ROI, quality/standard of care, patient satisfaction, course of care outcome, personnel satisfaction, etc.). The parameters can relate to activities associated with the course of care (e.g., what activities to perform, how to perform them, etc.), timing of the activities (e.g., when to perform them, timing between activities, etc.), resources for the activities (e.g., what supplies, pharmaceuticals and machines to employ, amount of use of resources, etc.), and medical care personnel associated with the activities (e.g., type or specific identify of medical caregivers to perform respective activities, roles of the medical caregivers in association with the activities, number of caregivers associated with performance of a particular activity, etc.). The parameters can also define standards of care, quality of care and costs/expenses allowed in association with provision of the course of care and/or specific activities of the course of care.

In various embodiments, care path creation component 1404 can generate a flow diagram for a model course of care for the condition from start to finish (e.g., initial patient meeting and/or diagnosis with the condition to patient completion of care for the condition). The flow diagram can indicate what activities to perform and when to perform them throughout the course of care. The flow diagram can also include branches for different scenarios that may occur during the course of care (e.g., using decision trees). Information describing other parameters involved in the course of care (e.g., timing between activities, how to perform the activities, what resources to use, what caregiver personal should be involved and their respective roles, etc.) can further be tied to the appropriate blocks/branches of the flow diagram.

Care path creation component 1404 can also develop standards and regulations regarding various other aspects and operations of a healthcare organization based on various areas for improvement identified by care path evaluation component 1402 and various mechanisms determined to facilitate improvement. For example, care path creation component 1404 can determine or infer standards/regulations regarding how a particular medical service, procedure, caregiver, or sector of a hospital should operate in terms of efficiency, quality, outcome performance, resource consumption, and costs. In another example, standardization can determine optimal standards/regulations regarding efficiency of various hospital procedures and services, costs associated with those procedures and services, standards of care quality regarding those procedures and service, standards of patient satisfaction regarding those procedures and services, and standards of caregiver performance regarding those procedures and services.

In some embodiments, for each new patient admitted to the care of a health care organization, care path creation component can determine an optimal care path that achieves the standard of care, provides a profit, reduces patient cost and maximizes overall efficiency. According to these embodiments, care path creation component 1404 can first identify a model care path for a similar patient (e.g., having a similar diagnosis, requiring a similar procedure, etc.) that was considered clinically and financially efficient care path and/or that was empirically derived as a model care path for patients similar to the admitted patient. Care path creation component 1404 can further modify the selected model care path based on specific factors unique to the admitted patient (e.g., health history, incurrence carrier, age, gender, medical treatment preferences, etc.). Care path creation component 1404 can also tailor the model care path to optimize efficiency and cost based on current scheduling constraints (e.g., with respect to medical personal availability, facility availability, etc.) and supply availability.

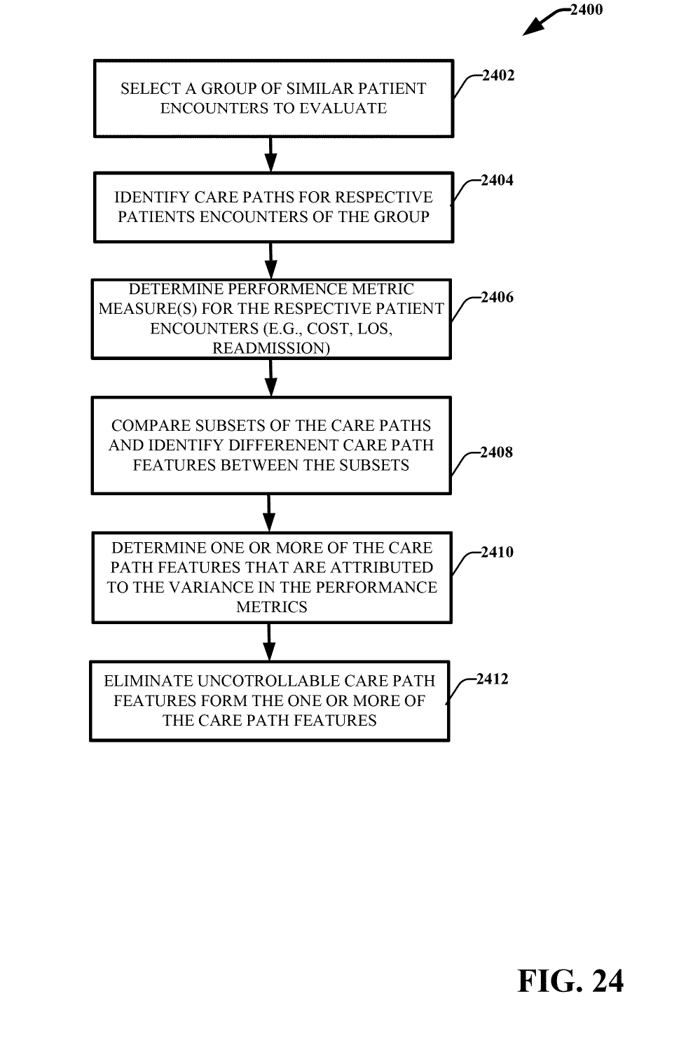

FIG. 24 presents a flow diagram of an example method 2400 for determining root causes of variance between care paths of similar patient encounters in accordance with various aspects and embodiments described herein. Repetitive description of like elements employed in respective embodiments described herein is omitted for sake of brevity.

At 2402, a group of similar patient encounters is selected for evaluation in association with automatically identifying variances between the respective patient encounters by care path evaluation component 1402. In an aspect, the particular group of patient encounters can be received by care path evaluation component 1402 in response to selection of the respective patient encounters by a user the graphical user interfaces described with reference to FIGS. 15-22. In another aspect, care path evaluation component 1402 can be configured to evaluate a particular group of patient encounters based on a high degree of variance (e.g., with respect to a threshold degree of variance) between their respective OP scores. In yet another aspect, care path evaluation component 1402 can be configured to evaluate a group of similar patient encounters based on a determination by opportunity assessment component 204 that a relatively high degree of improvement in cost or LOS (e.g., with respect to a threshold percentage or degree of improvement) is associated with the group of patient encounters. Still in yet another aspect, care path evaluation component 1402 can be configured to select a group of similar patient encounters to evaluate based on association with a ranking (e.g., determined by ranking component 108) above a threshold ranking (e.g., where the ranking reflect an amount of opportunity in cost or LOS associated with the group of patient encounters).

At 2404, care path evaluation component 1402 identifies the care paths for the respective patient encounters included in the group. For example, care path evaluation component 1402 can access aggregated and indexed information stored in memory 116, and/or information provided at one or more healthcare information sources 118, identifying patient care event/activities involved in each of the different care paths, timing and sequencing associated with the patient care events/activities, resource employed in association with the patient care events/activities, and medical personnel involved in the respective patient care events/activities. At 2406, care path evaluation component 1402 determines one or more performance metric measures for the respective patient encounters. For example, for each of the different patient encounters, care path evaluation component 1402 can determine a cost of the patient encounter (e.g., total hospital cost, revenue, supply cost, etc.), a LOS of the patient encounter, and/or a readmission rate of the patient encounter (e.g., using information stored in memory 116 and/or provided at one or more external healthcare information sources 118).

At 2408, care path evaluation component 1402 compares subsets of the care paths and identifies different care path features between the subsets, and at 2410, the care path evaluation component determines one or more of the different care path features that are attributed to the variance in the performance metrics.

For example, in one embodiment care path evaluation component 1402 can run through all possible combinations of pairs of patient encounters exhibiting a degree of variance in cost, LOS and/or readmission rate above a threshold degree of variance. For each pair, care path evaluation component 1402 can determine features regarding care path events/activities that differ between the two patient encounters, differences in timing and/or sequencing of the care path events/activities of the two care paths, differences in resources employed for the two patient encounters, and/or differences in medical caregiver personnel involved in the two patient encounters.

Care path evaluation component 1402 can also compare subsets of the care paths demonstrating a degree of variance below a threshold degree of variance in one or more of the performance metric measures and identifies different care path features between the subsets. For example, care path evaluation component 1402 can identify subsets of patient encounters with similar costs, LOS, and readmission rate to identifies similar care path features associated with the respective encounters. According to this example, care path evaluation component 1402 can identify care path features that are common to high costs, high LOS and high readmission rates as well as care path events that are common to low costs, low LOS and low readmission rates.

Care path evaluation component 1402 then analyzes the identified differential features between the subsets of care paths (and in some aspects the common features) and determines one or more of the different care path features that attributed to the variance in the performance metrics. For example, care path evaluation component 1402 can determine the frequency of identified differential care path features and further determine the different care path features that are frequently associated with patient encounters involving high costs, high LOS and high readmission rates and those which are frequently associated with patient encounters involving low costs, low LOS, and low readmission rates. Those features that occur most frequently (e.g., relative to the other features) can be attributed to the variance in the performance metrics.

In another embodiment, after care path evaluation component 1402 can identify a first subset of patient encounters in the group that are associated with a performance metric measure (e.g., costs, LOS, readmission rate, etc.) above a threshold degree. Care path evaluation component 1402 can further identify a second subset of patient encounters in the group that are associated the a performance metric below the threshold degree. For example, care path evaluation component 1402 can identify a first set of patient encounters associated with costs below a threshold cost (e.g., patient encounters that were low cost), and second set of patient encounters associated with costs above the threshold cost (e.g., patient encounters that were high cost).

Care path evaluation component 1402 can then compare each care path of the first group to each care path in the second group to identify different care path features between them. In particular, can path evaluation component 1402 can select a first care path in the first group and compare it to every care path in the second group to determine a first set of differential care path features. The frequency of occurrence of each differential feature is determined and noted. Care path evaluation component 1402 can then select a second care path included in the first group and compare it to every care path in the second group to determine a second set of differential care path features, again noting the frequency of reoccurring differential features. Care evaluation component 1402 can continue this process until each care path included in the first group has been exhausted. Each of the sets of differential care path features are then combined and the frequency of occurrence of the different care path features is determined.

Care path evaluation component 1402 then selects a subset of the different care path features based on the frequency in which they occur and attributes this subset of different care path features to the variance in the performance metric(s). For example, care path evaluation component 1402 can select those care path features that occur more than a threshold number of times or those care path features that occur greater than the median frequency distribution among the different features. At 2412, care path evaluation component 1402 eliminates the one or more of the care path features attributed to the variance in the performance metrics that are determined to be uncontrollable features (e.g., using predetermined information identifying controllable and uncontrollable care path features).

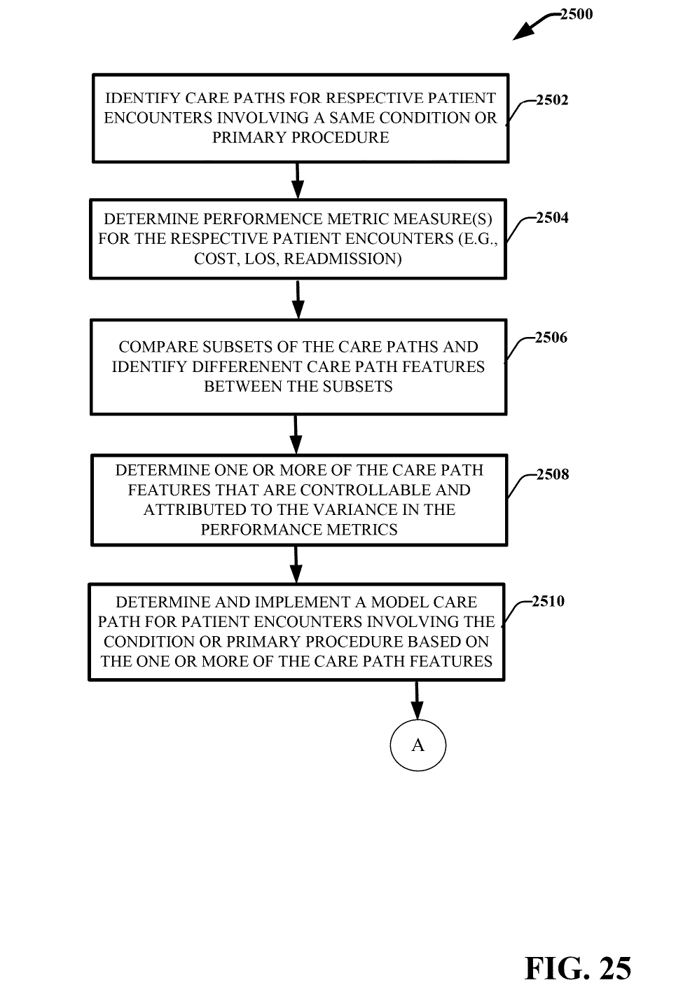

FIG. 25 presents a flow diagram of an example method 2500 for determining a model care path associated with treatment of a patient with a particular condition or prescribed a particular primary procedure in accordance with various aspects and embodiments described herein. Repetitive description of like elements employed in respective embodiments described herein is omitted for sake of brevity.

At 2502, care paths followed for respective patient encounters included in a group of patient encounters involving a same condition (diagnosis) or primary procedure are identified. For example, the group of patient encounters can include patients treated for a particular type of cancer, patients that received a particular type of spinal surgery, patients that underwent labor, etc. At 2504, care path evaluation component 1402 determines one or more performance metric measures for the respective patient encounters. For example, for each of the different patient encounters, care path evaluation component 1402 can determine a cost of the patient encounter (e.g., total hospital cost, revenue, supply cost, etc.), a LOS of the patient encounter, and/or a readmission rate of the patient encounter (e.g., using information stored in memory 116 and/or provided at one or more external healthcare information sources 118). Method 2500 can be employed to evaluate a single performance metric measure or several different performance metric measures simultaneously.

At 2506, care path evaluation component 1402 compares subsets of the care paths and identifies different care path features between the subsets (using the analytical techniques discussed with respect to method 2400), and at 2508, the care path evaluation component determines one or more of the different care path features that are controllable and attributed to the variance in the performance metrics (using the analytical techniques discussed with respect to method 2400). At 2510, care path creation component 1404 then determines and implements a model care path for patient encounters involving the condition or primary procedure based on the one or more different care path features. For example, care path creation component 1404 can develop a model care path that employs care path features that are attributed to low costs, low LOS, and low readmission rates (even if these features are not necessarily required to meet the standard of care) and eliminates or modifies those care path features that are not required to meet the standard of care yet contribute to high costs, high LOS and high readmission rates.

For instance, care path evaluation component 1402 can determine that a particular sequence and/or timing of care path events or activities leads to lower costs, lower LOS and/or lower readmission rates, and care path creation component 1404 can develop a model care plan that follows the particular sequence and/or timing. In another example, care path evaluation component 1402 can determine that administration of a particular pharmaceutical after a particular procedure, although not required to meet the standard of care, leads to lower total costs, LOS and or readmission rate. Accordingly care path creation component 1404 can include administration of the particular pharmaceutical after the particular procedure in the model care plan. In yet another example, care path evaluation component 1402 can determine that performance of a high cost imaging study (that is not required to meet the standard of care) following occurrence of a particular patient condition results in increased costs (relative to other similar patient encounters) without a clinical benefit (e.g., no decrease in LOS or readmission). Accordingly, care path evaluation creation component 1404 can implement a model care plan that involves a lower cost imaging study following the particular diagnosis or eliminates an imaging study following the particular diagnosis all together (depending on what is required to meet the standard of care).

With reference back to FIG. 14, optimization component 1406 is configured to monitor measures implemented by a healthcare organization based on recommendations and/or determinations provided by healthcare management server 102 to determine or infer whether those measure are resulting in a desired outcome. For example, after a healthcare organization implements a clinical or procedural measure based on a recommendation provided by recommendation component 208, optimization component 1406 can monitor new data received by the one or more healthcare information sources 118 based on new patient encounters to determine whether the clinical or procedural measure is resulting in the anticipated cost, LOS, or readmission rate improvement. If the optimization component 1406 determines that the anticipated improvement is not being achieved, optimization component 1406 can direct improvement evaluation component 202 to re-evaluate an opportunity assessment, a complications evaluation, and/or a care path evaluation to determine alternative measures to decrease costs, LOS, readmission rates, and complications, while calibrating the evaluation based on the lack of improvement determined for the previous clinical and/or procedural measure that was implemented. Optimization component 1406 can continually perform this procedure until it determines that an implemented clinical and/or procedural measure is resulting in the desired improvement.

In an exemplary embodiment, optimization component 1406 is configured to monitor new data received for patients encounters that follow a model care plan determined by care path creation component 1404 and determine whether the patient encounters exhibit a desired cost, LOS, and/or readmission rate. In response to a determination that new patient encounters which follow the model care plan either fail to exhibit the desired cost, LOS, and/or readmission rate or significantly vary with respect to meeting the desired cost, LOS and/or readmission rate (e.g., with respect to a variance threshold for a predetermined sample size), optimization component 1406 can direct care path evaluation component 1402 to evaluate the patient encounters to determine what features of the model care plan are attributed to the failure to meet the desired outcome and/or are attributed to the variance. Care path creation component 1404 can further modify or update the model care plan based on the new evaluation performed by care path creation component 1404.

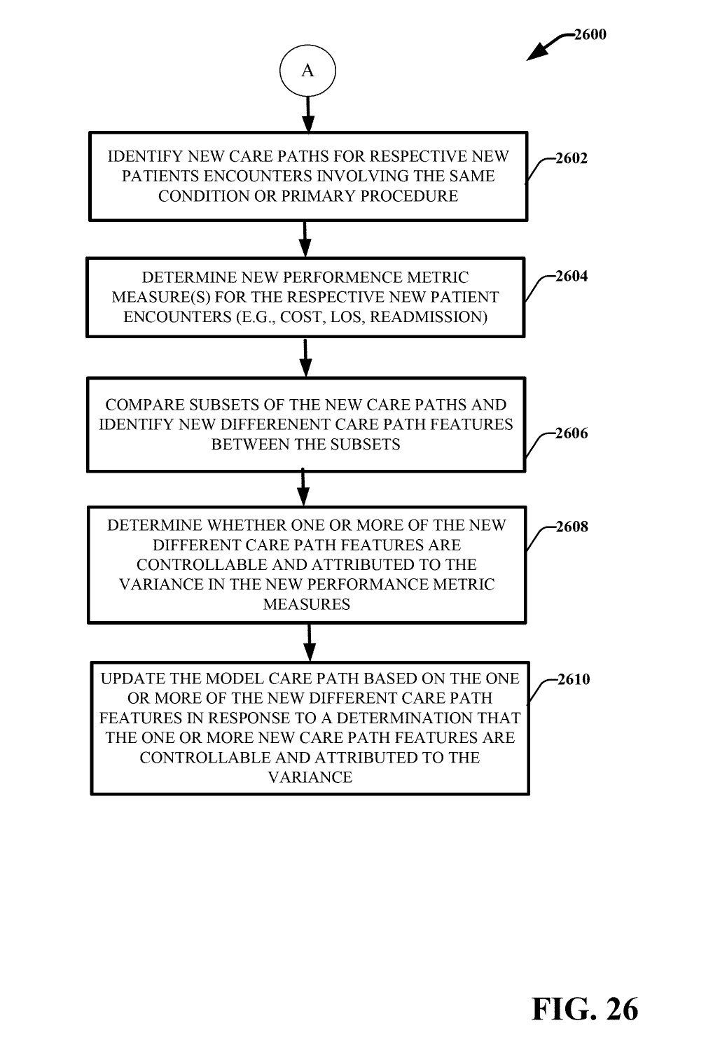

FIG. 26 presents a flow diagram of an example method 2600 for optimizing a model care path by optimization component 1406 using machine learning techniques, in accordance with various aspects and embodiments described herein. Method 2600 is a continuance of method 2500 from point A. Repetitive description of like elements employed in respective embodiments described herein is omitted for sake of brevity.

At 2602, optimization component 1406 directs care path evaluation component 1402 to identify new care paths followed for respective new patient encounters involving the same condition (diagnosis) or primary procedure. At 2604, care path evaluation component 1402 determines one or more new performance metric measures for the respective patient encounters. For example, for each of the different patient encounters, care path evaluation component 1402 can determine a cost of the patient encounter (e.g., total hospital cost, revenue, supply cost, etc.), a LOS of the patient encounter, and/or a readmission rate of the patient encounter (e.g., using information stored in memory 116 and/or provided at one or more external healthcare information sources 118). At 2606, care path evaluation component 1402 compares subsets of the new care paths and identifies new different care path features between the subsets (using the analytical techniques discussed with respect to method 2400), and at 2608, the care path evaluation component 1402 determines one or more of the new different care path features that are controllable and attributed to the variance in the performance metrics (using the analytical techniques discussed with respect to method 2400). At 2610, care path creation component 1404 then updates the model care path based on the one or more of the new different care path features in response to a determination the one or more of the new care path features are controllable and attributed to the variance.

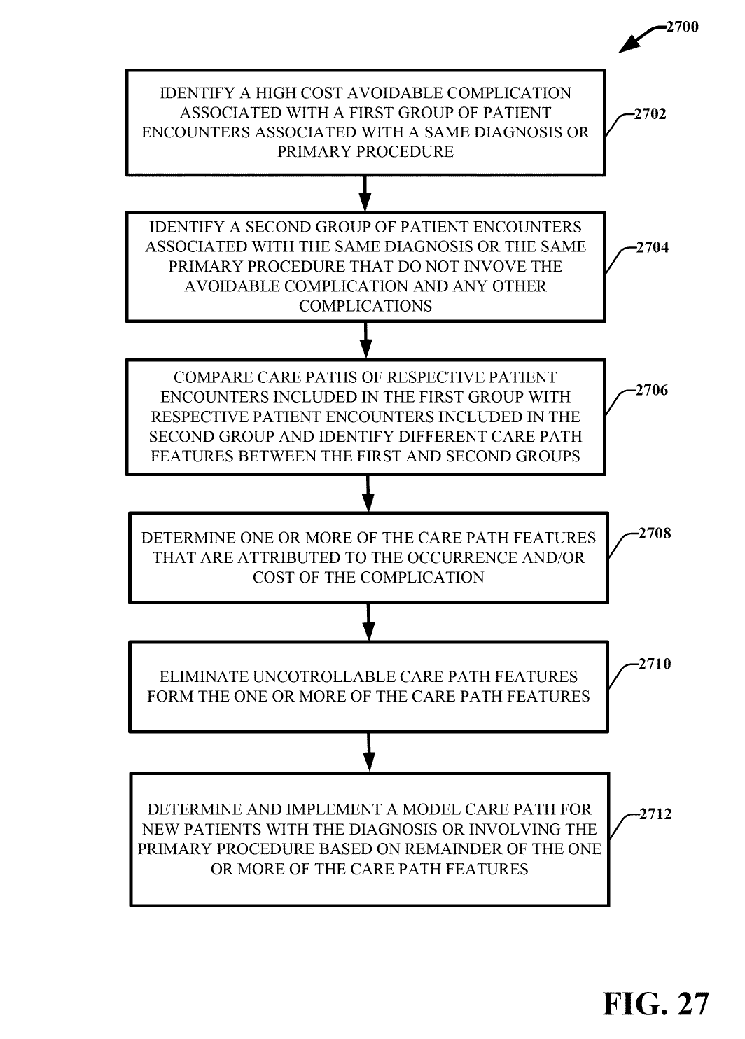

FIG. 27 presents a flow diagram of an example method 2700 for determining mechanisms to reduce the amount and cost associated avoidable complications that arise in patient encounters in accordance with various aspects and embodiments described herein. Repetitive description of like elements employed in respective embodiments described herein is omitted for sake of brevity.

With reference to FIGS. 14 and 27, as discussed supra, complications evaluations component 206 can identify avoidable complications that occur in for a particular group of patient encounter (e.g., aggregated based on diagnosis, primary procedure, physician, facility, and/or various other healthcare service parameters) that have a significant impact on cost, LOS, readmission rate, or other suitable performance evaluation metric. In various embodiments, complications evaluation component 206 can employ care path evaluation component 1402 to determine or infer one or more mechanisms to reduce the occurrence of the avoidable complications and mechanisms to reduce costs associated with the complications if and when they do occur in the future.

In particular, using similar analytical techniques discussed with respect to methods 2400-2700, complications evaluation component 206 can employ care path evaluation component 1402 to evaluate care paths follows for a group of similar patient encounters, wherein some of the patient encounters involve the particular avoidable complication while others do not. Based on the comparison between the patient encounters, complications evaluation component 206 can determine or infer clinical and/or procedural factors contributing to the occurrence and/or costs of the avoidable complication. In addition, based on the identified factors, complications evaluation component 206 can direct care path creation component 1404 to develop a model care path for the type of patient encounter being evaluated that is determined to minimize the occurrence and/or cost of the complications in similar future patient encounters. Further, similar to the machine learning techniques provided by optimization component 1406 as described with reference method 2600, optimization component care path creation component 1404 can also employ optimization component 1406 to optimize a model care path that is directed to reduce the cost and/or occurrence of an avoidable complication. In particular, optimization component 1406 can employ machine learning to determine an update to the model care path based on evaluation of information regarding occurrence of the avoidable complication with respect to a set of new patient encounters that followed the model care path.

With reference to FIG. 27 and method 2700, at 2702, complications evaluation component 206 identifies a high cost avoidable complication associated with a first group of patient encounters associated with a same diagnosis or primary procedure (e.g., using the techniques discussed supra with reference to FIG. 2). In an exemplary embodiment, the first group of patient encounters does not involve any other complications aside from the avoidable high cost complication. At 2704, the complications evaluation component 206 identifies a second group of patient encounters associated with the same diagnosis or the same primary procedure that do not involve the avoidable complication and any other complications.

At 2706, the complications evaluation component 206 can employ care path evaluation component 1402 to determine the care paths followed for respective patient encounters included in the first group and the second group and to compare the care paths for the patient encounters included in the first group and the second group to identify different care path features between the first group and the second group. At 2708, the care path evaluation component 1402 then determines one or more of the causal care path features that are attributed to the occurrence and/or cost of the complication.

For example, care path evaluation component 1402 can identify care path features that are frequently present in the first group of encounters and not present in the second group of encounters, and vice versa, using the similar techniques to those described with reference to method 2300. Those care path features that are included in the first group of patient encounters and excluded from the second group of patient encounters are considered to have a causal relationship with the occurrence and/or cost of the avoidable complication. Likewise, those care path features that are included in the second group of patient encounters and excluded from the first group of patient encounters are considered to have a preventative relationship with the occurrence of the avoidable complication (e.g., considered to prevent or deter the occurrence of the avoidable complications).

For instance, care path evaluation component 206 can compare each patient encounter in the first group with each patient encounter in the second group and identify different care path features. Those care path features that are attributed to the first group of patient encounters that occur frequently (e.g., more than N number of times or more than a median frequency relative to other features attributed to the first group) are then attributed to the occurrence of the complication and/or the cost of the complication. In an aspect, those features that are attributed to the second group of patient encounters that occur frequently are considered to prevent the likelihood of the occurrence of the complication.

At 2710, the care path evaluation component then eliminates the uncontrollable features (e.g., based on predefined information identifying controllable and uncontrollable features. In some embodiments, care path evaluation component 1402 can also remove features that are known to have no causal relationship with a particular complication. Care path evaluation component 1402 can also remove features that have a low likelihood or confidence level of having a causal relationship with the particular complication based on the timing of the complication and the feature (e.g., a feature occurring after the complication that is not an effect of the complication or affected by the complication), the facility where the complication occurred and the facility where the feature occurred (e.g., the complication and the feature occurred at different facilities), the nature of the avoidable complication, and other possible factors.

At 2712, the care path creation component 1404 then determines and implements a model care path for new patients with the diagnosis or involving the primary procedure based on the remainder of the one or more of the care path features. For example, care path creation component 1402 can develop a model care path that eliminates or modifies the features determined to lead to the occurrence of the complication and that includes those feature determined to deter occurrence of the complication. Complications evaluation component 206 can further employ optimization component 1406 to monitor the effectiveness of the model care plan with respect to reducing the occurrence of the avoidable complication and/or the cost of the avoidable complication. In particular, optimization component can continually perform method 2700 with respect to new data regarding new patient encounters that followed the model care plan and determine whether the frequency and/or cost associated with the avoidable complication has decreased. Optimization component 206 can further determine or infer that certain care path features previously determined to have a causal relationship or a preventative relationship with the avoidable complication for which the model care path was based were correctly identified. Optimization component 206 can then adapt or update the model care plan accordingly (e.g., rule out previously identified features as having or not having a causal or preventative relationship with the avoidable complication and/or identify or place more emphasis on new features determined to have a causal or preventative relationship with the avoidable complication).

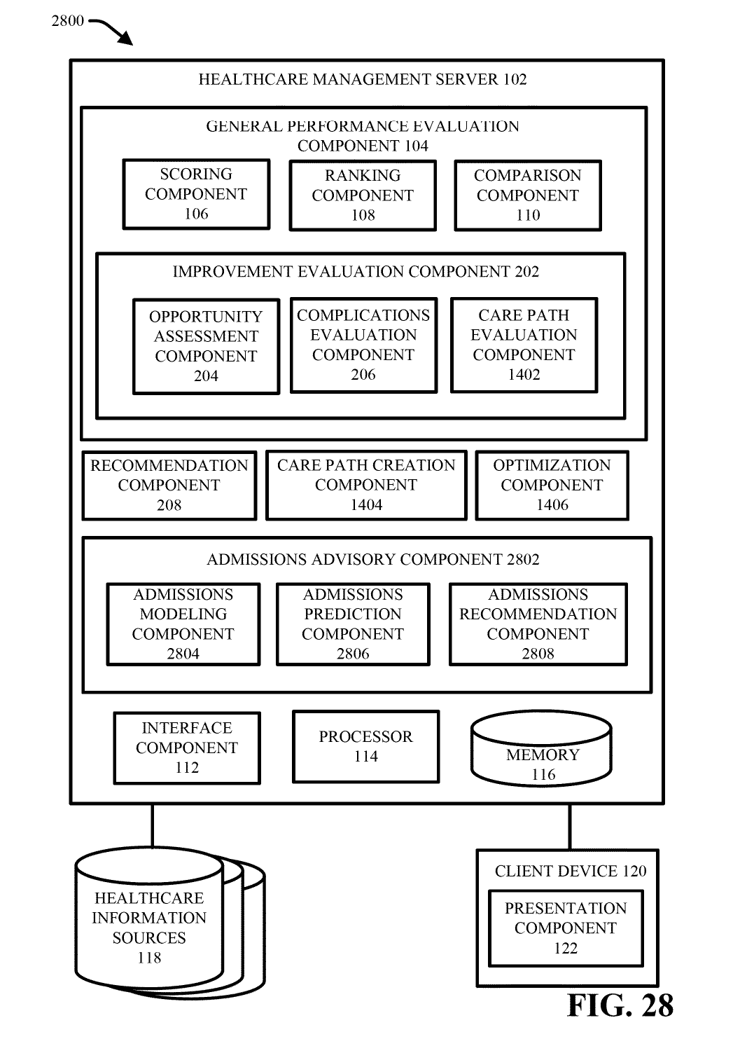

FIG. 28 illustrates another example system 2800 that facilitates providing clinically informed financial decisions that improve healthcare performance in accordance with various aspects and embodiments described herein. System 2800 includes same or similar aspects as system 1400 with the addition of admissions advisory component 2802. Repetitive description of like elements employed in respective embodiments of systems described herein is omitted for sake of brevity.

Admissions advisory component 2802 is configured to facilitate assessing potential patients and determining or inferring the likely LOS, likely costs, and likely readmission rate for the potential patients. As a result, the healthcare organization can notify the patient prior to admission regarding likely LOS, cost and readmission rate. In addition, the healthcare organization can financially budget for the patient and smoothly integrate the patient into the existing healthcare environment based on the existing healthcare environment's patient population, schedule, financial constraints and care constraints (e.g., scheduling constraints, personnel availability constraints, facility constraints, supply constraints, etc.). In addition, based on these determinations regarding likely LOS, cost and readmission rate, the admissions advisory component 2802 can provide recommendations regarding whether to admit a new patient or refer the patient, how to charge the patient, how to monitory the patient (e.g., level of monitoring and what clinical signals to monitor), and how to modify a care path for the patient and/or other patients to accommodate the patient and to decrease the likely LOS, total cost and readmission rate.

In an exemplary embodiment, admissions advisory component 2802 is particularly tailored to provided admissions evaluations and recommendations for a skilled nursing facility (SNF). A SNF provides skilled nursing care and/or rehabilitation services to help injured, sick, or disabled individuals to get back on their feet. In terms of rehabilitation in skilled nursing facilities, hospitals make the arrangements for follow-up patient care after an acute hospital stay, such as after a surgery. When released from the hospital, a patient transfers to the SNF to receive hands-on care from nurses. If a patient needs rehabilitation like physical therapy or speech therapy, a patient receives the services until they're able to go home. For example, SNFs can provide short-term and long term care for patients recovering from a stroke, patients with Parkinson's disease, patients needing general wound care, patients with acute medical conditions, patients with terminal illnesses, or patients needing general rehabilitation care.

Admissions advisory component 2802 includes admissions modeling component 2804, admissions prediction component 2806 and admissions recommendation component 2808. Admissions modeling component 2804 is configured to generate and regularly or continuously update a plurality of admissions models that are respectively designed to generate different admissions outputs including predicted LOS, predicted discharge to the community, and predicted cost and/or revenue for a particular healthcare facility. The admissions outputs are based on the internal clinical/procedural operations of the healthcare facility as well as the billing/charging and reimbursement system employed by the healthcare facility.

In particular, admissions modeling component 2804 can receive or extract internal information for the healthcare facility such as an SNF (e.g., from one or more healthcare information sources 118 associated with a healthcare facility) for patients that were cared for by the healthcare facility. The internal information can include patient information regarding a patients' demographics (e.g., age, gender, etc.), the patient's medical condition/diagnosis and/or reason for admission, medical history (including pre-existing conditions), course of care received at the healthcare facility, particular medications taken, referring provider, and any other relevant information that can be retrieved about the patient. For example, the above noted patient information is often included and/or provided on a patient referral form that is accessible to admissions modeling component 2804. The admissions modeling component 2804 can further extract/receive (or determine) information regarding LOS of the patient, costs associated with care of the patient (e.g., total cost, total revenue, supply costs, etc.), when/whether the patient was discharged to the community, and whether/when the patient was readmitted to a hospital.

In an aspect, when applied to a SNF, admissions modeling component 2804 receives internal patient data from the following data sources to facilitate admissions modeling: the skilled nursing electronic medical record or billing system (SNEMR or SNEBS), the general ledger, the pharmacy invoice, and the therapy invoices. The SNEMR or SNEBS provides information regarding revenue, clinical activity, and costs per patient day. The general ledger provides information identifying clinical activity based costs. The pharmacy invoice provides specific data on pharmacy costs, utilization, and high cost drugs, and the therapy invoices provide information regarding a specific amount and type of therapy delivered to patients.

In one or more embodiments, the admissions modeling component 2802 employs a plurality of different models that respectively relate a defined set of patient parameters with outputs for LOS, costs, and readmission rate. These models are respectively referred to as the LOS model, the cost model and the readmission rate model. The defined set of patient parameters include but are not limited to: age, gender, number of prescription drugs, cost of drugs, referral reason or diagnosis (including highly specific diagnoses), clinical status or history (e.g., other existing conditions, comorbidities, acuities, etc.), referring provider, insurance provider, the specific facility to which the patient will be admitted, and any necessary seasonal factors for the patient profile.

In various embodiments, each of the admissions models (e.g., LOS admissions model, cost admissions model, and readmission rate mode) employ Equation 2 below to determine the above noted outputs (e.g., LOS, cost and readmission rate), wherein C is a mathematical constant for the linear equation or baseline value for the null set where all of the input variables are zero, A₁₋ₙ are the respective coefficients and X₁₋ₙ are the respective patient factors/variables for the particular patient being evaluated.

Output=C+A₁X₁+A₂X₂+A₃X₃+A₄X₄+A₅X₅+ . . . +AₙXₙ Equation 2

In an aspect, admissions modeling component 2804 uses multivariate linear regression based on the internal data for past patients of the healthcare facility to determine the coefficients for the defined set of patient parameters that reflect the impact the respective patient parameters have on the specific metric in question (e.g., LOS, readmission rate, total cost, etc.). The coefficients for the respective patient factors can vary depending on the metric being evaluated.

For example, with respect to LOS, admissions modeling component 2804 can examine a plurality of different past patient encounters to determine a value that represents the impact of age on LOS, regardless of other patient parameters involved (e.g., gender, diagnosis, pre-existing conditions, etc.). In other aspects, admissions modeling component 2804 can determine specific coefficients that reflect the impact specific patient parameter values have on the metric in question. For example, admissions modeling component 2804 can employ multivariate linear regression against data for past patient encounters at the healthcare facility to determine respective coefficients for different age value inputs, different diagnosis value inputs, different pre-existing condition value inputs, etc.

In some embodiments, in addition to internal patient data of the healthcare facility, admissions modeling component 2804 can employ existing external insurance agency associated with an external patient population serviced by the insurance agency to facilitate determining the coefficients for the different patient parameters and/or patient parameter values (e.g., data employed or determined by outside insurance companies to facilitate determining insurance premiums). For example, admissions modeling component 2802 can extract or receive (e.g., from the one or more healthcare information sources 118) insurance program data (e.g., Medicare™ or Medicaid™ data) that associates patient parameters (e.g., age, gender diagnosis, etc.) for different types of clinical patient scenarios (e.g., those observed for all patients and potential patients covered by the insurance program) to LOS, readmission rate, and cost, to create a baseline market model. The admissions modeling component 2802 then calibrates the baseline model based on the internal data for patients treated by the healthcare facility and the clinical, procedural, and financial operations of the healthcare facility.

Because the LOS, cost, and readmission rate models can be built using existing insurance company data, and data generated by the healthcare facility relating patient factors (age, gender diagnosis, etc.) to LOS, readmission rate, and cost, when a new patient presents a clinical situation that has not previous been encountered by the healthcare facility, the admissions modeling component 2802 can still accurately predict likely LOS, readmission rate, discharge, and cost, for the patient. For example, if a new potential patient needs a specific prescription drug for treatment, the admissions modeling component can still predict likely LOS, readmission, discharge, and cost, even though a patient needing the specific prescription drug for may not have seen before by that facility. As new types of patients are admitted and treated and discharged, the admission model is updated to reflect the actual impact of the new patient parameters or parameter values on likely LOS, readmission, discharge and cost. Hence, the specific costs and operational nuances of the facility are captured.

Admissions prediction component 2806 is configured to receive input identifying a set of values for the patient parameters for a potential patient of the healthcare facility and employ the respective cost, LOS, and/or readmission rate models to respectively determine likely LOS (e.g., how long the patient will require treatment), likely cost (e.g., what the expected cost of care will be for that patient and amount of reimbursement available), and likely readmission (e.g., the likelihood that the patient will return to a hospital within 30 days of discharge). In some aspects, admissions prediction component 2806 can also determine likely discharge to community (e.g., the likelihood that the patient will return to the community alive (private home, assisted living, group home) within 100 days and stay out of a skilled nursing facility (SNF) care for at least 30 days. For example, admissions prediction component 2806 can receive input identifying a patients age, gender, diagnosis, medications, referring provider, etc. Based on the values of the patient parameters and the established coefficients for the respective patient parameters, for each respective model, the admissions predication component 2806 can determine the respective outputs.

In some embodiments, for each patient evaluated, the admissions prediction component 2806 can further determine a subset of the patient parameters that have the greatest impact on the specific metric in question the predicted length of stay for the potential patient, and the admissions recommendation component can identify the subset of the patient parameters in the recommendation. For example, admissions prediction component 2806 can identify the top N parameter values for a particular patient that most heavily impact a determined LOS, cost or readmission rate for the patient.

The admissions recommendation component 2808 is configured to generate and provide a recommendation regarding whether to admit a potential patient based on the one or more of the outputs determined by admissions prediction component 2806. For example, admissions recommendation component 2808 can determine whether to admit or deny a potential patient based on the patients respective predicted LOS, cost, and/or readmission rate being above or below a threshold value. In another example, admissions recommendation component 2810 can determine whether to admit or deny a potential patient based on a combination of the patient's predicted LOS, cost and/or readmission rate. According to this example, admissions recommendation component 2808 can determine an admittance score for a patient that reflects the cumulative output values of LOS, cost and readmission rate. Admissions recommendation component 2808 can then generate a recommendation regarding whether to admit or deny the patient based on the patient's admissions score being above or below a threshold score.

In association with providing a recommendation to admit or deny a patient, admissions recommendation component 2808 can include information in the recommendation regarding what patient factors most heavily influenced the decision. For example, admissions recommendation component 2808 can identify the patient parameters or patient parameter values for the particular patient that most heavily influence the patient's predicted cost, LOS, and/or readmission rate as well as which of the three outputs most heavily influenced the patient's admissions score.

In various implementations, in addition to providing a recommendation regarding whether to admit or deny a potential patient, admissions recommendation component 2808 can also provide recommendations regarding whether to admit a patient a patient with caution, admit a patient into a particular highly monitored program employed by the facility, or request further review of the patient prior to making an admittance decision. For example, the type or recommendations provided by the recommendation component 2808 (e.g., admit with caution, admit to highly monitored program, examine for additional review, etc.), can be based on an individual output score/value for a particular evaluation metric, (LOS, cost, readmission rate), an admissions score based on the collective metrics, or one or more particular patient parameters that have been determined to have the greatest impact on a specific evaluation metric. For instance, admissions recommendation component 2808 can be configured to generate an admit with caution recommendation in response to a patient's LOS output, cost output, readmission rate output, or admissions score output, being within a caution range. In another example, admissions recommendation component 2808 can be configured to generate “admit to highly monitored program” recommendation in response to a patient's predicted cost being heavily attributed to a number of high cost pharmaceuticals. Admissions recommendation component 2808 can also alert the healthcare facility to pay closer attention to a patient after admission based on the various outputs of the admission models and/or the patient's admissions score.

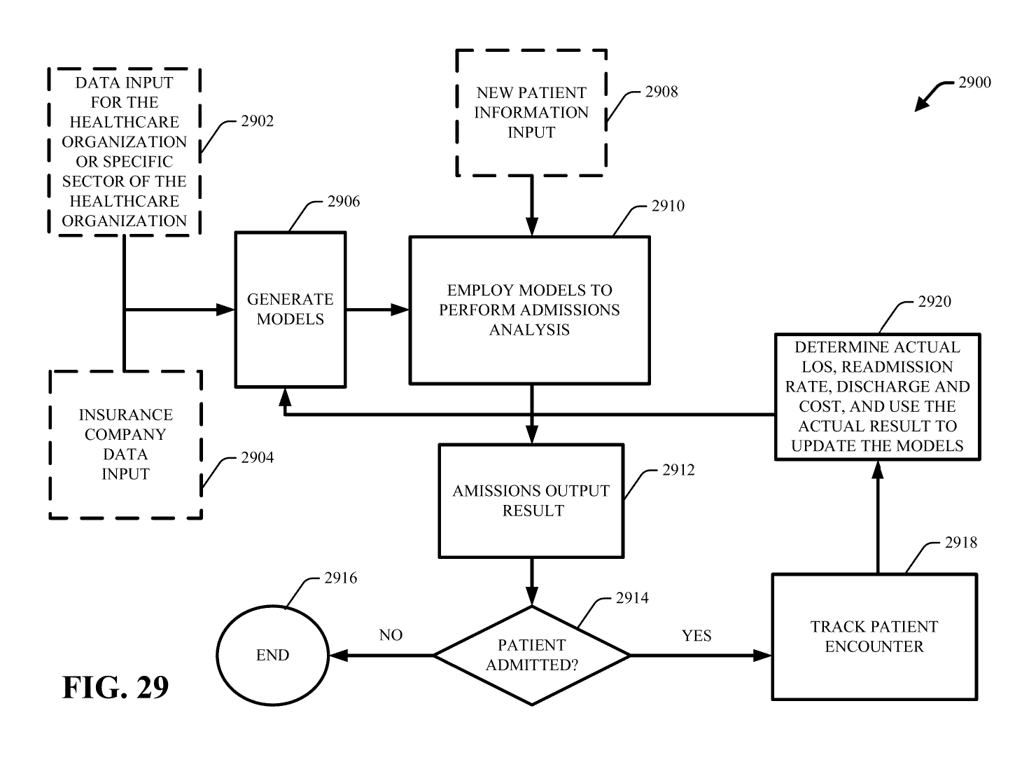

FIG. 29 provides a flow diagram of an example method 2900 for predicting expected clinical and financial outcomes associated with a patient prior to admittance in accordance with various aspects and embodiments described herein. Admissions advisory component 2802 is configured to implement the various processes of method 2900. At 2906, LOS, cost, and readmission rate admissions models are generated based on data input received from various sources. These sources can include data 2902 provided by a particular healthcare facility (e.g., a SNF) and/or a specific sector of a healthcare organization. For example, data 2902 can include information regarding past patient encounters of the healthcare facility, including information about the respective patients (e.g., patient age, gender, number of prescription drugs, cost of drugs, referral reason or diagnosis, clinical status or history, referring provider, referring provider, insurance provider, the specific facility to which the patient will be admitted, and any necessary seasonal factors for the patient profile), and determined actual LOS of the respective patients, readmission rates, discharge to the community and cost of the encounters. Data 2902 can also include information received, an electronic billing system employed by the healthcare organization (e.g., SNEMR or SNEBS), the general ledger, pharmacy invoices, and therapy invoices.

These sources can also include data 2904 provided by one or more insurance companies (e.g., Medicare™ data) that relates various patient parameters to LOS, readmission rate, discharge to community and cost. In addition, data input that is used to generate the admissions models can also include the outputs produced/determined at step 2920, discussed below.

Using the data inputs 2902 and 2904, at 2906, the admissions modeling component 2804 determines weighted values for each possible patient factor that represents the impact of each factor on LOS, readmission rate, discharge to the community and total cost. For example, for a particular patient age, gender, diagnosis, drug, etc., admissions modeling component 2804 can determine the impact (e.g., in days or cost), each factor has on LOS, readmission rate, discharge to the community and total cost. These weighted values are employed as coefficients for different algorithms configured to generate outputs for LOS, readmission rate, discharge to the community and total cost, based on a predefined set of patient factors (e.g., patient age, gender, number of prescription drugs, cost of drugs, referral reason or diagnosis, clinical status or history, referring provider, referring provider, insurance provider, the specific facility to which the patient will be admitted, and any necessary seasonal factors for the patient profile).

When a new potential patient is received, specific input 2908 information for the patient (e.g., the patient factors noted herein) is received, and at 2910 the admissions prediction component 2806 employs the patient input 2908 and the admissions models developed at step 2906 to determine a predicted admissions output result 2912. This output result includes a value for LOS, readmission rate, discharge to the community and total cost. This output result can also include information identifying a patient's admittance score and/or information identifying specific patient factors that most heavily impact LOS, readmission rate, cost, discharge to community and/or the admissions score.

At 2914, based on the admissions result output, the admissions recommendation component 2808 (or a user) can determine whether to admit the patient. If the patient is not admitted, process 2900 then ends at 2916. In some aspects, information regarding the patient's analysis is stored by the healthcare information server 102 and employed for future evaluation and calibration of the admissions models, even though the patient is not admitted. If the patient is admitted, at 2918, the patient encounter is tracked. For example, the course of care of the patient is tracked, including procedures performed, supplies used, drug usage, etc. At 2920, the admissions modeling component 2802 can determine actual values for LOS, readmission, discharge to the community and total cost. This information along with the detailed information of the patient encounter is then fed back into the admission modeler and used to update/recalibrate the admission models. For example, the admissions modeling component 2804 can compare the predicted admissions output result with the actual LOS, readmission, discharge to the community and total cost. Based on this comparison, the admissions modeling component 2804 can fine tune the coefficients for the specific patient factors of the patient (e.g., the specific age, diagnosis, drug usage, etc.) to better reflect the impact the respective factors have on LOS, readmission, discharge to the community and total cost.

FIGS. 30-32 present a series of example graphical user interfaces 3000-3200 that facilitate generating and providing visualizations identifying expected clinical and financial outcomes associated with a patient prior to admittance in accordance with various aspects and embodiments described herein. In various embodiments, interfaces 3000-3200 are generated/configured by interface component 112 and rendered at a client device 120 via presentation component 122 in response to a request to perform an admissions modeling application provided by the healthcare management server 102 and driven by admissions advisory component 2802.

With reference to FIG. 30, presented is an example graphical user interface 3000 that facilitate inputting new patient data in association with performing an admissions model for the new patient. Interface 3000 includes several defined input fields via which a user can enter information about the new patient. For example, these input field include information associated with demographics of the patient (e.g., age, gender, etc.), pharmacy information for the patient (e.g., prescriptions, and number of unique drugs), and clinical information for the patient (e.g., conditions, total number of conditions, etc.). It should be appreciated that these input fields are merely exemplary and various other types of patient criteria can be employed to facilitate admissions modeling in accordance with aspects and embodiments of the subject disclosure.

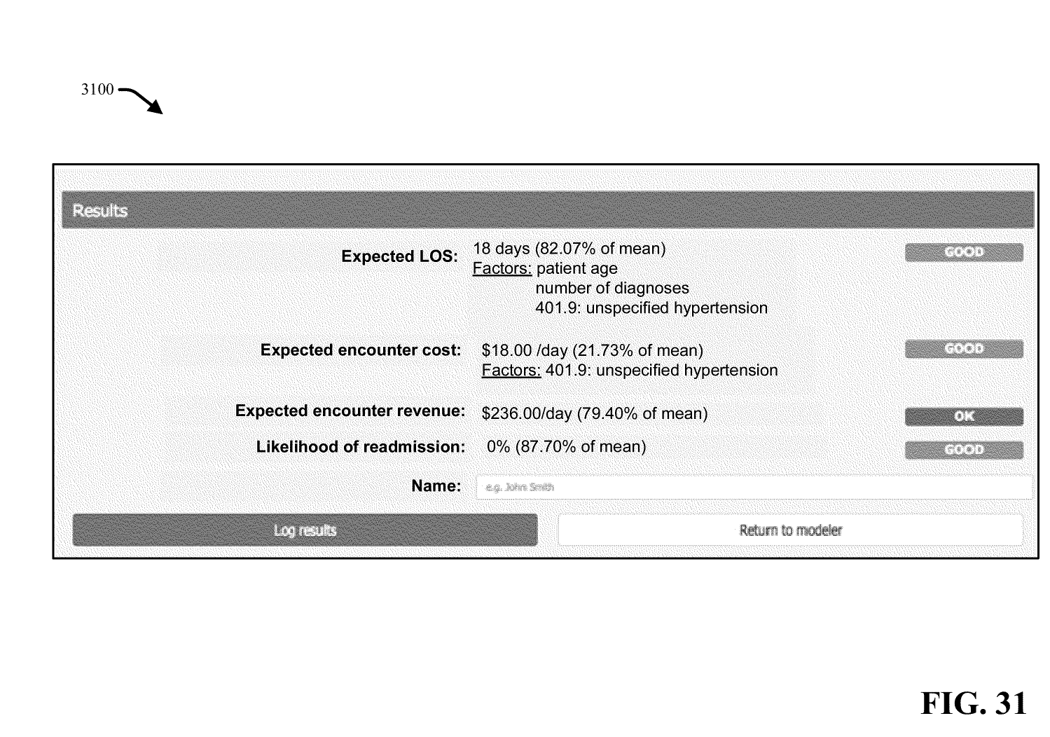

FIG. 31 presents an example output interface 3100 presenting the results of an admissions modeling assessment based on input criteria provided in interface 3000. The output provides output results in each category corresponding to expected LOS, expected encounter cost, expected encounter revenue and likelihood of readmission. The results for each category are further assigned a score (e.g., determined by admissions prediction component 2806) indicating the quality of the result (e.g., good, ok, etc.). In other aspects, the scores can include a numerical value. Via interface 3100, the user can select an option to log the results or return to the modeler.

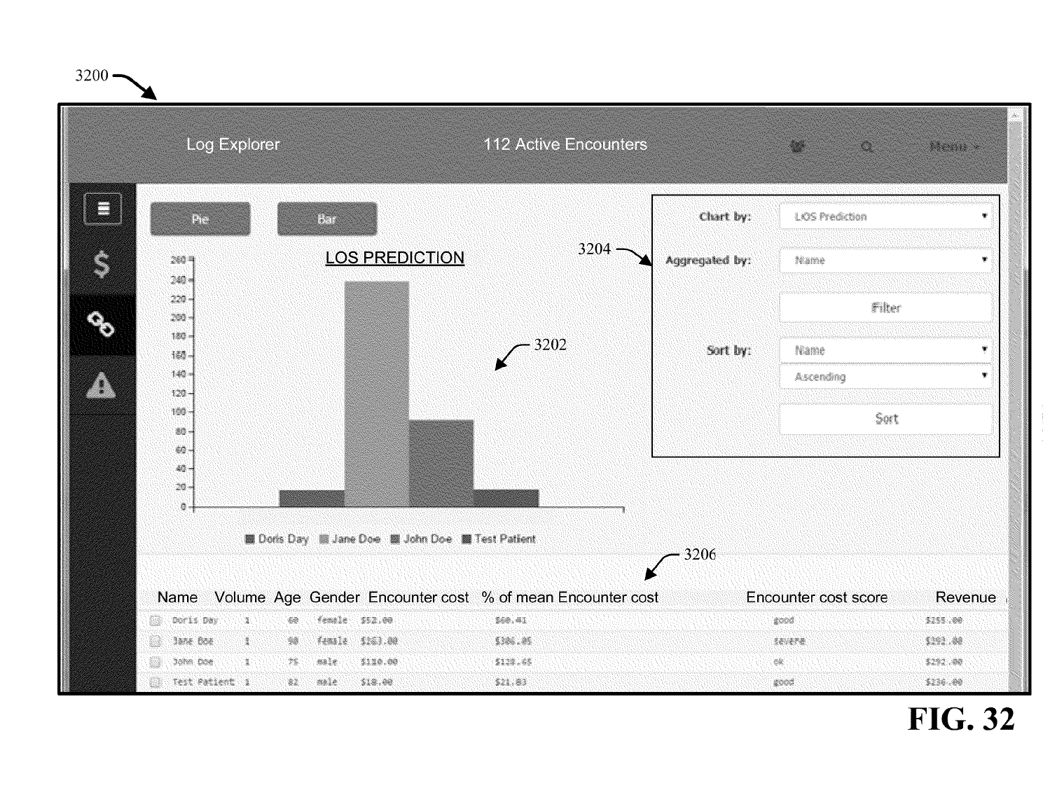

FIG. 32 presents a log explorer interface 3200 that facilitates analyzing logged admissions modeler results for different patients. Interface 3200 for example, includes information comparing admissions models of four selected patients (e.g., one patient corresponding to each bar of the bar graph). Via interface 3200, the user can compare the selected patients with respect to various filtering criteria. For example, an interactive input menu 3204 allows the user to provide information selecting a criteria to chart by (e.g., LOS prediction, readmission rate, cost, etc.), aggregate by and sort by, in association with generating a graphical visualization 3202 representative of the selected data.

The graphical representation 3202 depicts the number of days for predicted LOS for four different patients. Each bar of the bar graph corresponds to a different patient (e.g., the aggregation factor). The vertical axis corresponds to number of days. A summary chart 3206 can also be included below the visualization with information summarizing the admission model result for each patient.

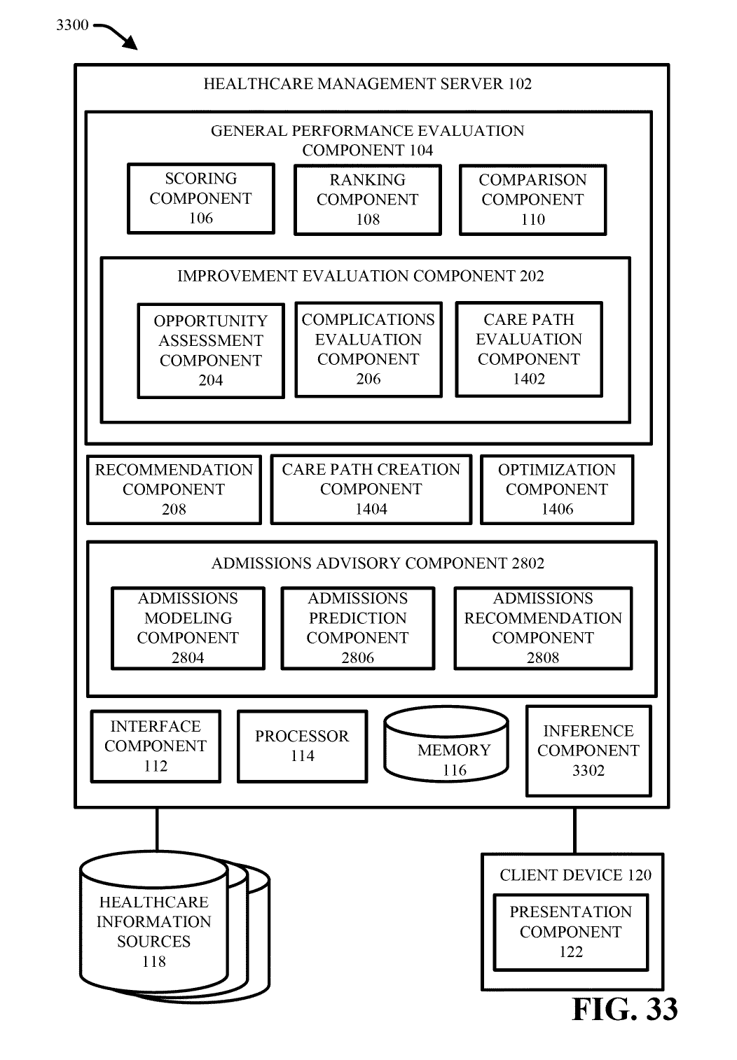

FIG. 33 illustrates another example system that facilitates providing clinically informed financial decisions that improve healthcare performance in accordance with various aspects and embodiments described herein. System 3300 includes same or similar aspects as system 2800 with the addition of inference component 3302. Repetitive description of like elements employed in respective embodiments of systems described herein is omitted for sake of brevity.

Inference component 3302 is configured to provide for or aid in various inferences or determinations associated with aspects of healthcare management server 102. For example inference component 3302 can facilitate comparison component 110 and improvement evaluation component 202 (including opportunity assessment component, 204, complications evaluation component 206 and care path evaluation component 1402) with identifying variances between different aspect of operation of a healthcare organization. For instance, inference component 3302 can facilitate comparison component 110 with identifying causes of variance with respect to efficiency, quality/nature of care, cost, ROI, patient satisfaction, employee satisfaction, etc. in association with analysis of various aspects of operation of the healthcare organization (e.g., courses of care, operation of different sectors, groups of patients, groups of employees, different windows of time, etc.). In another example, inference component 3302 can infer what aspects of a course of patient care for a particular condition are responsible for increased costs in association with analysis performed by care path evaluation component 1402 and care path creation component 1404.

In another example, inference component 3302 can facilitate recommendation component 208 with inferring mechanisms to optimize performance and operation of a healthcare organization in terms of efficiency, quality/standard of care, cost, course of care outcome, patient satisfaction, employee satisfaction, etc., based on comparative analysis performed by improvement evaluation component 202. In particular, inference component 3302 can facilitate inferring one or more changes to aspects of the healthcare organization to increase or improve efficiency, quality/standard of care, cost, course of care outcome, patient satisfaction, employee satisfaction, service portfolio, etc., based on identification of sources and causes of variance in efficiency, quality/standard of care, cost, course of care outcome, patient satisfaction, employee satisfaction, etc. These changes can consider impact on the entire healthcare organization or a sub-sector of the healthcare organization (e.g., a specific clinical group, a specific procedure, a specific division of the healthcare organization, a group of patients, a staff division, a course of care for a particular condition). Inference component 3302 can also facilitate care path creation component 1404 with inferring standards and regulations to implement regarding how a the healthcare organization as a whole or a particular medical service, procedure, caregiver, or sector of a hospital should perform in terms of efficiency, quality, outcome performance, resource consumption, and costs. In yet another example, inference component 3302 can facilitate inferring predicted LOS, readmission rate, discharge to community and cost for new patients in association with analysis performed by admissions advisory component 2802.

Inference component 3302 can have access to the various components of healthcare management server 102, healthcare information sources 118, and/or client device 120 as well as other external systems and sources accessible via a network. In order to provide for or aid in the numerous inferences described herein, inference component 3302 can examine the entirety or a subset of the data to which it is granted access and can provide for reasoning about or infer states of the system, environment, etc. from a set of observations as captured via events and/or data. An inference can be employed to identify a specific context or action, or can generate a probability distribution over states, for example. The inference can be probabilistic—that is, the computation of a probability distribution over states of interest based on a consideration of data and events. An inference can also refer to techniques employed for composing higher-level events from a set of events and/or data.

Such an inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x3, x4, xn), to a confidence that the input belongs to a class, such as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

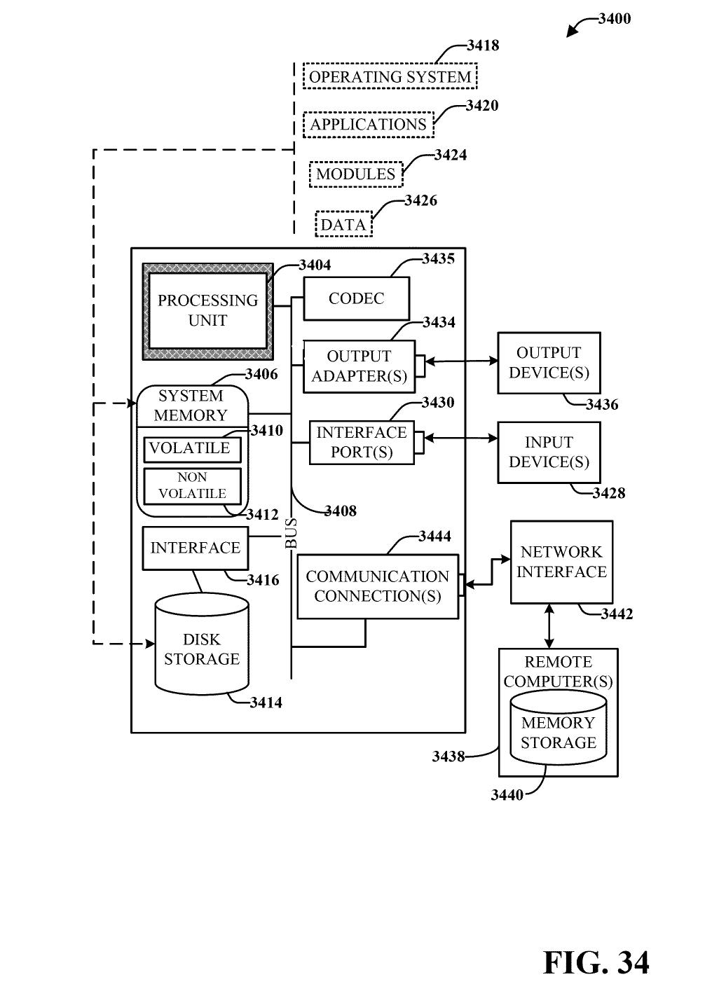

With reference to FIG. 34, a suitable environment 3400 for implementing various aspects of the claimed subject matter includes a computer 3402. The computer 3402 includes a processing unit 3404, a system memory 3406, a codec 3405, and a system bus 3408. The system bus 3408 couples system components including, but not limited to, the system memory 3406 to the processing unit 3404. The processing unit 3404 can be any of various available processors. Dual microprocessors and other multiprocessor architectures also can be employed as the processing unit 3404.

The system bus 3408 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13344), and Small Computer Systems Interface (SCSI).

The system memory 3406 includes volatile memory 3410 and non-volatile memory 3412. The basic input/output system (BIOS), containing the basic routines to transfer information between elements within the computer 3402, such as during start-up, is stored in non-volatile memory 3412. In addition, according to present innovations, codec 3405 may include at least one of an encoder or decoder, wherein the at least one of an encoder or decoder may consist of hardware, a combination of hardware and software, or software. Although, codec 3405 is depicted as a separate component, codec 3405 may be contained within non-volatile memory 3412. By way of illustration, and not limitation, non-volatile memory 3412 can include read only memory (ROM), programmable ROM (PROM), electrically programmable ROM (EPROM), electrically erasable programmable ROM (EEPROM), or flash memory. Volatile memory 3410 includes random access memory (RAM), which acts as external cache memory. According to present aspects, the volatile memory may store the write operation retry logic (not shown in FIG. 34) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 3402 may also include removable/non-removable, volatile/non-volatile computer storage medium. FIG. 34 illustrates, for example, disk storage 3414. Disk storage 3414 includes, but is not limited to, devices like a magnetic disk drive, solid state disk (SSD) floppy disk drive, tape drive, Jaz drive, Zip drive, LS-70 drive, flash memory card, or memory stick. In addition, disk storage 3414 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 3414 to the system bus 3408, a removable or non-removable interface is typically used, such as interface 3416.

It is to be appreciated that FIG. 34 describes software that acts as an intermediary between users and the basic computer resources described in the suitable operating environment 3400. Such software includes an operating system 3418. Operating system 3418, which can be stored on disk storage 3414, acts to control and allocate resources of the computer system 3402. Applications 3420 take advantage of the management of resources by operating system 3418 through program modules 3424, and program data 3426, such as the boot/shutdown transaction table and the like, stored either in system memory 3406 or on disk storage 3414. It is to be appreciated that the claimed subject matter can be implemented with various operating systems or combinations of operating systems.

A user enters commands or information into the computer 3402 through input device(s) 3428. Input devices 3428 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 3404 through the system bus 3408 via interface port(s) 3434. Interface port(s) 3434 include, for example, a serial port, a parallel port, a game port, and a universal serial bus (USB). Output device(s) 3436 use some of the same type of ports as input device(s). Thus, for example, a USB port may be used to provide input to computer 3402, and to output information from computer 3402 to an output device 3436. Output adapter 3434 is provided to illustrate that there are some output devices 3436 like monitors, speakers, and printers, among other output devices 3436, which require special adapters. The output adapters 3434 include, by way of illustration and not limitation, video and sound cards that provide a means of connection between the output device 3436 and the system bus 3408. It should be noted that other devices and/or systems of devices provide both input and output capabilities such as remote computer(s) 3438.

Computer 3402 can operate in a networked environment using logical connections to one or more remote computers, such as remote computer(s) 3438. The remote computer(s) 3438 can be a personal computer, a server, a router, a network PC, a workstation, a microprocessor based appliance, a peer device, a smart phone, a tablet, or other network node, and typically includes many of the elements described relative to computer 3402. For purposes of brevity, only a memory storage device 3440 is illustrated with remote computer(s) 3438. Remote computer(s) 3438 is logically connected to computer 3402 through a network interface 3442 and then connected via communication connection(s) 3444. Network interface 3442 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 3444 refers to the hardware/software employed to connect the network interface 3442 to the bus 3408. While communication connection 3444 is shown for illustrative clarity inside computer 3402, it can also be external to computer 3402. The hardware/software necessary for connection to the network interface 3442 includes, for exemplary purposes only, internal and external technologies such as, modems including regular telephone grade modems, cable modems and DSL modems, ISDN adapters, and wired and wireless Ethernet cards, hubs, and routers.

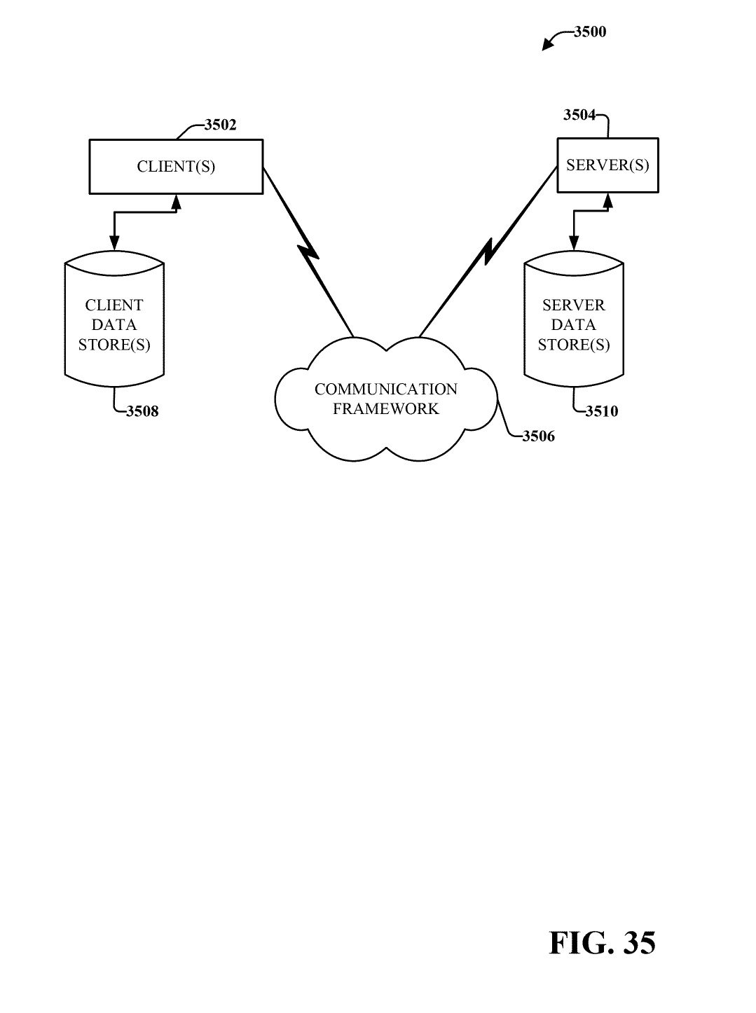

Referring now to FIG. 35, there is illustrated a schematic block diagram of a computing environment 3500 in accordance with this disclosure. The system 3500 includes one or more client(s) 3502 (e.g., laptops, smart phones, PDAs, media players, computers, portable electronic devices, tablets, and the like). The client(s) 3502 can be hardware and/or software (e.g., threads, processes, computing devices). The system 3500 also includes one or more server(s) 3504. The server(s) 3504 can also be hardware or hardware in combination with software (e.g., threads, processes, computing devices). The servers 3504 can house threads to perform transformations by employing aspects of this disclosure, for example. One possible communication between a client 3502 and a server 3504 can be in the form of a data packet transmitted between two or more computer processes wherein the data packet may include video data. The data packet can include a metadata, e.g., associated contextual information, for example. The system 3500 includes a communication framework 3506 (e.g., a global communication network such as the Internet, or mobile network(s)) that can be employed to facilitate communications between the client(s) 3502 and the server(s) 3504.

Communications can be facilitated via a wired (including optical fiber) and/or wireless technology. The client(s) 3502 include or are operatively connected to one or more client data store(s) 3508 that can be employed to store information local to the client(s) 3502 (e.g., associated contextual information). Similarly, the server(s) 3504 are operatively include or are operatively connected to one or more server data store(s) 3510 that can be employed to store information local to the servers 3504.

In one embodiment, a client 3502 can transfer an encoded file, in accordance with the disclosed subject matter, to server 3504. Server 3504 can store the file, decode the file, or transmit the file to another client 3502. It is to be appreciated, that a client 3502 can also transfer uncompressed file to a server 3504 and server 3504 can compress the file in accordance with the disclosed subject matter. Likewise, server 3504 can encode video information and transmit the information via communication framework 3506 to one or more clients 3502.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

What is claimed is:

1. A system, comprising:
a memory that stores computer executable components;
a processor that executes at least the following computer executable components stored in the memory:
a performance evaluation component configured to identify groups of patients having received healthcare service by a healthcare organization and associated with a common healthcare service parameter and an uncommon healthcare service parameters;
a scoring component configured to determine performance scores for respective groups of patients, wherein the performance scores reflect clinical and financial performance of the healthcare organization in association with provision of the healthcare service to the respective groups of patients; and
a comparison component configured to compare the respective groups of patients based on the performances scores respectively associated therewith to facilitate identifying one or more of the uncommon healthcare service parameters that are responsible for variance between at least a subset of performance scores.

2. The system of claim 1, wherein scoring component is configured to determine the respective performance scores based on: cost of care delivery to the respective patients of the groups of patients, length of stay (LOS) of the respective patients of the groups of patients, readmission rate of the respective patients of the groups of patients, complication rate of the respective patients of the groups of, financial variance of the respective patients of the groups of patients, and case complexity of the respective patients of the groups of patients.

3. The system of claim 1, wherein the comparison component is configured to select a subset of the respective groups of patients for comparison based on association with performance scores that differ beyond a threshold deviation value, and wherein the comparison component is configured to identify one or more of the uncommon healthcare service parameters that are responsible for variance between the performance scores of the respective groups included in the subset.

4. The system of claim 3, further comprising:
an opportunity assessment component configured to determine an amount of unnecessary cost associated with provision of healthcare service to respective groups of patients included in the subset based on the one or more uncommon healthcare service parameters.

5. The system of claim 3, further comprising:
an opportunity assessment component configured to determine an amount of unnecessary days associated with provision of healthcare service to respective groups of patients included in the subset based on the one or more uncommon healthcare service parameters.

6. The system of claim 3, further comprising:
a recommendation component configured to determine a mechanism to improve the clinical or financial performance of the healthcare organization in association with provision of future healthcare service to new patients associated with the common healthcare service parameter based on the one or more of the uncommon healthcare service parameters.

7. The system of claim 1, further comprising, a ranking component configured to rank the respective groups of patients based on the performance scores respectively associated therewith; and
an improvement evaluation component configured to select a subset of the respective groups of patients for improvement evaluation based on their ranking being below a threshold value.

8. The system of claim 1, wherein the common healthcare service parameter comprises a common diagnosis.

9. The system of claim 1, wherein the common healthcare service parameter comprises a common medical procedure.

10. The system of claim 1, wherein the uncommon healthcare service parameters comprise one or more of: a diagnosis, a procedure, a risk score, a medical caregiver, a facility or place of service, a supply type, a supply manufacturer, an avoidable complication, activities included in a course of care, or an order of care activities included in the course of care.

11. A method comprising:
using a processor to execute the following computer executable instructions stored in a memory to perform the following acts:
identifying groups of patients having received healthcare service by a healthcare organization and associated with a common healthcare service parameter and uncommon healthcare service parameters;
determining performance scores for respective groups of patients, wherein the performance scores reflect clinical and financial performance of the healthcare organization in association with provision of the healthcare service to the respective groups of patients; and
comparing the respective groups of patients based on the performances scores respectively associated therewith to facilitate identifying one or more of the uncommon healthcare service parameters that are responsible for variance between at least a subset of performance scores.

12. The method of claim 11, wherein determining comprises determining the respective performance scores based on: cost of care delivery to the respective patients of the groups of patients, length of stay (LOS) of the respective patients of the groups of patients, readmission rate of the respective patients of the groups of patients, complication rate of the respective patients of the groups of, financial variance of the respective patients of the groups of patients, and case complexity of the respective patients of the groups of patients.

13. The method of claim 11, further comprising:
selecting a subset of the respective groups of patients for comparison based on association with performance scores that differ beyond a threshold deviation value; and
identifying one or more of the uncommon healthcare service parameters that are responsible for variance between the performance scores of the respective groups included in the subset.

14. The method of claim 13, further comprising:
determining an amount of unnecessary cost associated with provision of healthcare service to respective groups of patients included in the subset based on the one or more uncommon healthcare service parameters.

15. The method of claim 13, further comprising:
determining an amount of unnecessary days associated with provision of healthcare service to respective groups of patients included in the subset based on the one or more uncommon healthcare service parameters.

16. The method of claim 13, further comprising:
determining a mechanism to improve the clinical or financial performance of the healthcare organization in association with provision of future healthcare service to new patients associated with the common healthcare service parameter based on the one or more of the uncommon healthcare service parameters.

17. The method of claim 11, further comprising:
ranking the respective groups of patients based on the performance scores respectively associated therewith; and
selecting a subset of the respective groups of patients for improvement evaluation based on their ranking being below a threshold value.

18. A tangible computer-readable storage medium comprising computer-readable instructions that, in response to execution, cause a computing system to perform operations, comprising:
identifying groups of patients with a common diagnosis having received healthcare service from a healthcare organization;
determining performance scores for respective groups of patients, wherein the performance scores reflect clinical and financial performance of the healthcare organization in association with provision of the healthcare service to the respective groups of patients; and
comparing the respective groups of patients based on the performances scores respectively associated therewith to facilitate identifying one or more healthcare service parameters that are responsible for variance between at least a subset of performance scores.

19. The tangible computer-readable storage medium of claim 18, wherein determining comprises determining the respective performance scores based on: cost of care delivery to the respective patients of the groups of patients, length of stay (LOS) of the respective patients of the groups of patients, readmission rate of the respective patients of the groups of patients, complication rate of the respective patients of the groups of, financial variance of the respective patients of the groups of patients, and case complexity of the respective patients of the groups of patients.

20. The tangible computer-readable storage medium of claim 18, the operations further comprising:
selecting a subset of the respective groups of patients for comparison based on association with performance scores that differ beyond a threshold deviation value; and
identifying one or more of the healthcare service parameters that are responsible for variance between the performance scores of the respective groups included in the subset, wherein the healthcare service parameters include: a procedure, a risk score, a medical caregiver, a facility or place of service, a supply type, a supply manufacturer, an avoidable complication, activities included in a course of care, and an order of care activities included in the course of care.
